(19) United States
(12) Patent Application Publication
(10) Pub. No.: US 2020/0269809 A1
(43) Pub. Date: Aug. 27, 2020

(54) VEHICLE OCCUPANT INFORMATION ACQUISITION SYSTEM

(71) Applicants: DENSO CORPORATION, Kariya-city, Aichi-pref. (JP); SOKEN, INC., Nisshin-city, Aichi-pref. (JP)

(72) Inventors: Kenichiro SANJI, Nishio-city (JP); Noritaka HIRAO, Kariya-city (JP); Kentaro ASAI, Kariya-city (JP); Yasuhiro TANAKA, Kariya-city (JP)

(21) Appl. No.: 16/063,717

(22) PCT Filed: Dec. 12, 2016
(86) PCT No.: PCT/JP2016/086864

§ 371 Date: Jun. 19, 2018

(30) Foreign Application Priority Data
Dec. 23, 2015 (JP) 2015-250777
Apr. 13, 2016 (JP) 2016-080577
Aug. 9, 2016 (JP) 2016-156595

(51) Int. Cl. B60R 25/24; B60R 25/31; H04W 4/02; H04W 4/48; H04W 4/80

(52) U.S. Cl. CPC B60R 25/245; B60R 25/31; E05B 81/56; H04W 4/48; H04W 4/80; H04W 4/025

(57) ABSTRACT

A vehicle occupant information acquisition system including an onboard device mounted to a vehicle and at least one vehicular portable device associated with the onboard device is provided. The vehicular portable device has a function of performing short-range communication with portable terminals, determines a holder's terminal based on a variation in received signal strength indication of a signal sent from each portable terminal, and sends a holder information signal identifying the holder's terminal to the onboard device. The onboard device identifies a user holding the vehicular portable device based on the holder information signal sent from the vehicular portable device, and identifies a portable device location by receiving a response signal. A seat determined based on the portable device location is determined to be a seated location of the user acting as the portable device holder.

### CROSS REFERENCE TO RELATED APPLICATIONS

This application is based on Japanese Patent Application No. 2015-250777 filed on Dec. 23, 2015, Japanese Patent Application No. 2016-80577 filed on Apr. 13, 2016, and Japanese Patent Application No. 2016-156595 filed on Aug. 9, 2016, the disclosures of which are incorporated herein by reference.

### TECHNICAL FIELD

The present disclosure relates to a vehicle occupant information acquisition system for acquiring information on a user who is to use a vehicle.

### BACKGROUND ART

There is known a system that performs various controls such as locking and unlocking doors of the vehicle and starting an engine, based on successful authentication via wireless communication between an onboard device which is mounted to a vehicle and a vehicular portable device which is carried by a user of the vehicle and which is associated with the onboard device.

Patent Literature 1 discloses a system which provides an individualized service suitable to a user by identifying a location of a portable terminal brought into the vehicle and assuming that a seat corresponding to the identified location of the portable terminal is a seat on which a user of the portable terminal is seated.

More specifically, the system of Patent Literature 1 includes receivers provided at multiple points in a compartment (for example, at respective seats) to receive a signal sent from a portable terminal, and each receiver detects a received signal strength indication of a signal from the portable terminal when the signal is received. It is determined that the portable terminal (in other words, a user of the portable terminal) is present on a seat corresponding to a receiver which has detected a highest received signal strength indication among the multiple receivers provided at the respective seats.

The portable terminal described above is a communication terminal furnished with a Bluetooth (registered trademark) communication function, and the portable terminal in Patent Literature 1 is assumed to be a smartphone or a cellular phone. Accordingly, the receivers provided at the respective seats perform wireless communication based on the Bluetooth (registered trademark) standards.

Hereinafter, communications based on predetermined wireless communication standards covering a communication range up to, for example, several tens of meters, such as the Bluetooth standards, is referred to as short-range communication for ease of description. A system for acquiring information on a vehicle occupant as to which user will take (or is seated on) which seat, which user holds the vehicular portable device, and so on is referred to also as a vehicle occupant information acquisition system.

### PRIOR ART LITERATURE

### Patent Literature

Patent Literature 1: JP 2009-177588 A

### SUMMARY OF INVENTION

In the configuration of Patent Literature 1, receivers for short-range communication are required at respective seats of a vehicle in order to acquire information as to, for example, which user is seated on which seat. Accordingly, the cost increases with the number of the receivers.

In view of the foregoing circumstances, it is an object of the present disclosure to provide a vehicle occupant information acquisition system which can eliminate a need to provide a vehicle with multiple receivers for wireless communication with a portable terminal.

In a first aspect of the present disclosure, a vehicle occupant information acquisition system comprises an onboard device mounted to a vehicle used by a plurality of users and at least one vehicular portable device associated with the onboard device, wherein the onboard device includes a vehicle-side transmission unit that sends a predetermined signal from a plurality of transmission antenna provided to send a signal in a frequency band receivable by the vehicular portable device, a vehicle-side reception unit that receives a signal sent from the vehicular portable device via a reception antenna, and a portable device location identification unit that identifies a portable device location which is a location where the vehicular portable device is present, by receiving a response signal sent from the vehicular portable device in response to the signal sent from the plurality of transmission antennae, wherein the vehicular portable device includes a first communication unit that sends a signal to and receives a signal from the onboard device and sends the response signal in response to a signal sent from the onboard device when the signal is received, a second communication unit that is provided to perform short-range wireless communication with each of a plurality of portable terminals carried by the plurality of users, a received signal strength indication detection unit that detects a received signal strength indication of the signal that the second communication unit receives from the portable terminal, and a holder's terminal identification unit that identifies a holder's terminal which is the portable terminal that is carried by the user carrying the vehicular portable device, based on the received signal strength indications detected by the received signal strength indication detection unit, wherein the first communication unit sends to the onboard device holder information identifying the user of the holder's terminal identified by the holder's terminal identification unit, and wherein the onboard device further includes a vehicle occupant information acquisition unit that identifies a portable device holder who is the user holding the vehicular portable device based on the holder information sent from the vehicular portable device, and identifies a seated location of the portable device holder based on the portable device location identified by the portable device location identification unit.

According to the configuration as above, the vehicular portable device sends a response signal in response to a signal sent from the onboard device when the signal is received. The vehicular portable device determines the holder's terminal among portable terminals present near the self device according to reception signal strengths of signals sent from the portable terminals present near the vehicular portable device, and sends holder information identifying a user of the holder's terminal to the onboard device. The user of the holder's terminal corresponds to a user carrying the vehicular portable device. Hence, the holder information functions as information identifying the user carrying the vehicular portable device.

Meanwhile, the onboard device identifies a location of the vehicular portable device by receiving a response signal sent from the vehicular portable device. The onboard device identifies a user as the portable device holder among the users of the vehicle according to the holder information sent from the vehicular portable device, and identifies a seated location of the user as the portable device holder according to the location of the vehicular portable device.

Owing to the configuration as above, only the vehicular portable device needs to be furnished with a function of performing short-range communication with portable terminals. A need to provide the vehicle with multiple receivers for short-range communication with portable terminals to enable the onboard device to estimate a seated location of a user who is to use the vehicle can be thus eliminated. That is, according to the configuration as the first aspect of the present disclosure, the number of receives provided to the vehicle occupant information acquisition system for short-range communication can be reduced.

In a second aspect of the present disclosure, a vehicle occupant information acquisition system comprises an onboard device mounted to a vehicle used by a plurality of users and at least one vehicular portable device associated with the onboard device, wherein the onboard device includes a vehicle-side transmission unit that sends a predetermined signal from a plurality of transmission antennae provided to send a signal in a frequency band receivable by the vehicular portable device, and a vehicle-side reception unit that receives a signal sent from the vehicular portable device via a reception antenna, wherein the vehicular portable device includes a first communication unit that sends a signal to and receives a signal from the onboard device and sends a response signal in response to a signal sent from the onboard device when the signal is received, a second communication unit that is provided to perform short-range wireless communication with each of a plurality of portable terminals carried by the plurality of users, and a state quantity acquisition unit that, from a device for detecting a predetermined state quantity which changes due to a behavior of a portable device holder who is one of the users carrying the vehicular portable device, acquires a detection result of the state quantity and saves the detection result into a predetermined storage medium, wherein each portable terminal is configured to send state quantity history data or predetermined processed state quantity data to the vehicular portable device as behavior notification data, wherein the state quantity history data is data indicating a history of the state quantity on the portable terminal and the predetermined processed state quantity data is data generated by applying predetermined computation processing to the state quantity history data, wherein the vehicular portable device further includes a holder's terminal identification unit that identifies a holder's terminal which is the portable terminal carried by the portable device holder, based on the behavior notification data sent from each of the plurality of portable terminals and a history of the state quantity of the vehicular portable device acquired by the state quantity acquisition unit, wherein the first communication unit sends holder information identifying a user of the holder's terminal identified by the holder's terminal identification unit to the onboard device, and wherein the onboard device further includes a vehicle occupant information acquisition unit that identifies the portable device holder based on the holder information sent from the vehicular portable device.

According to the configuration as above, the vehicular portable device determines the holder's terminal among portable terminals present near the vehicular portable device according to the behavior notification data sent from portable terminals present near the vehicular portable device, and sends the holder information identifying a user of the holder's terminal to the onboard device. The user of the holder's terminal corresponds to a user carrying the vehicular portable device. Hence, the holder information functions as information identifying the user carrying the vehicular portable device.

Meanwhile, the onboard device identifies a user acting as the portable device holder among the users of the vehicle according to the holder information sent from the vehicular portable device. Owing to the configuration as above, only the vehicular portable device needs to be furnished with a function of performing short-range communication with portable terminals. A need to provide the vehicle with multiple receivers for short-range communication with portable terminals can be thus eliminated. That is, according to the configuration as the second aspect of the present disclosure, the number of receivers provided to the vehicle occupant information acquisition system for short-range communication can be reduced.

### BRIEF DESCRIPTION OF DRAWINGS

The above and other objects, features and advantages of the present invention will become more apparent from the following detailed description made with reference to the accompanying drawings. In the drawings:

FIG. 1 is a block diagram showing a schematic configuration of a vehicle occupant information acquisition system;

FIG. 2 is a block diagram showing a schematic configuration of an onboard device;

FIG. 3 is a conceptual diagram to illustrate locations and transmission areas of LF antennae;

FIG. 4 is a functional block diagram showing a schematic configuration of a vehicle-side controller;

FIG. 5 is a diagram to illustrate a method of identifying an LF antenna which has sent a signal responded to by a vehicular portable device;

FIG. 6 is a block diagram showing a schematic configuration of the vehicular portable device;

FIG. 7 is a functional block diagram showing a schematic configuration of a portable device-side controller;

FIG. 8 is a block diagram showing a schematic configuration of a portable terminal;

FIG. 9 is a flowchart to illustrate processing at a vehicle end;

FIG. 10 is a flowchart to illustrate processing at a portable device end;

FIG. 11 is a diagram to illustrate a modification relating to the method of identifying an LF antenna which has sent a signal responded to by the vehicular portable device;

FIG. 12 is a conceptual diagram showing a modification relating to locations and transmission areas of the LF antennae;

FIG. 13 is a diagram to illustrate a modification relating to a method of identifying a portable device location by a portable device locating section;

FIG. 14 is a diagram to illustrate a modification relating to a sampling period,

FIG. 15 is a diagram to illustrate another modification relating to the sampling period;

FIG. 16 is a flowchart to illustrate holder information acquisition processing;

FIG. 17 is a flowchart to illustrate holder information providing processing;

FIG. 18 is a flowchart to illustrate first holder's terminal identification processing;

FIG. 19 is a diagram to illustrate a utilization form of a RAM;

FIG. 20 is a flowchart to illustrate second holder's terminal identification processing;

FIG. 21 is a block diagram showing a schematic configuration of the vehicular portable device according to a fifteenth modification;

FIG. 22 is a block diagram showing a schematic configuration of the portable device-side controller according to the fifteenth modification;

FIG. 23 is a diagram to illustrate an operation of a frequency characteristic analysis section;

FIG. 24 is another diagram to illustrate the operation of the frequency characteristic analysis section;

FIG. 25 is a diagram to illustrate an operation of a walking determiner section;

FIG. 26 is a flowchart to illustrate holder's terminal identification processing performed by the portable device-side controller according to the fifteenth modification;

FIG. 27 is a flowchart continuing from the flowchart of FIG. 26:

FIG. 28 is still another diagram to illustrate the operation of the frequency characteristic analysis section;

FIG. 29 is a block diagram showing a schematic configuration of the portable terminal according to a sixteenth modification;

FIG. 30 is a diagram to illustrate an operation of a holder's terminal identification section according to the sixteenth modification;

FIG. 31 is a diagram to illustrate another operation of the holder's terminal identification section according to the sixteenth modification;

FIG. 32 is a diagram to illustrate still another operation of the holder's terminal identification section according to the sixteenth modification;

FIG. 33 is a diagram to illustrate yet another operation of the holder's terminal identification section according to the sixteenth modification;

FIG. 34 is a block diagram showing a schematic configuration of the portable terminal according to a seventeenth modification;

FIG. 35 is a block diagram showing a schematic configuration of the vehicular portable device according to the seventeenth modification;

FIG. 36 is a diagram to illustrate an operation of the holder's terminal identification section according to the seventeenth modification;

FIG. 37 is a block diagram showing a schematic configuration of the portable terminal according to an eighteenth modification;

FIG. 38 is a block diagram showing a schematic configuration of the vehicular portable device according to the eighteenth modification;

FIG. 39 is a diagram to illustrate an operation of the holder's terminal identification section according to the seventeenth modification;

FIG. 40 is a block diagram showing an example of a schematic configuration of the portable terminal according to a twentieth modification;

FIG. 41 is a block diagram showing a schematic configuration of the portable device-side controller according to the twentieth modification;

FIG. 42 is a diagram to illustrate an operation of a holding style pattern identification section G;

FIG. 43 is a flowchart to illustrate the holder's terminal identification processing performed by the portable device-side controller according to the twentieth modification;

FIG. 44 is a flowchart continuing from the flowchart of FIG. 43;

FIG. 45 is a diagram schematically showing first-pattern variation calculation processing;

FIG. 46 is a flowchart to illustrate second-pattern variation calculation processing;

FIG. 47 is a diagram to illustrate an effect of the second-pattern variation calculation processing;

FIG. 48 is a flowchart to illustrate third-pattern variation calculation processing;

FIG. 49 is a diagram to illustrate an operation by the third-pattern variation calculation processing; and

FIG. 50 is a diagram to illustrate another operation by the third-pattern variation calculation processing.

### MODES FOR CARRYING OUT INVENTION

### Embodiments

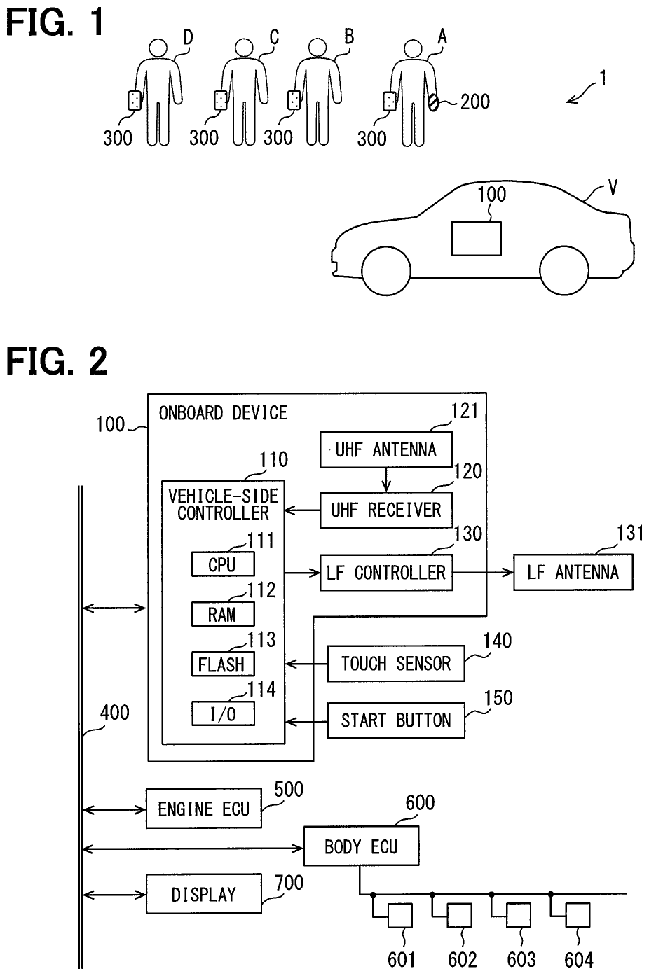

Hereinafter, embodiments will be described by using the drawings. FIG. 1 is a conceptual view to illustrate a general outline of a vehicle occupant information acquisition system 1 according to one embodiment. As is shown in FIG. 1, the vehicle occupant information acquisition system 1 includes an onboard device 100 mounted to a vehicle V used by multiple users, and a vehicular portable device 200 furnished with a function as a key unique to the vehicle V.

A user referred to herein means an individual preliminarily registered in the onboard device 100 as a user of the vehicle V. Herein, four individuals are registered as users A through D of the vehicle V as an example. It goes without saying that the number of individuals registered as the users is not particularly limited. In FIG. 1, numerals 300 denote portable terminals 300 owned by the respective users. Each portable terminal 300 is, for example, a smartphone serving as a communication device furnished with a short-range communication function described below.

### Schematic Configuration of Vehicle Occupant Information Acquisition System 1

Each of the onboard device 100 and the vehicular portable device 200 is furnished with a function of realizing a known smart entry system by performing wireless communication with each other by using radio waves in a predetermined frequency band.

More specifically, the onboard device 100 is furnished with a function of sending a signal in a predetermined LF (Low Frequency) band toward a compartment and a predetermined range around the vehicle V (hereinafter, referred to as a wireless communication area), and a function of receiving a signal in a predetermined RF (Radio Frequency) band sent from the vehicular portable device 200. The vehicular portable device 200 is furnished with a function of receiving a signal in the LF band sent from the onboard device 100, and a function of sends, as a response, a signal in the predetermined RF band to the onboard device 100.

Herein, the LF band is a frequency ranging from 20 kHz to 200 kHz as an example. The RF band is a frequency ranging from 300 MHz to 500 MHz. Frequency ranges of the LF band and the RF band may be designed as needed. It goes without saying that a radio wave in a frequency band other than the LF band may be used to send a signal from the onboard device 100 to the vehicular portable device 200. Likewise, a radio wave in a frequency band other than the RF band may be used to send a signal from the vehicular portable device 200 to the onboard device 100.

In the configuration as above, the onboard device 100 performs authentication processing with the vehicular portable device 200 via wireless communication when the vehicular portable device 200 is present within the wireless communication area, and performs various controls, such as locking and unlocking doors and starting an engine, on condition that the authentication is successful.

The authentication processing referred to herein is processing for the onboard device 100 to confirm that a communication terminal (hereinafter, referred to as a communication target) presently performing wireless communication with the onboard device 100 is the vehicular portable device 200 associated with the onboard device 100 (that is, an authorized vehicular portable device 200).

When the onboard device 100 authenticates the vehicular portable device 200 via wireless communication, a user holding the vehicular portable device 200 is enabled to lock or unlock the doors and start or stop the engine without having to operate the vehicular portable device 200 serving as a key.

The wireless communication area formed by the onboard device 100 may be designed as needed. For example, the wireless communication area outside the compartment is a range within several meters about the vehicle V. Vehicle IDs, which are identification numbers unique to the onboard device 100 and the vehicular portable device 200, are stored in the onboard device 100 and the vehicular portable device 200. Authentication of the vehicular portable device 200 by the authentication processing described above is realized by using an ID code generated from the vehicle ID. The authentication processing will be described separately in detail below.

The vehicular portable device 200 includes a switch 240 operable by a user, and provides so-called a remote keyless entry system which performs controls, such as locking and unlocking the vehicle doors, by sending a signal corresponding to the user's operation of the switch to the onboard device 100. The vehicular portable device 200 thus functions as a key of the vehicle V.

Each portable terminal 300 is a communication device furnished with a function of performing communication based on predetermined short-range wireless communication standards covering a communication range up to several tens of meters (hereinafter, referred to as short-range communication). The portable terminal 300 only needs to be furnished with the short-range communication function described above. A portable phone, for example, a smartphone may be used as the portable terminal 300. It goes without saying that a tablet terminal, a wearable device, a portable music player, a portable game machine, and so on may be also used as the portable terminal 300.

For example, Bluetooth (registered trademark) Low Energy, Wi-Fi (registered trademark), and ZigBee (registered trademark) may be adopted as the short-range wireless communication standards. Herein, the short-range communication corresponds to short-range wireless communication.

The vehicular portable device 200 is further furnished with the short-range communication function. When the vehicular portable device 200 detects a portable terminal 300 present near the vehicular portable device 200, the vehicular portable device 200 performs short-range communication with the detected portable terminal 300. The phrase, “near the vehicular portable device 200”, referred to herein means a range (hereinafter, referred to as a short-range communication range) within which the vehicular portable device 200 is capable of performing short-range communication.

Each portable terminal 300 notifies the vehicular portable device 200 of its presence by sending a notification signal containing a terminal identifier (hereinafter, referred to as a terminal ID) uniquely assigned to the self either regularly or in response to a request from the vehicular portable device 200.

Herein, the vehicular portable device 200 behaves as a master of portable terminals 300 while portable terminals 300 behave as slaves to the vehicular portable device 200 as an example. Each portable terminal 300 notifies the vehicular portable device 200 of its presence by regularly sending a notification signal in a predetermined period (hereinafter, referred to as a notification period).

### Schematic Operation of Vehicle Occupant Information Acquisition System 1

Schematically speaking, the vehicle occupant information acquisition system 1 of the present embodiment operates as follows. First, the vehicular portable device 200 identifies a portable terminal 300 carried by a user carrying the vehicular portable device 200 (hereinafter, referred to as a portable device holder), based on received signal strength indications of signals received from portable terminals 300 present near the self-device which means the vehicular portable device 200 itself herein.

Hereinafter, a portable terminal 300 carried by the portable device holder is referred to also as a holder's terminal for ease of description. Also, processing performed by the vehicular portable device 200 to identify the holder's terminal is referred to as holder's terminal identification processing.

The vehicular portable device 200 sends to the onboard device 100 holder information specified by the terminal ID of a portable terminal 300 identified as being the holder's terminal. The holder information referred to herein means information which enable the onboard device 100 to identify or recognize a user as the portable device holder. The holder information used herein as an example is the terminal ID of a portable terminal 300 identified as being the holder's terminal.

The onboard device 100 pre-stores user management data, which is the terminal IDs assigned to portable terminals 300 owned by respective users and associated with vehicle setting data which specifies settings customized for the respective users (for example, seat positions). Users of the vehicle V may be distinguished from one another by the user IDs uniquely assigned to the users.

Upon acquisition of the holder information from the vehicular portable device 200, the onboard device 100 identifies a user corresponding to the terminal ID contained in the acquired holder information by referring to the user management data. The onboard device 100 also performs processing to identify a location of the vehicular portable device 200 with respect to the vehicle V independently of the processing described above.

In a case where the onboard device 100 succeeds in identifying a present location of the vehicular portable device 200, the onboard device 100 identifies a seated location of the user identified by the holder information, based on the location information. For example, in a case where the present location of the vehicular portable device 200 at a time of receiving the holder information is near a door at a front occupant's seat, the seated location of the user acting as the portable device holder is determined as being the front occupant's seat. In a case where the present location of the vehicular portable device 200 at the time of receiving the holder information is near a door at a driver's seat, the seated location of the user acting as the portable device holder is determined as being the driver' seat.

After the seated locations of the users are identified, the onboard device 100 automatically changes a compartment environment, for example, a seat position, to a compartment environment that suits a preference of each user by referring to the vehicle setting data of each user.

An operation to determine that a seated location of a user is the driver's seat corresponds to an operation to determine that the user in question is a user who behaves as a driver of a present trip. The trip referred to herein means a series of running operations from beginning to end until the vehicle V is parked. Hereinafter, specific configurations and operations of the respective elements will be described.

### Configuration of Onboard Device 100

The onboard device 100 is mounted to the vehicle V, and as is shown in FIG. 2, connected to various devices including ECUs (Electronic Control Units) to enable mutual communication via a network 400 constructed in the vehicle V. For example, the onboard device 100 is connected individually to an engine ECU 500, a body ECU 600, and a display 700 to enable mutual communication.

The engine ECU 500 is an ECU for controlling an operation of the engine installed to the vehicle V. The vehicle V used herein as an example is a vehicle using the engine as a drive source. However, the vehicle V is not limited to the vehicle of the example and may be an electric vehicle or a hybrid vehicle instead.

The body ECU 600 is an ECU for controlling various actuators equipped to the vehicle V and connected to the actuators and various sensors to enable communication. For example, the body ECU 600 locks or unlocks the vehicle doors by outputting a predetermined control signal to door lock motors 601 provided to the respective vehicle doors. The body ECU 600 also changes a position of each seat by outputting a predetermined drive signal to an actuator 602 provided to each seat to adjust a seat position.

Further, the body ECU 600 is connected to a curtesy switch 603 provided to each door and to a vehicle occupant detection sensor 604 provided to each seat. The courtesy switch 603 is a sensor which detects opening and closing of the door and the vehicle occupant detection sensor 604 is a sensor which detects presence of a vehicle occupant in the driver's seat. The vehicle occupant detection sensor 604 can be realized by a pressure sensor or the like.

The display 700 displays an image corresponding to data inputted from the onboard device 100 or the like. The display 700 may be realized by, for example, a liquid crystal display or an organic EL display. Alternatively, the display 700 may be a head-up display.

To describe the configuration more in detail, the onboard device 100 includes a vehicle-side controller 110, a UHF receiver 120, a UHF antenna 121, and an LF controller 130. Each of the UHF receiver 120 and the LF controller 130 is connected to the vehicle-side controller 110 to enable mutual communication. The onboard device 100 is also electrically and individually connected to an LF antenna 131, a touch sensor 140, and a start button 150.

The UHF antenna 121 converts a radio wave in a UHF band to an electrical signal which is outputted to the UHF receiver 120. The UHF antenna 121 corresponds to a reception antenna. In the present embodiment, the onboard device 100 includes the UHF antenna 121 as an example. However, the present disclosure is not limited to the configuration of the example. The UHF antenna 121 may be provided outside the onboard device 100 and electrically connected to the onboard device 100.

The UHF receiver 120 demodulates a signal inputted from the UHF antenna 121 and provides the demodulated signal to the vehicle-side controller 110. The UHF receiver 120 corresponds to a vehicle-side reception unit.

The LF antenna 131 converts a signal inputted from the LF controller 130 into a radio wave in the LF band which is radiated. The LF antenna 131 is provided to the vehicle V at more than one locations on an as-needed basis to form a desirable transmission area. The transmission area of the LF antenna 131 referred to herein means an area within which a signal sent from the LF antenna 131 arrives while maintaining a signal level receivable (in other words, decodable) by the vehicular portable device 200.

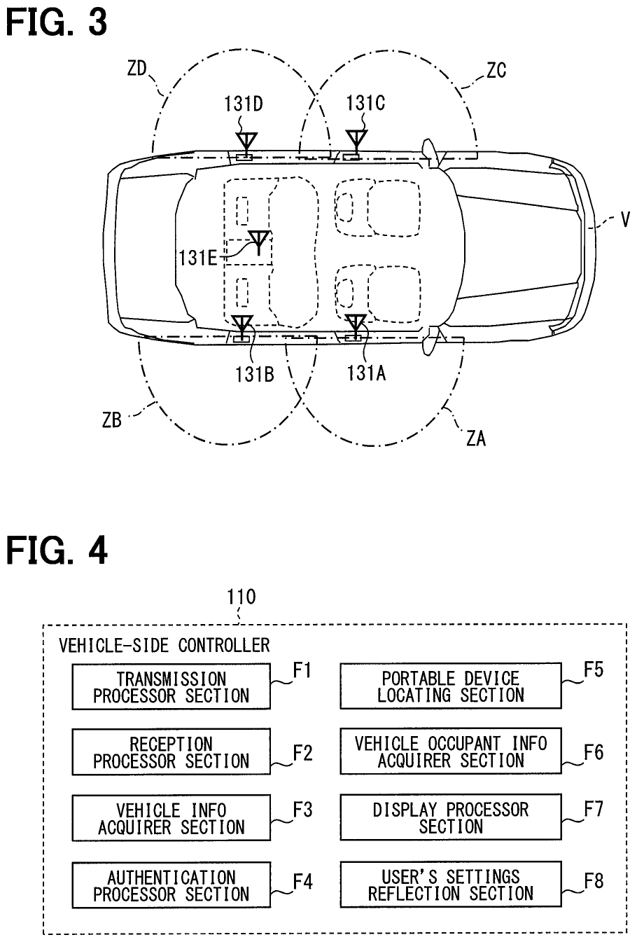

In the present embodiment, the vehicle V is provided with the LF antenna 131 which includes, as is shown in FIG. 3, a DF-side antenna 131A, a DR-side antenna 131B, a PF-side antenna 131C, a PR-side antenna 131D, and a compartment antenna 131E as an example.

The DF-side antenna 131A is an LF antenna 131 provided near a handle of the door at the driver's seat (including an interior of the handle). The DF-side antenna 131A is designed to cover an area outside the compartment within a certain range from the door at the driver's seat as the transmission area. In FIG. 3, ZA conceptually represents the transmission area of the DF-side antenna 131A. The DF-side antenna 131A corresponds to an LF antenna 131 associated with the driver's seat. In the present embodiment, the driver's seat of the vehicle V is a right front seat.

The DR-side antenna 131B is an LF antenna 131 provided near a handle of a door at a backseat behind the driver's seat. The DR-side antenna 131B is designed to cover an area outside the compartment within a certain range from the door at the backseat behind the driver's seat as the transmission area. In FIG. 3, ZB conceptually represents the transmission area of the DR-side antenna 131B. The DR-side antenna 131B corresponds to an LF antenna 131 associated with a backseat, in particular, the backseat behind the driver's seat.

The PF-side antenna 131C is an LF antenna 131 provided near a handle of the door at the front occupant's seat. The PF-side antenna 131C is designed to cover an area outside the compartment within a certain range from the door at the front occupant's seat as the transmission area. In FIG. 3, ZC conceptually represents the transmission area of the PF-side antenna 131C. The PF-side antenna 131C corresponds to an LF antenna 131 associated with the front occupant's seat.

The PR-side antenna 131D is an LF antenna 131 provided near a handle of the door at a backseat behind the front occupant's seat. The PR-side antenna 131D is designed to cover an area outside the compartment within a certain range from the door at the backseat behind the front occupant's seat as the transmission area. In FIG. 3, ZD conceptually represents the transmission area of the PR-side antenna 131D. The PR-side antenna 131D corresponds to an LF antenna 131 associated with a backseat, in particular, the backseat behind the front occupant's seat.

The compartment antenna 131E is an LF antenna covering the entire compartment as the transmission area. Although only one compartment antenna 131E is shown in FIG. 3, two or more compartment antennae 131E may be provided. In FIG. 3, the transmission area of the compartment antenna 131E is not shown.

It should be appreciated that set positions and the transmission areas of the LF antennae 131 provided to the vehicle V are not limited to the configuration described above. Set positions and the like of the LF antennae 131 may be designed as needed to form desirable transmission areas. Besides the LF antennae 131 described above, the vehicle V may be provided with an LF antenna 131 covering an interior of a trunk as the transmission area and an LF antenna 131 covering an area around a trunk door as the transmission area.

The LF antennae 131 correspond to transmission antennae. The DF-side antenna 131A, the DR-side antenna 131B, the PF-side antenna 131C, and the PR-side antenna 131D correspond to an external antenna and the compartment antenna 131E corresponds to an internal antenna. The DF-side antenna 131A corresponds to a driver's seat antenna and the PF-side antenna 131C corresponds to a front occupant's seat antenna.

In the present embodiment, an area adopted as the transmission area of an LF antenna 131 as an example is a range within which a signal sent from the LF antenna 131 arrives while maintaining a signal level decodable by the vehicular portable device 200. It should be appreciated, however, that the present disclosure is not limited to the configuration of the example. The transmission area may be a range within which a signal propagates at a signal level with which a received signal strength indication at the vehicular portable device 200 is at or above a predetermined area determination threshold. The area determination threshold used herein is a value designed by a designer as needed and larger than a lower-limit value of a decodable signal level (that is, a decodable threshold limit value). According to the configuration as above, even when a signal with a received signal strength indication at a decodable level is received from the onboard device 100, the vehicular portable device 200 determines that a present location is outside the transmission area and does not respond to the received signal in a case where the received signal strength indication is at or below the area determination threshold.

The touch sensor 140 is provided to each door handle of the vehicle V and detects touching on the door handle by a user. Detection results of the touch sensor 140 are successively outputted to the vehicle-side controller 110. The start button 150 is a push switch to start the engine by the user. When the user makes a push operation, the start button 150 outputs a control signal indicating the push operation to the vehicle-side controller 110.

The LF controller 130 generates a signal by modulating data inputted from the vehicle-side controller 110 into a carrier wave signal. The LF controller 130 outputs the modulated signal to an arbitrary LF antenna 131 among the multiple LF antennae 131 for the signal to be radiated to space as a radio wave. The vehicle-side controller 110 designates which LF antenna 131 outputs the signal.

For example, the LF controller 130 outputs a signal to the respective LF antennae 131 in turn to prevent transmission timing of one LF antenna 131 from falling on transmission timing of another. The signal is thus sent from the respective LF antennae 131 in turn. By shifting timing to send a radio wave from the respective LF antennae 131, interference of a signal sent from one LF antenna 131 with a signal sent from another LF another 131 can be prevented. The LF controller 130 corresponds to a vehicle-side transmission unit.

The vehicle-side controller 110 is formed with a normal computer and includes a CPU 111, a RAM 112, a flash memory 113, an IO 114, and a bus line interconnecting the foregoing elements.

The CPU 111 is an electronic circuit module for performing various types of computation processing and realized by a microprocessor or the like. The RAM 112 is a volatile memory and the flash memory 113 is a non-volatile memory. A program causing a normal computer to function as the vehicle-side controller 110 (hereinafter, referred to as a vehicle control program) is pre-installed to the flash memory 113.

The IO 114 functions as an interface between the vehicle-side controller 110 and various devices, for example, the body ECU 600, the UHF receiver 120, and the LF controller 130 to input and output data. The IO 114 may be realized by an analog circuit element or an IC.

The vehicle-side controller 110 provides various functions by executing the vehicle control program pre-installed to the flash memory 113. Various functions provided by the vehicle-side controller 110 will be described in detail below. The vehicle control program only needs to be pre-installed to a non-transitory tangible storage medium. An operation to run the vehicle control program on the CPU 111 corresponds to an operation to perform a method in accordance with the vehicle control program.

The flash memory 113 pre-stores user management data, which is data generated by associated users of the vehicle V, the terminal IDs of portable terminals 300 owned by respective users, and the vehicle setting data specifying the settings of the vehicle V customized for respective users.

Particulars of the settings to be customized for users are particulars forming a compartment environment, for example, a seat position, angles of a rearview mirror and sideview mirrors, and an air-conditioned temperature. When the vehicle V is furnished with a function of illuminating lights provided inside and outside the compartment upon detection of a driver getting into the vehicle V or a preparatory action of the driver to get into the vehicle V (so-called welcome illumination function), an illumination color may be also a particular that can be customized for users. Further, settings registered in an unillustrated onboard navigation system may differ from user to user.

### Function of Vehicle-Side Controller 110

The vehicle-side controller 110 performs processing corresponding to various functional blocks shown in FIG. 4 by executing the vehicle control program described above. That is, the vehicle-side controller 110 includes the functional blocks which are a transmission processor section F1, a reception processor section F2, a vehicle information acquirer section F3, an authentication processor section F4, a portable device locating section F5, a vehicle occupant information acquirer section F6, a display processor section F7, and a user's settings reflection section F8. Functions performed by the vehicle-side controller 110, either in part or as a whole, may be realized by hardware in the form of one or more than one IC.

The transmission processor section F1 generates a signal to be sent from the respective LF antennae 131 and outputs the signal to the LF controller 130 by designating which LF antenna 131 is an output destination of the signal. Accordingly, a desirable signal is outputted from a desirable LF antenna 131 as a radio wave. A transmission signal may be a signal requesting to send a predetermined response signal for authentication of the vehicular portable device 200 (hereinafter, referred to as an authentication signal), a signal directing to start scan processing described below (hereinafter, referred to as a scan command signal), a signal directing to report a result of holder's terminal identification processing (hereinafter, referred to as a report command signal), and so on.

The authentication signal referred to herein means a signal requesting the vehicular portable device 200 to send an ID code generated according to a predetermined rule. The authentication processing may be configured to perform authentication step by step by sequentially sending authentication signals of multiple types at different confidential levels. In short, signals of multiple types may be used as the authentication signal. Both of the authentication signal and the scan command signal are signals requesting the vehicular portable device 200 to send a response signal corresponding to contents of the respective signals.

The reception processor section F2 acquires data received at the UHF antenna 121 and demodulated by the UHF receiver 120. The vehicle information acquirer section F3 acquires various types of information on a vehicle state (hereinafter, referred to as vehicle information) from sensors and ECUs equipped to the vehicle V, such as the touch sensors 140, the start button 150, the engine ECU 500, the body ECU 600, and the display 700.

The vehicle information is, for example, a door opening or closing state, a locked or unlocked state of each door, detection results of the vehicle occupant detection sensors 604, and presence or absence of a depressing operation on the touch sensors 140 and the start button 150. However, information included in the vehicle information is not limited to the information specified above. A gear shift position detected by an unillustrated gear shift position sensor, a detection result of an unillustrated brake sensor which detects whether a braking pedal is depressed are also included in the vehicle information.

The vehicle information acquired by the vehicle information acquirer section F3 is used by the authentication processor section F4 or the like to recognize a present state of the vehicle V. For example, in a case where the engine is off and all the doors are locked, the authentication processor section F4 determines that the vehicle V is parked. It goes without saying that a condition for determining the parking of the vehicle V may be designed as needed and a known determination condition or the like is also applicable.

The authentication processor section F4 performs the authentication processing with the vehicular portable device 200 via wireless communication. A procedure of the authentication processing is known and a detailed description is omitted herein. The authentication processor section F4 starts the authentication processing when it is detected, based on the vehicle information acquired by the vehicle information acquirer section F3, that a predetermined condition for performing the authentication processing is met. For example, the authentication processor section F4 performs the authentication processing when the vehicular portable device 200 entering a vehicle communication range is detected or when the start button 150 is pushed.

The determination of whether the vehicular portable device 200 enters the vehicle communication range may be made by, for example, sending a polling signal regularly from the respective LF antennae 131 and checking whether a response signal to the polling signal is received from the vehicular portable device 200. That is, the vehicular portable device 200 entering into the vehicle communication range may be determined when a response signal to the polling signal is received from the vehicular portable device 200 in a state where no response signal from the vehicular portable device 200 has been received over a period of some time.

The polling signal may be any signal requesting the vehicular portable device 200 to send a response. The polling signal may be a signal exclusively used to detect whether the vehicular portable device 200 is present within the vehicle communication range or a signal used also for a different purpose. Further, the polling signal may be the authentication signal or the scan command signal. The polling signal may be a signal used for any other purpose.

The portable device locating section F5 identifies a location of the vehicular portable device 200 (hereinafter, referred to as a portable device location) with respect to the vehicle V by receiving a response signal from the vehicular portable device 200 in response to a signal sent from the LF antennae 131. More specifically, in the present embodiment, the portable device locating section F5 identifies the portable device location in a manner as follows as an example.

The portable device locating section F5 cooperates with the transmission processor section F1 and sends from the respective LF antennae 131 in turn a signal (for example, the polling signal) requesting the vehicular portable device 200 to send a response. A signal used to identify the portable device location is referred to also as a location identification signal for ease of description. As has been described, the location identification signal may be a signal used to achieve a different purpose, for example, the authentication signal, or a signal exclusively used to identify the portable device location.

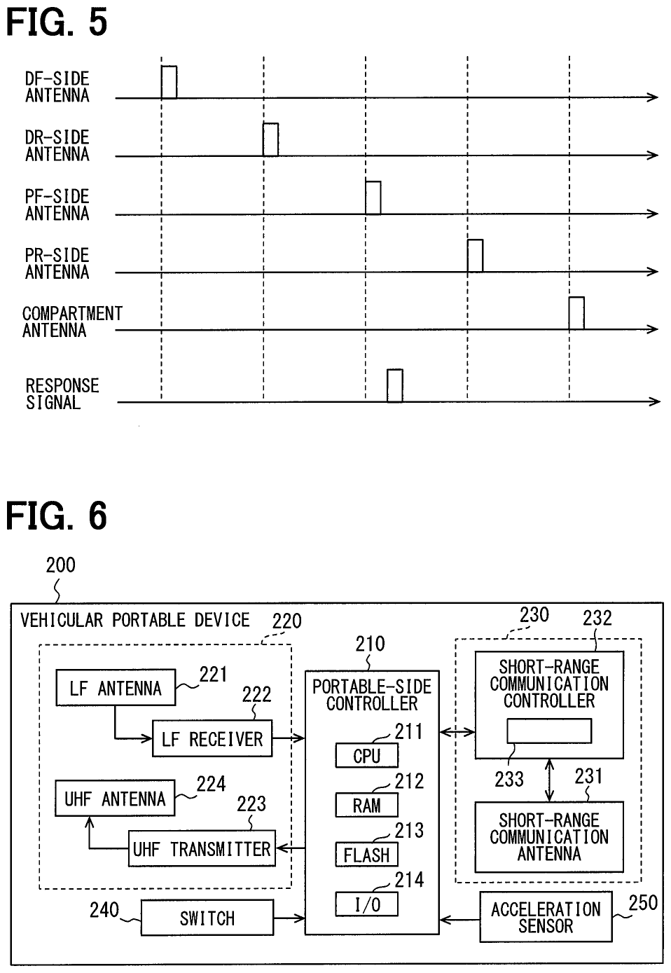

Herein, the location identification signal is sent at regular time intervals in order shown in FIG. 5 as an example, that is, in order of the DF-side antenna 131A, the DR-side antenna 131B, the PF-side antenna 131C, the PR-side antenna 131D, and the compartment antenna 131E.

As has been described above, the LF controller 130 sends the location identification signal from the multiple LF antennae 131 at different timing. The portable device locating section F5 is thus capable of uniquely identifying the LF antenna 131 which has sent the location identification signal responded to by the vehicular portable device 200. For example, in a case as is shown in FIG. 5 where a response signal is received within a certain time after the location identification signal is sent from the PF-side antenna 131C, it is understood that the vehicular portable device 200 has responded to the location identification signal sent from the PF-side antenna 131C.

When the vehicular portable device 200 sends a response signal in response to a signal sent from a particular LF antenna 131, it means that the vehicular portable device 200 is present within the transmission area of the signal-sender LF antenna 131. Hence, the portable device locating section F5 determines that the vehicular portable device 200 is present within the transmission area of the LF antenna 131 to which the response signal is sent.

The transmission area of the DF-side antenna 131A is set to cover an area within a certain range from the door at the driver's seat. Hence, determining that the vehicular portable device 200 is present within the transmission area of the DF-side antenna 131A corresponds to determining that the vehicular portable device 200 is present near the door at the driver's seat. The same applies to a case where it is determined that the vehicular portable device 200 is present within the transmission area of one of the LF antennae 131 provided to the other doors.

A method of identifying the portable device location is not limited to the method described above. Besides the method described above, various other known methods are also applicable.

The vehicle occupant information acquirer section F6 identifies a user holding the vehicular portable device 200, based on the holder information sent from the vehicular portable device 200. Specifically, a user associated with the terminal ID indicated by the holder information is recognized as the portable device holder. The vehicle occupant information acquirer section F6 also identifies a seat (in other words, a seated location) that the portable device holder is going to take, based on the portable device location identified by the portable device locating section F5.

Specifically, the vehicle occupant information acquirer section F6 assumes that the seat associated with the LF antenna 131 covering the transmission area including the portable device location identified by the portable device locating section F5 is the seated location. For example, when the portable device location is within the transmission area of the PF-side antenna 131C, the seated location of the portable device holder is determined as being the front occupant's seat.

This is because, as is shown in FIG. 3, areas around the vehicle V covered by the respective external LF antennae 131 in the present embodiment are limited to areas near the doors at the associated seats. For example, when the portable device location is near the door at the front occupant's seat, the front occupant's seat is highly likely to be the seated location of the portable device holder. Hence, the portable device location identified by the portable device locating section F5 corresponds to the seat that the portable device holder is going to take among the seats provided to the vehicle V.

The display processor section F7 generates image data to be displayed on the display 700 and outputs the image data to the display 700. An image corresponding to the generated image data is thus displayed on the display 700. In short, the display processor section F7 controls a display screen of the display 700. Specific examples of an image displayed by the display processor section F7 will be described separately below.

The user's settings reflection section F8 changes settings of the compartment environment to suit a preference of a user (so-called customization), based on the seated location of the user acquired by the vehicle occupant information acquirer section F6. For example, the user's settings reflection section F8 moves the seat on which a user is seated to a position pre-set by the user. An adjustment of the seat position may be realized by cooperating with the body ECU 600. For example, the body ECU 600 moves a seat to a target position by driving an actuator provided to the seat, based on a command from the user's settings reflection section F8.

### Configuration of Vehicular Portable Device 200

As is shown in FIG. 6, the vehicular portable device 200 includes a portable device-side controller 210, a vehicle communicator 220, a short-range communicator 230, a switch 240, and an acceleration sensor 250. The portable device-side controller 210 is individually connected to the vehicle communicator 220, the short-range communicator 230, the switch 240, and the acceleration sensor 250 to enable communication.

The portable device-side controller 210 is a module for controlling an operation of the vehicular portable device 200 and formed with a normal computer. That is, the portable device-side controller 210 includes a CPU 211, a RAM 212, a flash memory 213, an IO 214, and a bus line interconnecting the foregoing elements.

A program causing a normal computer to function as the portable device-side controller 210 (hereinafter, referred to as a portable device control program) and a vehicle ID assigned to the vehicular portable device 200 for authentication with the vehicle V are pre-installed to the flash memory 213.

It is preferable that the terminal IDs of portable terminals 300 owned by users of the vehicle V are associated with information (for example, user IDs) of users who own respective portable terminals 300 and saved in the flash memory 213. Data indicating a correspondence between the user IDs and the terminal IDs is referred to as terminal management data for ease of description. In a case where a single user owns multiple portable terminals 300, data of such a user may be associated with the respective portable terminals 300 and saved in the flash memory 213. The same applies to the user management data described above.

The vehicle communicator 220 is a communication module for performing communication with the onboard vehicle 100. To describe the configuration more in detail, the vehicle communicator 220 includes an LF antenna 221, an LF receiver 222, a UHF transmitter 223, and a UHF antenna 224.

The LF antenna 221 converts a radio wave in the LF band into an electrical signal which is outputted to the LF receiver 222. The LF receiver 222 generates data by demodulating a signal inputted from the LF antenna 221. The LF receiver 222 provides the portable device-side controller 210 with data obtained by demodulating the received signal.

The UHF transmitter 223 modulates data inputted from the portable device-side controller 210 into an electrical carrier signal which is outputted to the UHF antenna 224. The UHF antenna 224 converts the electrical signal inputted from the UHF transmitter 223 into a radio wave in the UHF band which is radiated to space. The vehicle communicator 220 corresponds to a first communication unit.

The short-range communicator 230 is a module for performing short-range communication with portable terminals 300. To describe the configuration more in detail, the short-range communicator 230 includes a short-range communication antenna 231 and a short-range communication controller 232.

The short-range communication antenna 231 is an antenna for sending and receiving a radio wave in a frequency band used for short-range communication (for example, 2.4 GHz band). The short-range communication controller 232 demodulates a signal received at the short-range communication antenna 231 and provides the portable device-side controller 210 with the demodulated signal, and also modulates a signal inputted from the portable device-side controller 210 and outputs the modulated signal to the short-range communication antenna 231 from which the modulated signal is sent to space.

The short-range communication controller 232 further includes a received signal strength indication detector section 233 for detecting a received signal strength indication of a signal received at the short-range communication antenna 231. The short-range communication controller 232 demodulates the received signal into data and associates the data with the received signal strength indication, which is provided to the portable device-side controller 210. The short-range communicator 230 corresponds to a second communication unit.

The switch 240 is a switch for accepting a user operation on the vehicular portable device 200 and is, for example, a push switch. For example, the user can use a remote keyless entry function of locking and unlocking the doors of the vehicle V by operating (pushing) the switch 240. The switch 240 may include multiple switches 240. The switch 240 used herein as an example includes one switch 240 to lock the doors of the vehicle V and another switch 240 to unlock the doors of the vehicle V.

The acceleration sensor 250 is a sensor for detecting acceleration acting on the vehicular portable device 200. The acceleration sensor 250 outputs a signal indicating acceleration acting on the vehicular portable device 200 to the portable device-side controller 210. The acceleration sensor 250 corresponds to a portable device-side acceleration sensor.

### Function of Portable Device-Side Controller 210

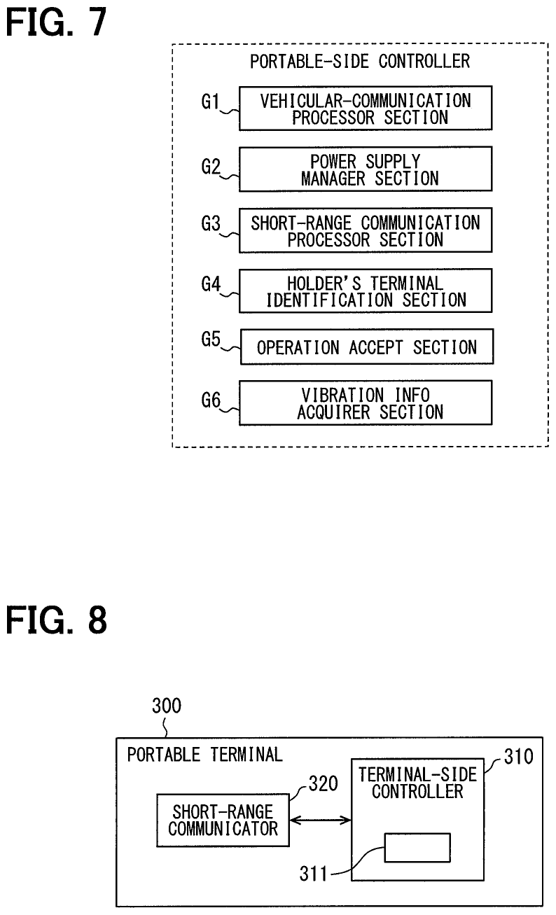

The portable device-side controller 210 includes functional blocks realized by executing the portable device control program. The functional blocks are, as is shown in FIG. 7, a vehicle communication processor section G1, a power supply manager section G2, a short-range communication processor section G3, a holder's terminal identification section G4, an operation accept section G5, and a vibration information acquirer section G6. The foregoing functional blocks, either in part or as a whole, may be realized by hardware in the form of one or more than one IC.

The vehicle communication processor section G1 acquires data received by the LF receiver 222 via the LF antenna 221. The vehicle communication processor section G1 generates a signal to be sent from the UHF antenna 224 and outputs the generated signal to the UHF transmitter 223. That is, the vehicle communication processor section G1 performs software processing related to communication with the onboard device 100.

More specifically, as will be described in the following by way of example, the vehicle communication processor section G1 generates a response signal in response to a signal received from the onboard device 100 and sends the response signal from the UHF antenna 224. For example, when the vehicle communication processor section G1 receives the authentication signal requesting to send the ID code in response, an ID code is generated by encrypting the vehicle ID stored in the flash memory 213 according to a predetermined rule and a signal containing the ID code is sent to the onboard device 100. When the scan command signal is received, a response signal indicating a start of the holder's terminal identification processing is generated and sent to the onboard device 100. When the report command signal is received, a holder information signal containing the holder information is generated and sent to the onboard device 100.

The power supply manager section G2 controls supply of power from a power supply to respective sections in the vehicular portable device 200. For example, when it is not necessary to perform short-range communication with any portable terminal 300, the power supply manager section G2 sets the short-range communicator 230 to a low power consumption mode to reduce power consumption in the short-range communicator 230. The short-range communicator 230 does not perform short-range communication with portable terminals 300 when set in the low power consumption mode. In the low power consumption mode, power consumption may be reduced by stopping supply of power to the entire short-range communicator 230 or by limiting sections supplied with the power. A technology to reduce power consumption in the short-range communicator 230 may be any known technique. A state in which the short-range communicator 230 is permitted to perform short-range communication with portable terminals 300 is referred to as an active mode for ease of description.

The short-range communication processor section G3 acquires data received by the short-range communication controller 232 and a received signal strength indication of the received data. The short-range communication processor section G3 generates a signal to be sent to a portable terminal 300 and outputs the generated signal to the short-range communication controller 232.

The short-range communication processor section G3 also performs processing to detect a portable terminal 300 present near the self-device (hereinafter, referred to as scan processing). For example, the short-range communication processor section G3 enables the short-range communicator 230 to receive a signal from a portable terminal 300 (that is, sets in the active mode) for a time duration corresponding to the notification period in the scan processing.

The short-range communication processor section G3 detects a portable terminal 300 present near the self-device by receiving a notification signal sent from the portable terminal 300 within the time duration. For example, when only the users A and B among the users A through D are present in a range within which the vehicular portable device 200 is capable of performing short-range communication, the short-range communication processor section G3 detects portable terminals 300 carried by the respective users A and B by the scan processing. When all the users A through D are present in a range within which the vehicular portable device 200 is capable of performing short-range communication, the short-range communication processor section G3 detects portable terminals 300 carried by the respective users A through D by the scan processing.

Terminals detected by the scan processing are not limited to portable terminals 300 registered as the portable terminals owned by users of the vehicle V and all communication terminals furnished with a short-range communication function present near the self-device may be detected as well.

Information (for example, the terminal ID) on a portable terminal 300 detected by the scan processing is associated with a received signal strength indication of a signal from the detected portable terminal 300 and managed in, for example, a list format. That is, the short-range communication processor section G3 distinguishes the detected portable terminals 300 by way of the terminal IDs contained in the notification signals received from the detected portable terminals 300. A result of the scan processing is stored into the RAM 212.

The holder's terminal identification section G4 performs processing to identify the holder's terminal. When the vehicle communication processor section G1 receives the scan command signal from the onboard device 100, the holder's terminal identification section G4 first requests the short-range communication processor section G3 to start sampling processing. The sampling processing is processing to perform the scan processing successively at a predetermined time interval (for example, every 50 milliseconds).

Subsequently, when the vehicle communication processor section G1 receives the report requesting signal, the holder's terminal identification section G4 calculates a degree of temporal change (hereinafter, referred to as a variation) in the received signal strength indication for each portable terminal 300, based on the received signal strength indications collected for each portable terminal 300 after reception of the scan command signal until reception of the report command signal.

The holder's terminal identification section G4 determines the holder's terminal among portable terminals 300 present near the self-device, based on a variation in the received signal strength indication calculated for each portable terminal 300. More specifically, the holder's terminal identification section G4 calculates a variance value of the received signal strength indications of a signal received from each portable terminal 300 at multiple time points as a variation for each portable terminal 300. The variance value referred to herein is same as dispersion used in statistics.

A portable terminal 300 with a smallest variance value as the variation is determined as being the holder's terminal. A reason for determining that a portable terminal 300 with the smallest variation in the received signal strength indication among multiple portable terminals 300 is the holder's terminal is as follows.

Generally, a frequency at 2.4 GHz is used for short-range communication. A radio wave at such a high frequency is attenuated markedly by a human body or the like. Hence, even when a same individual holds the vehicular portable device 200 and a portable terminal 300, a received signal strength indication attenuates markedly depending on a positional relationship between the vehicular portable device 200 and the portable terminal 300, for example, in a case where a body of the portable device holder is present between the vehicular portable device 200 and the portable terminal 300 of the portable device holder. In addition, a radio wave at a high frequency has a property of being readily reflected on a metal plate, such as a vehicle body. Hence, a portable terminal with a high received signal strength indication is not necessarily a nearest portable terminal. In some cases, a received signal strength indication may become higher in a portable terminal 300 held by another user than in the portable terminal 300 carried by the same individual depending on output levels of the portable terminals 300, antenna directivity of the portable terminals 300 and the vehicular portable device 200, and surrounding environments.

Meanwhile, it is expected that a change rate of a received signal strength indication is small unless a positional relationship between the vehicular portable device 200 and the portable terminal 300 established by the portable device holder changes. In addition, a received signal strength indication from a portable terminal 300 held by a user other than the portable device holder is highly likely to vary markedly with a positional relationship between the portable device holder and the other user, orientations of the bodies, and so on.

In short, a portable terminal 300 with the smallest variation in the received signal strength indication is highly likely to be the holder's terminal. In accordance with the idea as above, the holder's terminal identification section G4 determines a portable terminal 300 with the smallest variation in the received signal strength indication as being the holder's terminal in the present embodiment. By identifying the holder's terminal based on a variation in the received signal strength indication instead of magnitude of the received signal strength indication, the holder's terminal is identifiable at a higher degree of accuracy.

A variance value of a population adopted herein as a variation by way of example is a variance value of the received signal strength indications detected at multiple time points. However, the present disclosure is not limited to the example above. A variation may be a difference between a highest value and a lowest value of the received signal strength indications detected at multiple time points. Other measures used to quantify an amount of variation, for example, a standard deviation, may be adopted as a variation as well.

In a case where only one portable terminal 300 is present near the self-device and a received signal strength indication from the only one portable terminal 300 is at or above a predetermined received strength indication threshold, the only one portable terminal 300 is determined as being the holder's terminal. The received strength indication threshold is a threshold for determining whether a distance from the vehicular portable device 200 to the detected portable terminal 300 is equal to or longer than a certain distance (for example, 10 m). In a case where no portable terminal 300 with a received signal strength indication at or above the received strength indication threshold is present near the self-device, absence of the holder's terminal is determined. The received strength indication threshold used herein may correspond to a lower-limit value of a signal level at or above which the vehicular portable device 200 is capable of receiving signals from portable terminals 300.

After the holder's terminal identification section G4 determines the holder's terminal, the terminal ID of the holder's terminal is provided to the vehicle communication processor section G1. Upon receipt of the report command signal, the vehicle communication processor section G1 sends a holder information signal containing the holder information specified by the terminal ID of the holder's terminal to the onboard device 100. As has been described, the holder information referred to in the present embodiment is the terminal ID of the holder's terminal. In a case where the holder's terminal identification section G4 determines the absence of the holder's terminal, the vehicle communication processor section G1 sends a holder information signal informing the absence of the holder's terminal to the onboard device 100. Alternatively, the vehicular portable device 200 may send the user ID associated with the terminal ID of the holder's terminal as the holder information.

Hereinafter, the received signal strength indications at multiple time points used to calculate a variation are referred to as identification received strength indication data, and a period of collecting the received signal strength indications as the identification received strength indication data is referred to as a sampling period for ease of description. In the present embodiment, a period from a start of the scan direction signal to reception of the report command signal corresponds to the sampling period.

The present embodiment is configured such that the received signal strength indications acquired after reception of the scan command signal to reception of the report command signal are adopted as the identification received strength indication data. However, the present disclosure is not limited to the configuration as above. For example, the received signal strength indications collected until a predetermined sampling time elapses after reception of the scan command signal may be adopted as the identification received strength indication data. The sampling time is preferably long enough for a change to occur in a radio wave propagation environment for short-range communication, such as a positional relationship between the portable device holder and a user other than the portable device holder. For example, the sampling time may be several to ten seconds. It should be noted, however, that the sampling period is not limited to a period from reception of the scan command signal to reception of the report command signal, which will be described in a fifth modification below.

In the present embodiment, upon receipt of the report command signal, the sampling processing is aborted and the short-range communicator 230 is switched to the low-power consumption mode, from viewpoints of reducing power consumption. It goes without saying, however, that the sampling processing may be continued after reception of the report command signal.

The operation accept section G5 identifies a user's operation on the switch 240 based on a control signal inputted from the switch 240, and provides the other functional sections with contents of the operation. The respective sections then perform processing in accordance with the content of the user's operation identified by the operation accept section G5. For example, when the operation accept section G5 detects that the switch 240 to unlock the doors of the vehicle V is pushed by the user, the vehicle communication processor section G1 sends a signal directing to unlock the doors to the onboard device 100. The vibration information acquirer section G6 acquires acceleration acting on the vehicular portable device 200, which is provided from the acceleration sensor 250.

### Configuration of Portable Terminal 300

As has been described, each portable terminal 300 only needs to be furnished with a function of performing short-range communication, and various types of portable communication devices, such as a smartphone, can be adopted as the portable terminal 300 of the present embodiment. FIG. 8 shows a schematic configuration of the portable terminal 300. As is shown in FIG. 8, the portable terminal 300 includes a terminal-side controller 310 and a short-range communicator 320.

The terminal-side controller 310 is formed with a computer including a CPU, a RAM, a flash memory, an IO, and so on, and performs various types of processing by executing a portable terminal program pre-installed to the flash memory. Functions performed by the terminal-side controller 310, either in part or as a whole, may be formed with hardware in the form of one or more than one IC.

The terminal-side controller 310 includes a storage section 311 realized by a non-volatile storage medium, such as a flash memory. The storage section 311 pre-stores a terminal ID unique to the portable terminal 300 and various types of software.

The short-range communicator 320 is a communication module for the portable terminal 300 to perform short-range communication with the vehicular portable device 200 and is of a same configuration as the short-range communicator 230 provided to the vehicular portable device 200.

### Holder Identification Related Processing

Processing which is performed by each of the vehicle-side controller 110 of the onboard device 100 and the portable device-side controller 210 of the vehicular portable device 200 and which is for the onboard device 100 to identify a user holding the vehicular portable device 200 and a seated location of the user will now be described. Processing performed by the vehicle-side controller 110 is referred to as processing at a vehicle end and processing performed by the portable device-side controller 210 of the vehicular portable device 200 is referred to as processing at a portable device end for ease of description. The processing at the vehicle end and the processing at the portable device end are referred to collectively as holder identification related processing.

### Processing at Vehicle End

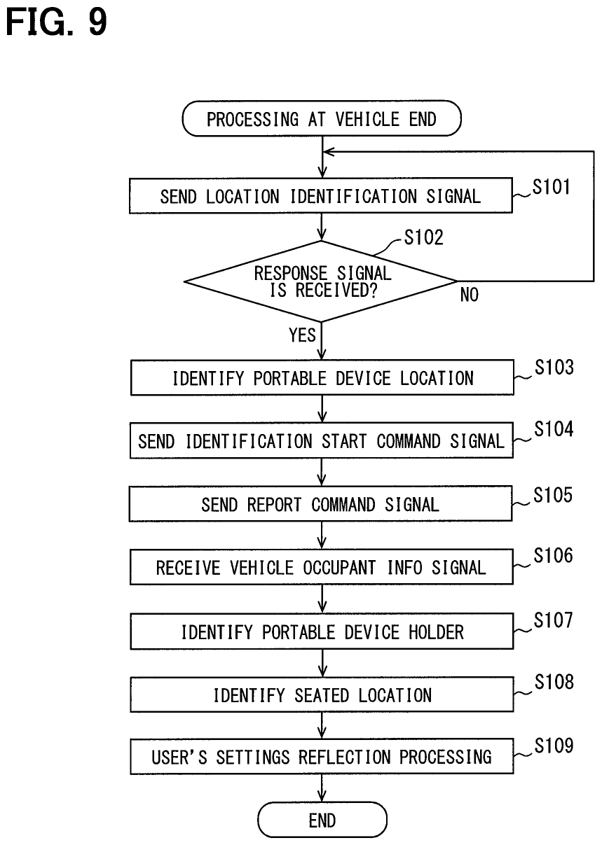

The processing at the vehicle end will be described first by using a flowchart of FIG. 9. The processing at the vehicle end is started, for example, upon successful authentication between the onboard device 100 and the vehicular portable device 200 via wireless communication succeeds during the parking of the vehicle V. That is, the processing at the vehicle end is started upon successful authentication with the vehicular portable device 200 present outside the compartment. It goes without saying that a condition for starting the processing at the vehicle end may be designed as needed. For example, the processing at the vehicle end may be started upon detecting the vehicular portable device 200 entering the vehicle communication range.

In Step S101, the transmission processor section F1 sends the location identification signal from a particular LF antenna 131 (for example, the DF-side antenna 131A). The flow then proceeds to Step S102. In Step S102, the reception processor section F2 determines whether a response signal to the location identification signal sent in Step S101 is received.

When the response signal is received, a positive determination is made in Step S102 and the flow proceeds to Step S103. Meanwhile, in a case where no response signal is received when a certain time has elapsed after Step S101 is performed, the flow returns to Step S101. The transmission processor section F1 then sends the location identification signal from an LF antenna 131 different from the LF antenna 131 which has sent the location identification signal last time. In short, Steps S101 and S102 are processing for sending the location identification signal from the multiple LF antennae 131 in turn. An order in which the multiple LF antennae 131 send the location identification signal may be designed as needed. In a case where no response signal is obtained after the location identification signal is sent from all the LF antennae 131, the operation may be started all over again from the authentication processing.

In Step S103, the portable device locating section F5 identifies the portable device location based on the transmission area of the LF antenna 131 (hereinafter, referred to as a response acquisition antenna) which sent the location identification signal in response to which the response signal was sent. The flow then proceeds to Step S104.

In Step S104, the transmission processor section F1 sends the scan command signal from a predetermined LF antenna 131 via the LF controller 130. The flow then proceeds to Step S105. The scan command signal may be sent from all the LF antennae 131 in turn or may be sent from only the LF antenna 131 which sent the location identification signal in response to which the response signal was given in Step S102.

In Step S105, the transmission processor section F1 sends the report command signal. The flow then proceeds to Step S106. An LF antenna 131 from which to send the report command signal is same as the LF antenna 131 from which the scan command signal is sent. The report command signal may be sent at timing when the sampling time has elapsed after the scan command signal was sent in Step S104.

In Step S106, the holder information signal sent from the vehicular portable device 200 is received. The flow then proceeds to Step S107. In Step S107, the user serving as the portable device holder is identified based on the terminal ID serving as the holder information contained in the holder information signal and the user management data stored in the flash memory 113. In short, the user associated with the terminal ID serving as the holder information is found by referring to the user management data and recognized as the portable device holder.

In Step S108, the vehicle occupant information acquisition proton F6 identifies the seated location of the user as the portable device holder based on the portable device location identified by the portable device locating section F5 in Step S104. The flow then proceeds to Step S109. In Step S109, the user's settings reflection section F8 changes the settings to change the compartment environment, such as a position of the seat identified in Step S109, a target temperature of air-conditioned air, and an air volume, to suit a preference of the user corresponding to the portable device holder identified in Step S108. The flow is then ended.

### Processing at Portable Device End

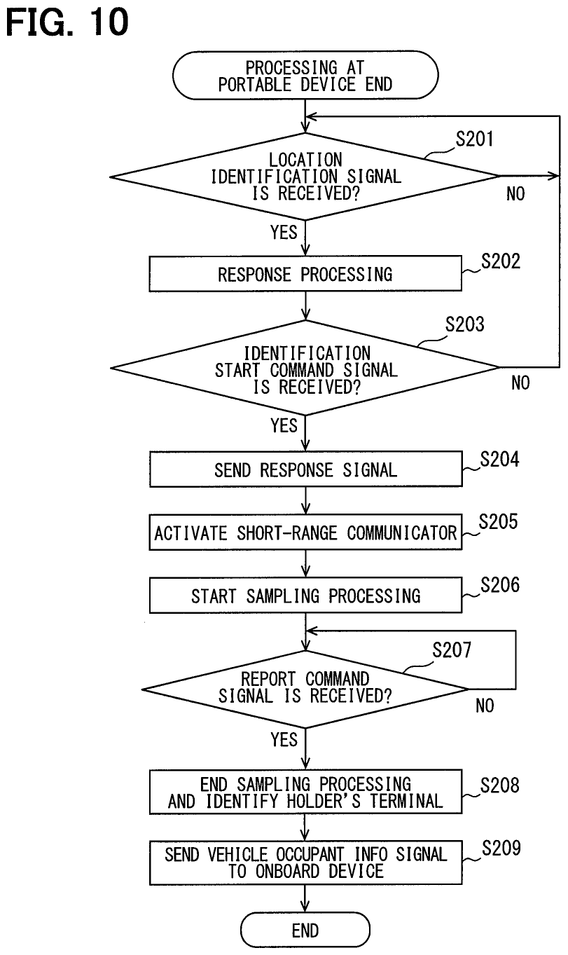

The processing at the portable device end will now be described by using a flowchart of FIG. 10. A condition for starting the processing at the portable device end may be designed as needed. Herein, as with the processing at the vehicle end, the processing at the portable device end starts when authentication between the onboard device 100 and the vehicular portable device 200 via wireless communication succeeds. It should be noted that the short-range communicator 230 is in the low power consumption mode when the flow is started.

In Step S201, the vehicle communication processor section G1 determines whether the location identification signal is received. When the location identification signal is received, a positive determination is made in S201 and the flow proceeds to Step S202. Meanwhile, when the location identification signal is not received, a negative determination is made in Step S201 and Step S201 is repeated. In a case where no location identification signal is received when a certain time has elapsed after the flow was started, in other words, after the authentication processing was completed, the operation may be started all over again from the authentication processing.

In Step S202, a response signal in response to the location identification signal received in Step S201 is sent. The flow then proceeds to Step S203. In Step S203, a determination is made as to whether the scan command signal is received. When the scan command signal is received, a positive determination is made in Step S203 and the flow proceeds to Step S204. Meanwhile, in a case where the scan command signal is not received when the scan command signal is waited for a certain time after the response signal was sent in Step S202, a negative determination is made in Step S203 and the flow returns to Step S201.

In Step S204, the vehicle communication processor section G1 sends a response signal, which informs duly receipt of the scan command signal. The flow then proceeds to Step S205. In Step S205, the power supply manager section G2 switches the short-range communicator 230 from the low power consumption mode to the active mode. The flow then proceeds to Step S206.

In Step S206, the short-range communication processor section G3 starts the sampling processing. The flow then proceeds to Step S207. In Step S207, the vehicle communication processor section G1 determines whether the report command signal is received. When the report command signal is received, a positive determination is made in Step S207 and the flow proceeds to Step S208. A determination in Step S207 is made repetitively until the report command signal is received.

In Step S208, the short-range communication processor section G3 ends the sampling processing while the holder's terminal identification section G4 calculates a variation in the received signal strength indication for each portable terminal 300 based on the received signal strength indications collected for each portable terminal 300 in Step S205, and a portable terminal 300 with the smallest variation is determined as being the holder's terminal. The flow then proceeds to Step S209. The power supply manager section G2 switches the short-range communicator 230 to the low power consumption mode when the sampling processing is completed.

In Step S209, the vehicle communication processor section G1 sends the holder information signal to the onboard device 100. The flow is then ended.

In the present embodiment, the onboard device 100 is configured to send the report command signal and the vehicular portable device 200 is configured to send the holder information signal upon reception of the report command signal as an example. However, the present disclosure is not limited to the configuration of the example. The onboard device 100 may not send the report command signal. In such a case, the vehicular portable device 200 may send the holder information signal when identification of the holder's terminal by the holder's terminal identification section G4 is completed.

### Summary of Present Embodiment

The vehicular portable device 200 detects a portable terminal 300 present near the self-device by performing the scan processing while acquiring received signal strength indications of signals sent from respective portable terminals 300. Further, the vehicular portable device 200 determines the holder's terminal based on the variations in received signal strength indications of signals sent from the respective portable terminals 300, and sends the holder information signal containing the terminal ID of the holder's terminal to the onboard device 100. In a case where the vehicular portable device 200 receives the location identification signal sent from the onboard device 100, the vehicular portable device 200 sends a response signal in response to the location identification signal.

Meanwhile, the onboard device 100 identifies a user holding the vehicular portable device 200, based on the holder information signal sent from the vehicular portable device 200. Also, the onboard device 100 identifies the portable device location by receiving the response signal sent from the vehicular portable device 200 in response to the location identification signal and identifies a seated location of the portable device holder based on the portable device location thus identified. The onboard device 100 then identifies the seated location of a user acting as the portable device holder by associating the identified seated location with the user acting as the portable device holder.

With the configuration as above, in order to estimating the seated location of a user who is to use the vehicle, it is not necessary to provide the vehicle V with multiple receivers for short-range communication with a portable terminal 300. It may be sufficient that the vehicular portable device 200 is furnished with a function of performing short-range communication with a portable terminal 300. Consequently, the number of receivers for short-range communication with a portable terminal 300 can be reduced, which can in turn reduce introduction costs of the system that identifies the seated location of the user (that is, the vehicle occupant information acquisition system).

In particular, the configuration of the present embodiment can be realized by using equipment of an existing smart entry system. Hence, the introduction costs of the vehicle occupant information acquisition system can be further reduced. In addition, a design change of the existing system caused by introducing the vehicle occupant information acquisition system can be small.

While the above has described the embodiment by way of example, a technical idea of the present disclosure can be implemented by various embodiments including modifications described below. Two or more various modifications described below may be combined as needed as an embodiment.

Members furnished with same functions as the members described in the embodiment above are labelled with same reference numerals and a description is omitted. When only a part of the configuration is described, the configuration of the embodiment above is applied to a rest of the configuration.

### First Modification

A first modification relates to the method of identifying an LF antenna 131 to which the vehicular portable device 200 has responded.

The above-described embodiment is configured to identify a sender LF antenna 131 of the location identification signal to which the vehicular portable device 200 responds, by sending the location identification signal from the multiple LF antennae 131 with shifted transmission timing by way of example. However, the present disclosure is not limited to the configuration as above.

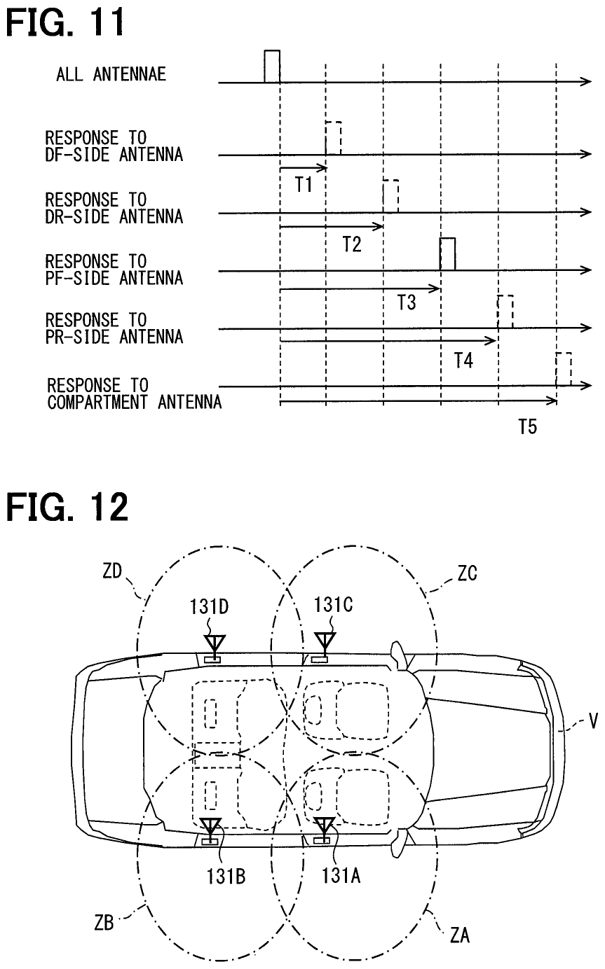

For example, in a case where the transmission areas of the multiple LF antennae 131 are designed not to overlap (in other words, not to interfere with each other), as is shown in a top row of FIG. 11, the location identification signal may be broadcasted from all the LF antennae 131.

In such a case, the location identification signal sent from the respective LF antennae 131 designates response timing that differs from one LF antenna 131 to another. For example, when a predetermined first wait time T1 has elapsed after reception of the location identification signal, the location identification signal sent from the DF-side antenna 131A designates return timing for a response signal to be sent. In FIG. 11, T2 through T5 also conceptually indicate waiting times designating return timing for each LF antenna 131.

Even when the transmission timing is same, the onboard device 100 is capable of identifying a sender antenna according to timing when a response signal is sent from the vehicular portable device by designating different return timing to each LF antennal 131 as above.

For example, in a case where the onboard device 100 receives a response signal when a third waiting time T3 has elapsed after the location identification signal is broadcasted, the PF-side antenna 131C is determined as being the sender of the location identification signal responded to by the vehicular portable device 200.

The sender antenna can be identified also by the configuration described in the first modification. In addition, because the location identification signal is broadcasted from the respective LF antennae 131, a worst value of a time required to identify the portable device location can be improved.

### Second Modification

A second modification relates to transmission areas of the LF antennae 131.

In the embodiment above, the transmission areas of the LF antennae 131 (the DF-side antenna 131A and so on) associated with the respective seats are areas outside the compartment near the doors at the associated seats as is shown in FIG. 3. However, the present disclosure is not limited to the configuration as above. In a second modification as is shown in FIG. 12, transmission areas of the DF-side antenna 131A, the DR-side antenna 131B, the PF-side antenna 131C, and the PR-side antenna 131D may be set to include space in the compartment near the seats associated with the respective LF antennae 131. In FIG. 12, the compartment antenna 131E and the transmission area of the compartment antenna 131E are omitted.

### Third Modification

A third modification relates to the method of identifying the portable device location.

The method of identifying the portable device location is not limited to the method described above. The portable device location may be identified by using a configuration described below as the third modification. In the third modification, a radio wave arrival distance of the respective LF antennae 131 is set to several to ten meters and the LF antennae 131 are designed in such a manner that a transmission area of each LF antenna 131 overlaps transmission areas of the other LF antennae 131 in most part.

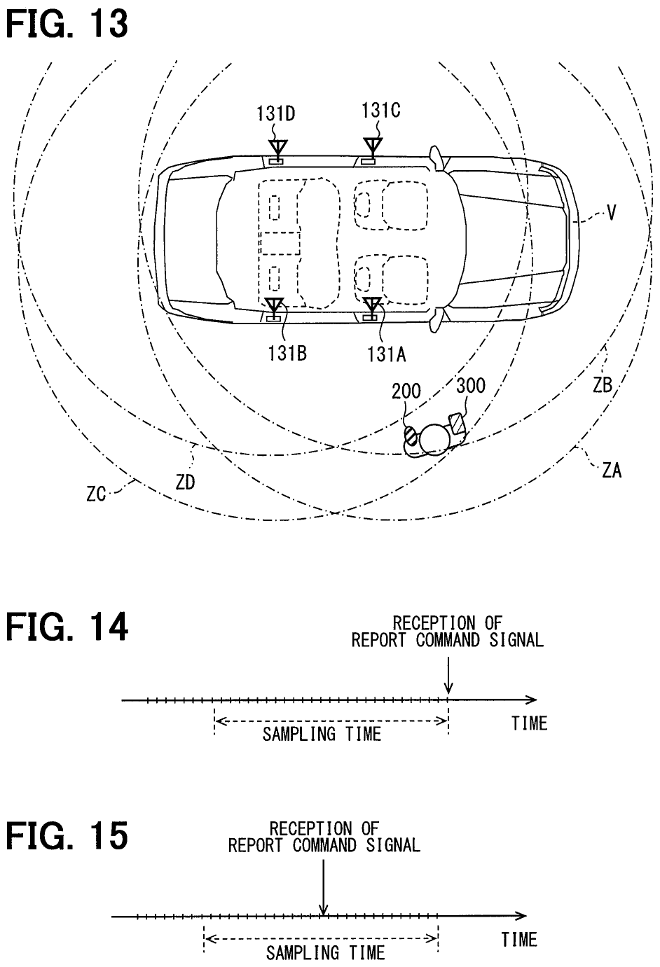

FIG. 13 conceptually shows the transmission areas of the respective LF antennae 131 in the third modification. In FIG. 13, the compartment antenna 131E and the transmission area of the compartment antenna 131E are omitted for ease of illustration. However, the compartment antenna 131E is also designed to form a transmission area large enough to cover an area outside the compartment. As in the embodiment above, the vehicle-side controller 110 sends the location identification signal from the multiple LF antennae 131 in turn by shifting timing.

Upon receipt of the location identification signal, the vehicular portable device 200 sends a response signal containing information indicating a received signal strength indication (hereinafter, referred to as received strength indication information). It should be noted that the vehicle communicator 220 of the vehicular portable device 200 is equipped with a circuit which detects a received signal strength indication of a signal in the LF band as a precondition.

The portable device locating section F5 estimates a distance between the sender antenna and the vehicular portable device 200 according to the received strength indication information contained in the response signal. The portable device locating section F5 then identifies the portable device location according to distances from three LF antennae 131 set at different locations and the set locations of the three LF antennae 131 in the vehicle V.

Generally, a wireless signal attenuates while propagating in space. Hence, a received signal strength indication takes a smaller value as a distance between the vehicular portable device 200 and an LF antenna 131 increases. The portable device locating section F5 is thus capable of finding a distance between an LF antenna 131 which has sent the location identification signal and the vehicular portable device 200 according to the received strength indication information contained in the response signal sent in response to the location identification signal.

For example, the portable device locating section F5 identifies a distance between an LF antenna 131 which has sent the location identification signal and the vehicular portable device 200 from a received signal strength indication of the location identification signal according to distance conversion data indicating a correspondence between distances from LF antennae 131 to the vehicular portable device 200 and received signal strength indications. The distance conversion data may be generated from various tests and preliminarily registered in the flash memory 113 as a part of the vehicle control program.

According to the configuration as above, the portable device locating section F5 is capable of identifying the location of the vehicular portable device 200 with respect to the vehicle V when response signals in response to the location identification signal sent from at least three LF antennae 131 are received.

The LF antennae 131 may be set to the vehicle V at locations about an arbitrary location of the vehicle V as points on a two-dimensional coordinate parallel to a road surface. For example, an X axis of a two-dimensional coordinate system may be parallel to a front-rear direction of the vehicle and a Y axis may be an axis parallel to a vehicle width direction. A center of the two-dimensional coordinate system may be set to, for example, a center of a rear wheel axis. Data indicating the set locations of the LF antennae 131 and the like in the vehicle V as above is referred to as vehicle body setting data. The vehicle body setting data includes locations where the respective seats are provided. The vehicle body setting data may be stored in the flash memory 113 or the body ECU 600.

The identified portable device location may also be expressed as a point on the two-dimensional coordinate system. The vehicle occupant information acquirer section F6 deems a seat nearest from the portable device location identified by the portable device locating section F5 as being the seat corresponding to the present portable device location. In short, a seat nearest from the portable device location identified by the portable device locating section F5 is determined as being the seated location of the portable device holder.

According to the configuration as above, the portable device location and the seated location of the portable device holder can be also identified.

### Fourth Modification

A fourth modification relates to transmission timing of the scan command signal.

A condition by which to send the scan command signal (hereinafter, referred to as a scan directing condition) may be set as needed. For example, a detection of the vehicular portable device 200 entering the communication range of the onboard device 100, a success of authentication with the vehicular portable device 200, touching on the touch sensor 140 by a user when the authentication succeeds, a detection of opening of the door of the vehicle V by the curtesy switch 603, and so on may be adopted as the scan directing condition. Further, a detection of presence of the vehicular portable device 200 inside the compartment of the vehicle, a detection of a user seated on the driver's seat by the vehicle occupant detection sensor 604, a detection of closing the door at the driver's seat, a detection of fastening of a seatbelt, a depression of the start button 150, and so on may be adopted as the scan direction condition as well. The scan directing condition may be a combination of the foregoing conditions.

In short, the scan directing condition, in other words, timing when the scan command signal is sent, may be designed as needed. Whether the scan directing condition is satisfied or not may be determined by the transmission processor section F1 according to the vehicle information acquired by the vehicle information acquirer section F3.

### Fifth Modification

A fifth modification relates to the sampling period.

The above has described the configuration in which the holder's terminal identification section G4 controls the short-range communication processor section G3 to start the sampling processing upon receipt of the scan command signal as an example. However, the present disclosure is not limited to the configuration of the example. The holder's terminal identification section G4 may cause the sampling processing to start upon receipt of a signal for a different purpose, such as the polling signal and the authentication signal.

Alternatively, the holder's terminal identification section G4 may cause the sampling processing to start when the operation accept section G5 detects a push operation on the switch 240 by a user or when a signal indicating acceleration at or above a predetermined threshold is inputted from the acceleration sensor 250. Results of the scan processing performed successively are saved in the RAM 212 or the like for at least the sampling time.

In a case where the vehicular portable device 200 is configured to start the sampling processing by an event other than reception of the scan direction signal, the onboard device 100 may not send the scan command signal and may instead send the report command signal when a predetermined report directing condition is satisfied.

When configured in such a manner, the vehicular portable device 200 is capable of identifying the holder's terminal by calculating a variation in received signal strength indication for each portable terminal 300 according to results of the scan processing performed within a previous sampling time before a time point when the report command signal is received. As is shown in FIG. 14, the fifth modification corresponds to a configuration which adopts a period up to a previous sampling time from the time point when the report command signal is received as the sampling period.

Alternatively, as is shown in FIG. 15, the holder's terminal may be determined according to results of the scan processing performed multiple times over a certain time before and after the time point when the report command signal is received. In other words, the sampling period may be set to extend before and after a time point when the report command signal is received. The vehicular portable device 200 may be configured to continue the sampling processing even after the holder information signal is sent in responding to reception of the report command signal.

While the above has described cases where the sampling period is set in various manners, a period of time used as the sampling period is determined in reference to a time point when either the scan command signal or the report command signal is received in any case. Hence, each of the scan command signal and the report command signal corresponds to a command signal.

### Sixth Modification

A sixth modification relates to presentation of a candidate driver. In a case where a seat other than the driver's seat is determined as being the seated location of the portable device holder, the display processor section F7 may display a screen showing a list of users other than the portable device holder on the display 700 for users to input a user as the driver. For example, in a case where the user A is determined as being the portable device holder among the users A through D and a seat other than the driver's seat is determined as the seated location of the user A, the display processor section F7 controls the display 700 to display a screen with which a user as the driver is selected among the users B through D.

According to the configuration as above, even when a user other than a user who behaves as the driver holds the vehicular portable device 200, the onboard device 100 is capable of recognizing the user as the driver.

It can be said that a case where a seat other than the driver's seat is determined as being the seated location of the portable device holder corresponds to an example of a case where a user as the driver is not identified. It is preferable that the display processor section F7 displays the screen described above on the display 700 when a user seated on the driver's seat is not identified besides the case where a seat other than the driver's seat is determined as being the seated location of the portable device holder. For example, the display processor section F7 may display the screen described above on the display 700 when the seated location of the portable device holder is not identified. The display processor section F7 performing the processing described above corresponds to a candidate driver presentation processing unit.

### Seventh Modification

A seventh modification relates to a configuration in which information on a vehicle occupant other than the portable device holder is also sent to the onboard device 100.

The vehicular portable device 200 may send vehicle occupant information showing a list of users present near the self-device to the onboard device 100 in addition to the holder information. The vehicle occupant information may be a list of the terminal IDs of portable terminals 300 detected in the sampling processing or a list of the user IDs specified by the terminal IDs. The terminal ID may be converted to the user ID by referring to the terminal management data stored in the flash memory 213.

Meanwhile, the vehicular portable device 200 may be configured to send the holder information signal containing the vehicle occupant information in addition to the holder information. The vehicle occupant information may be sent to the onboard device 100 as a signal separate from the holder information signal.

According to the configuration as above, the onboard device 100 is capable of recognizing users who are going to take a ride in a present trip among all the registered users. In short, the onboard device 100 is capable of recognizing a user as a vehicle occupant other than the portable device holder. For example, in a case where the acquired occupant information contains the terminal IDs of the users A and B, it is determined that the users A and B are going to take a ride.

In a case where it is determined that the user A is the portable device holder and the seated location of the user A is the front occupant's seat in the circumstance as above, it can be determined that the seated location of the other user B is a seat other than the front occupant's seat.

When the seventh modification is combined with the sixth modification above, the system becomes more convenient for users in a case where a user other than a user who behaves as the driver holds the vehicular portable device 200. That is, the display processor section F7 may display a screen showing a list of users other than the portable device holder on the display 700 for users to input a user as the driver.

### Eighth Modification

An eighth modification relates to a configuration in which multiple vehicular portable devices 200 are present.

The above has described cases where one vehicular portable device 200 is associated with the vehicle V by way of example. However, the present disclosure is not limited to the configuration of the example. Even when two or more vehicular portable devices 200 are associated with the vehicle V, same processing may be performed for each vehicular portable device 200.

In the eighth modification, multiple vehicular portable devices 200 send signals containing unique portable device IDs, and the onboard device 100 distinguishes a communication party according to the portable device ID contained in a received signal. In such a case, the authentication processing between the onboard device 100 and the vehicular portable device 200 may be performed by using the portable device ID instead of the vehicle ID.

### Ninth Modification

A ninth modification relates to an acquisition source of user's setting data.

The embodiment above is of the configuration in which the vehicle setting information of respective users is registered individually in the onboard device 100. However, the present disclosure is not limited to the configuration as above. The vehicle setting information of each user may be saved in a portable terminal 300 owned by each user. In such a case, the vehicle setting information is acquired from a portable terminal 300 determined as being the holder's terminal by the vehicular portable device 200 and further forwarded to the onboard device 100. The configuration as above is referred to as a user's setting forwarding method.

Alternatively, the vehicle settings of each user may be allocated to and stored in related ECUs which control actuators and electronic devices according to the vehicle settings while the onboard device 100 may notify the respective ECUs of the user ID identifying the portable device holder. When configured in such a manner, the ECU reads out the vehicle settings associated with the user ID notified from the onboard device 100 and changes the settings.

For example, the body ECU 600 may store settings of the seat position for each user, a navigation ECU may store settings of the navigation device for each user, and an air-conditioning ECU controlling an air-conditioning system may store air-conditioning settings, such as a compartment internal temperature. The ECUs thus read out settings associated with the user ID notified from the onboard device 100 and reflects the user's settings on the compartment environment. In a case where a user ID notification method as above is adopted, the onboard device 100 only needs to hold the user IDs of users of the vehicle V. In a case where the vehicular portable device 200 sends the terminal ID as the holder information, the onboard device 100 may hold the user ID and the terminal ID associated with each other.

Effects same as the effects obtained by the embodiment and the modifications above can be achieved also by the user ID notification method as above, by which the onboard device 100 merely notifies the respective ECUs of the user ID and the respective ECUs reflect the settings associated with the notified user ID on the compartment environment. In addition, when the user ID notification method is adopted, the ECUs are enabled to individually determine as to which settings are to be applied.

Further, when the user ID notification method is adopted, even when a new service that can be set as each user prefers becomes available, users are allowed to use the service once users, a designer, a dealer or the like registers settings for each user in an ECU providing the service. In other words, it is not necessary to rewrite software in the onboard device 100 to provide a new service available each time a new service appears. The user ID notification method is flexibly applicable to a new function added to the vehicle. The user setting forwarding method described at the beginning of the ninth modification is also flexibly applicable to a function newly added to the vehicle.

### Tenth Modification

A tenth modification relates to the method of identifying the portable device holder.

The method of identifying a user as the portable device holder who is going to use the vehicle V while the vehicle V is parked is not limited to the method described in the embodiment above by way of example. The portable device holder can be identified by a method described below. The various modifications applied to the embodiment as has been described above are also applicable to the tenth modification unless a contradiction arises.

Processing to identify the portable device holder in the tenth modification includes processing performed by the vehicle-side controller 110 (hereinafter, referred to as holder information acquisition processing), and processing performed by the vehicular portable device 200 (hereinafter, referred to as holder information providing processing). The holder information providing processing is processing in response to the holder information acquisition processing performed by the vehicle-side controller 110. Each processing will be described in the following.

### Holder Information Acquisition Processing

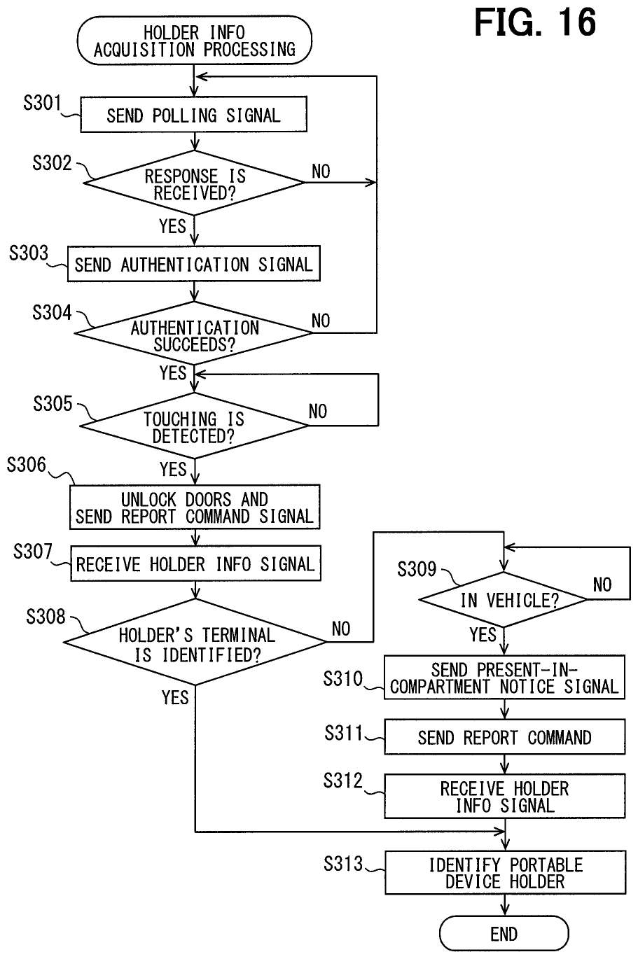

Firstly, the holder information acquisition processing performed by the vehicle-side controller 110 will be described by using a flowchart of FIG. 16. The holder information acquisition processing is processing to acquire the holder information. The vehicle occupant information acquisition processing may be started when the authentication processor section F4 detects that the vehicle V is parked.

In Step S301, the transmission processor section F1 sends the polling signal from a predetermined LF antenna 131 in response to a request from the authentication processor section F4. It is not necessary to identify the portable device location in acquiring the holder information. Hence, the polling signal and the authentication signal may be sent at a time from the respective LF antennae 131. It goes without saying that transmission timing may be shifted from one LF antenna 131 to another as in the embodiment above. The flow proceeds to Step S302 after the polling signal is sent from the predetermined LF antenna 131.

In Step S302, the reception processor section F2 determines whether a response signal to the polling signal sent in Step S301 is received. When the response signal is received, a positive determination is made in Step S302 and the flow proceeds to Step S303. Meanwhile, in a case where no response signal is received when a certain time has elapsed after transmission of the polling signal in Step S301, a negative determination is made in Step S302 and the flow returns to Step S301. Accordingly, the onboard device 100 continues to send the polling signal regularly at a predetermined time interval until a response signal to the polling signal is received.

In Step S303, the transmission processor section F1 sends the authentication signal from the LF antenna 131 in response to a request from the authentication processor section F4. The flow then proceeds to Step S304. In Step S304, a determination is made as to whether authentication of the vehicular portable device 200 succeeds.

More specifically, a success of the authentication is determined when the response signal to the authentication signal sent in Step S303 is received and the ID code indicated by the received signal establishes a predetermined relationship with the vehicle ID registered in the onboard device 100. Meanwhile, a failure of the authentication is determined when no response signal is received within a certain time after transmission of the authentication signal or the ID code indicated by the response signal does not establish a predetermined relationship with the vehicle ID.

When the authentication succeeds, a positive determination is made in Step S304 and the flow proceeds to Step S305. Also, when the authentication succeeds, the authentication processor section F4 sets the respective doors provided to the vehicle to a ready-to-unlock state. The ready-to-unlock state is a state in which a user is able to unlock the doors by merely touching the touch sensor 140 of any door. Meanwhile, when the authentication fails, a negative determination is made in Step S304 and the flow returns to Step S301.

In Step S305, the vehicle information acquirer section F3 determines whether the user has touched the door handle (to be more exact, the touch sensor 140) according to a signal inputted from the touch sensor 140. When a signal indicating touching by the user is inputted from the touch sensor 140, a determination that the user has touched the door handle is made. The flow then proceeds to Step S306. The determination processing in Step S305 is performed repetitively until a signal indicating touching by the user is inputted from the touch sensor 140. However, the flow may return to Step S301 when no touching is detected after an elapse of a certain time.

In Step S306, the authentication processor section F4 cooperates with the body ECU 600 and unlocks the vehicle doors. Also, the transmission processor section F1 sends the report command signal in response to a request from the authentication processor section F4. The flow then proceeds to Step S307. In Step S307, the reception processor section F2 receives the holder information signal sent as a response from the vehicular portable device 200. The flow then proceeds to Step S308.

Although it will be described in detail below, the holder information returned in Step S307 may indicate “unknown holder” because the vehicular portable device 200 fails in identifying the portable device holder. That is, the holder information indicating that the holder's terminal is unknown may be sent as a response. It goes without saying that the holder information indicating the terminal ID of the portable terminal 300 is sent when the holder's terminal is successfully identified.

In Step S308, a determination is made as to whether the vehicular portable device 200 succeeds in identifying the holder's terminal by referring to the holder information indicated by the holder information signal received in Step S307. In a case where the vehicular portable device 200 succeeds in identifying the holder's terminal, a positive determination is made in Step S308 and the flow skips to Step S313. Meanwhile, in a case where the vehicular portable device 200 fails in identifying the holder's terminal, a negative determination is made in Step S308 and the flow proceeds to Step S309.

In Step S309, whether the portable device holder has gotten into the vehicle V is determined. A condition by which to determine that the portable device holder has gotten into the vehicle V may be designed as needed. As an example, it is determined that the portable device holder has gotten into the vehicle V in a case where the authentication signal is sent from the compartment antenna 131E and authentication of the vehicular portable device 200 succeeds.

Alternatively, it may be determined that the vehicular portable device holder has gotten into the vehicle V when it is detected that the door of the vehicle V is opened and then closed. Further, it may be determined that the vehicular portable device holder has gotten into the vehicle V in a case where a response signal is sent to the polling signal sent from the compartment antenna 131E.

When the condition by which to determine that the portable device holder has gotten into the vehicle V is satisfied, a positive determination is made in Step S309 and the flow proceeds to Step S310. The determination processing in Step S309 is performed repetitively until the condition by which to determine that the portable device holder has gotten into the vehicle V is satisfied. However, the flow may return to Step S301 as exceptional processing in a case where the condition by which to determine that the portable device holder has gotten into the vehicle V is not satisfied when a certain time has elapsed.

In Step S310, the transmission processor section F1 sends a present-in-compartment notification signal notifying that the vehicular portable device 200 is present inside the compartment from the compartment antenna 131E. The flow then proceeds to Step S310.

In Step S311, the transmission processor section F1 sends the report command signal. The flow then proceeds to Step S312. The report command signal sent in Step S311 is sent when a predetermined second sampling time (for example, one second) has elapsed after transmission of the present-in-compartment notification signal. The second sampling time, which is an interval from transmission of the present-in-vehicle notification signal to transmission of the report command signal, may be designed as needed for the portable device-side controller 210 to perform second holder's terminal identification processing described below.

In Step S312, the reception processor section F2 receives the holder information signal sent from the vehicular portable device 200. The flow then proceeds to Step S313. In Step S313, the vehicle occupant information acquirer section F6 identifies a user as the portable device holder according to the holder information indicated by the holder information signal. Processing after the user as the portable device holder is identified is same as the processing in the embodiment above.

### Holder Information Providing Processing

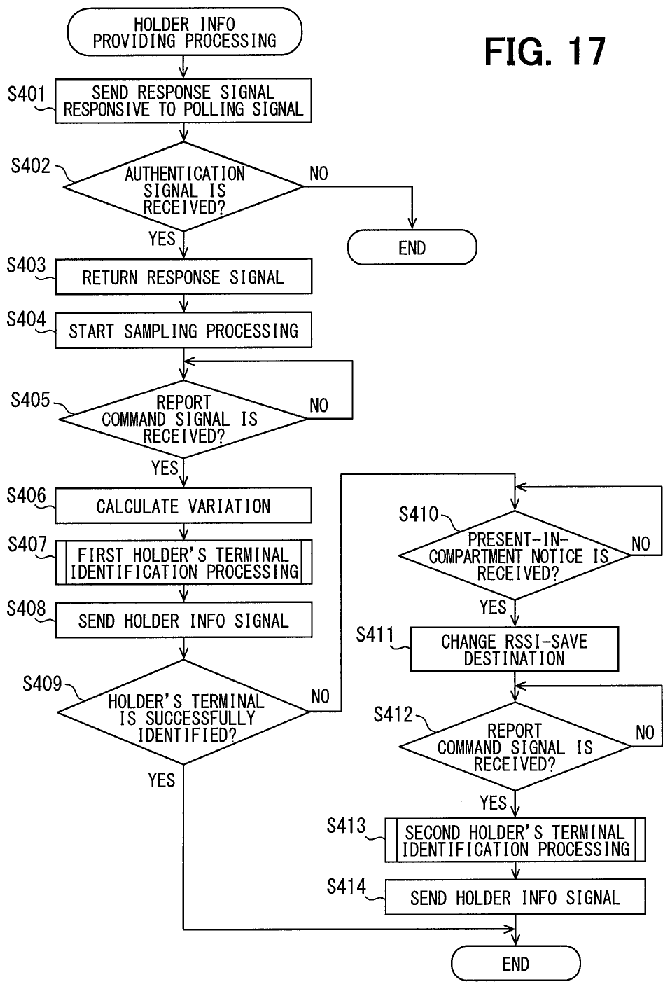

The holder information providing processing performed by the portable device-side controller 210 will now be described by using a flowchart of FIG. 17. The portable device-side controller 210 may start the holder information providing processing when the vehicle communication processor section G1 receives the polling signal.

Herein, assume that multiple portable terminals 300 (in other words, multiple users) are present near the vehicular portable device 200. As an example, the portable terminals 300 present near the vehicular portable device 200 are a portable terminal 300 owned by the portable device holder and a portable terminal 300 owned by a user who is not accompanying the portable device holder, and the vehicular portable device 200 is receiving signals from the respective portable terminals 300 present in a house.

In Step S401, the vehicle communication processor section G1 sends a response signal to the polling signal. The flow then proceeds to Step S402. In Step S402, the vehicle communication processor section G1 determines whether the authentication signal is received. When the authentication signal is received, a positive determination is made in Step S402 and the flow proceeds to Step S403. Meanwhile, in a case where no authentication signal is received when a certain time has elapsed after transmission of the response signal in Step S401, a negative determination is made in Step S402. The flow is then ended. In such a case, the flow may be started when the polling signal is received again.

In Step S403, a response signal to the authentication signal received in Step S402 is returned. The flow then proceeds to Step S404. In Step S404, the power supply manager section G2 switches the short-range communicator 230 from the low power consumption mode to the active mode. The short-range communication processor section G3 thus starts the sampling processing in response to a request from the holder's terminal identification section G4. The flow then proceeds to Step S405.

In the present embodiment, it should be noted that the holder's terminal identification section G4 controls the short-range communication processor section G3 to start the sampling processing upon reception of the authentication signal. The number of times signals are sent and received between the onboard device 100 and the vehicular portable device 200 can be thus reduced.

In the present embodiment, the short-range communication processor section G3 calculates a moving average value by using latest N detection results as a population for each portable terminal 300 each time the scan processing is performed and saves the moving average value associated with a latest received signal strength indication in the RAM 212. Acquisition of the received signal strength indication by the scan processing and a calculation of the moving average value by using a latest received signal strength indication correspond to the sampling processing of the present embodiment.

The moving average value may be calculated as an average value of latest N detection results (so-called a simple moving average) and N may be designed as needed and may be, for example, 10 or 50. Alternatively, the moving average value may be a value determined by a known method, such as a weighted moving averaging method and an exponential moving averaging method.

In Step S405, the vehicle communication processor section G1 determines whether the report command signal is received. When the report command signal is received, a positive determination is made in Step S405 and the flow proceeds to Step S406. The determination in Step S405 may be performed repetitively until the report command signal is received. In a case where no report command signal is received when a predetermined time has elapsed, the flow may be ended as exceptional processing.

In Step S406, the holder's terminal identification section G4 calculates a variation in received signal strength indication for each portable terminal 300 according to received signal strength indications stored in the RAM 212 for each portable terminal 300. The flow then proceeds to Step S407. The received signal strength indication used to calculate a variation may be latest M received signal strength indications. Herein, M may be designed as needed and may be, for example, 30 or 50. Alternatively, a variation may be calculated by using the moving average value instead of received signal strength indications.

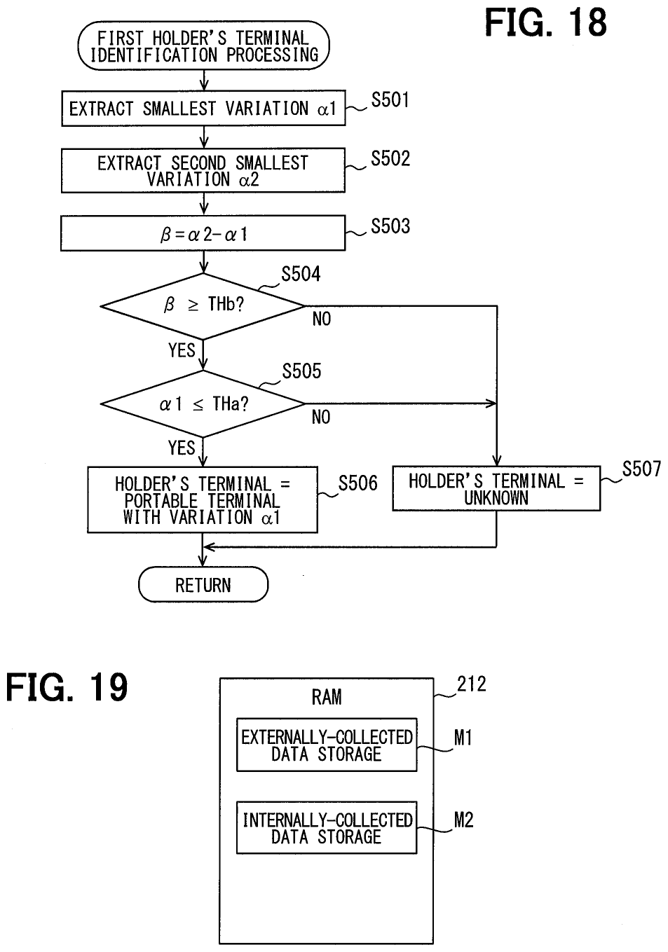

In Step S407, first holder's terminal identification processing is performed. The flow then proceeds to Step S408. The first holder's terminal identification processing will be described separately in the following by using a flowchart of FIG. 18. As is shown in FIG. 18, the first holder's terminal identification processing includes Steps S501 through S507.

In Step S501, a smallest value α1 of variation in received signal strength indication is identified among variations calculated for respective portable terminals 300 present near the self-device in Step S406. The flow then proceeds to Step S502. In Step S502, a second smallest value α2 of variation in received signal strength indication is identified among variations calculated for the respective portable terminals 300. The flow then proceeds to Step S503.

In Step S503, a gap amount β is calculated by subtracting α1 from α2. The flow then proceeds to Step S504. In Step S504, whether the gap amount β is at or above a predetermined gap threshold THb is determined. The threshold used herein is a threshold by which to determine whether variations have a difference large enough to distinguish between a portable terminal 300 carried by the portable device holder and a portable terminal 300 carried by a user other than the portable device holder.

In a case where a variation in received signal strength indication of the portable terminal 300 carried by the portable device holder and a variation in received signal strength indication of the portable terminal 300 carried by a user other than the portable device holder is substantially same, a likelihood that the portable terminal 300 with the smallest variation is the holder's terminal decreases.

However, by considering that the gap amount β is at or above the predetermined gap threshold THb in a process of determining that a portable terminal 300 with the smallest variation is the holder's terminal, a risk of erroneously determining the holder's terminal can be reduced. A specific value of the gap threshold THb may be designed as needed.

In a case where the gap amount β is at or above the gap threshold THb, a positive determination is made in Step S504 and the flow proceeds to Step S505. Meanwhile, in a case where the gap amount β is below the gap threshold THb, a negative determination is made in Step S504 and the flow proceeds to Step S507.

In Step S505, whether the smallest value α1 of variation is at or below a predetermined threshold THa is determined. Step S505 is also a step of determination processing to reduce a risk of erroneously determining the holder's terminal. A portable terminal 300 with the smallest variation is most likely to be the holder's terminal. However, a possibility that the most-likely portable terminal 300 is truly the holder's terminal is reduced as a variation becomes larger. Hence, when the smallest value α1 of variation is larger than a design value, it is preferable not to determine a portable terminal 300 with the smallest variation as being the holder's terminal.

A variation in received signal strength indication of the holder's terminal becomes relatively large when a portable terminal 300 is located where a signal propagating from the portable terminal 300 to the vehicular portable device 200 is attenuated by a body of the portable device holder, for example, when the vehicular portable device 200 is put in a right-rear trousers pocket while the portable terminal 300 is put in a left jacket pocket. In a case where such a positional relationship is established, the vehicular portable device 200 chiefly receives a reflected wave of the signal sent from the holder's terminal. Because a received signal strength indication of a reflected wave varies markedly, a variation naturally becomes relatively large. In the following, the positional relationship with which a signal propagating from a portable terminal 300 to the vehicular portable device 200 is attenuated by the body of the portable device holder is referred to as an indirect propagation pattern.

The determination processing in Step S505 is determination processing introduced in light of the idea described above, and a specific value of the threshold THa may be designed as needed by a test or the like. In a case where the smallest value α1 is at or below the threshold THa, a positive determination is made in Step S505 and the flow proceeds to Step S506. Meanwhile, in a case where the smallest value α1 is above the threshold THa, a negative determination is made in Step S505 and the flow proceeds to Step S507. The processing in Step S505, however, may be omitted.

In Step S506, a portable terminal 300 with the smallest variation among multiple portable terminals 300 is determined as being the holder's terminal. The flow is then ended. In Step S507, it is determined that the holder's terminal is unknown. The flow is then ended. When the flow is ended, advancement is made to Step S408 of the holder information providing processing shown in FIG. 17.

In Step S408, the vehicle communication processor section G1 generates the holder information signal indicating a result of the first holder's terminal identification processing in Step S407 and sends the generated signal to the onboard device 100. The flow then proceeds to Step S409. In Step S409, a determination is made as to whether the holder's terminal is successfully identified as an outcome of the first holder's terminal identification processing in Step S407. In a case where the holder's terminal is successfully identified as an outcome of the first holder's terminal identification processing, a positive determination is made in Step S409 and the flow is ended. Meanwhile, in a case where the holder's terminal is not identified as an outcome of the first holder's terminal identification processing, a negative determination is made in Step S409 and the flow then proceeds to Step S410.

In Step S410, a determination is made as to whether the vehicle communication processor section G1 receives the present-in-compartment notification signal. When the present-in-compartment notification signal is received, a positive determination is made in Step S410 and the flow proceeds to Step S411. The determination in Step S410 is made repetitively until the present-in-compartment notification signal is received. In a case where no present-in-compartment notification signal is received when a certain time has elapsed after the flow proceeds to Step S410, the flow may be ended.

When the present-in-compartment signal is received, the portable device-side controller 210 determines that the vehicular portable device 200 is present inside the compartment. In a case where the present-in-compartment signal is not received, the portable device-side controller 210 determines that the vehicular portable device 200 is present outside the compartment. A determination that the vehicular portable device 200 is present inside the compartment is held for a certain time after reception of the present-in-compartment notification signal.

The tenth modification is of a configuration in which the portable device-side controller 210 distinguishes (in other words, determines) whether the vehicular portable device 200 is present inside the compartment depending on whether the present-in-compartment notification signal is received as an example. However, the present disclosure is not limited to the configuration of the example. As will be described in an eleventh modification below by way of example, the presence inside the compartment may be distinguished by another method.

In Step S411, a storage region for saving data acquired as a result of the sampling processing is changed to another storage region to make the data distinguishable from data collected earlier. The flow then proceeds to Step S411. A change of the storage portion may be realized logically. For example, the storage portion may be changed logically by attaching a label indicating “data acquired inside the compartment” to the data to be saved.

In FIG. 19, for ease of illustration, a region in which data collected up to reception of the present-in-compartment notification signal is stored in the storage region of the RAM 212 is shown as an externally collected data storage M1. Also, a region where data collected after reception of the present-in-notification signal is stored is shown as an internally collected data storage M2. Collected data referred to herein means the terminal ID, a received signal strength indication, the moving average value, and so on collected for each portable terminal 300.

The data collected up to the reception of the present-in-compartment notification signal corresponds to external received strength indication information, and the data collected after the reception of the present-in-compartment notification signal corresponds to internal received strength indication information. The externally collected data storage M1 corresponds to an external received strength indication storage unit and the internally collected data storage M2 corresponds to an internal received strength indication storage unit.

In Step S412, a determination is made as to whether the vehicle communication processor section G1 receives the report command signal. When the report command signal is received, a positive determination is made in Step S412 and the flow proceeds to Step S413. The determination in Step S412 may be made repetitively until the report command signal is received. In a case where no report command signal is received when a certain time has elapsed after the flow proceeds to Step S412, the flow may be ended.

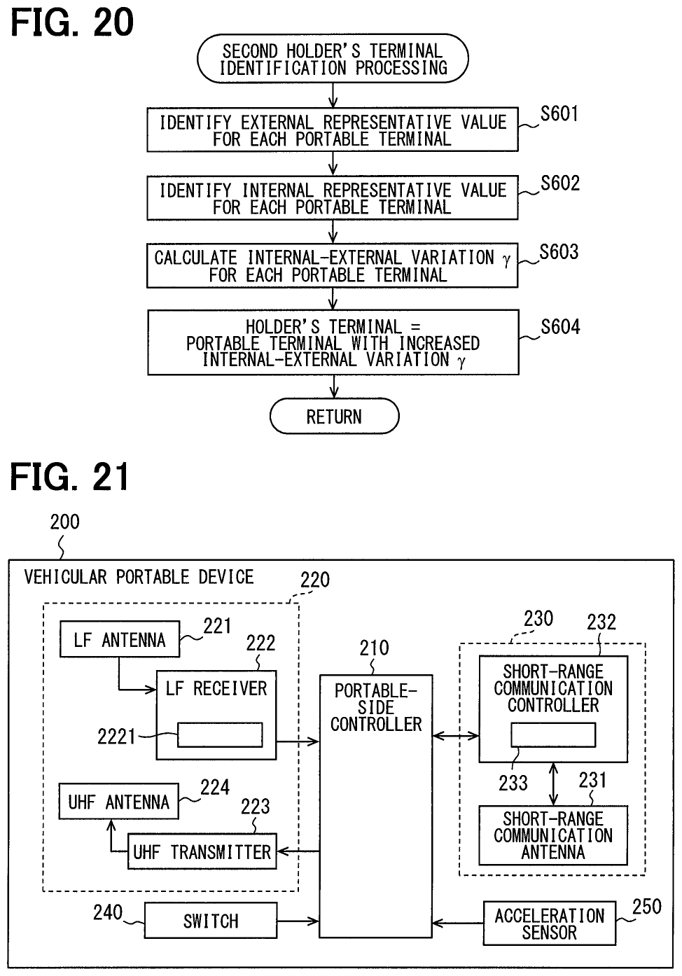

In Step S413, the holder's terminal identification section G4 performs the second holder's terminal identification processing. The flow then proceeds to Step S414. The second holder's terminal identification processing will be described separately in the following by using a flowchart of FIG. 20. As is shown in FIG. 20, the second holder's terminal identification processing includes Steps S601 through S604.

In Step S601, an external representative value is identified for each portable terminal 300. The flow then proceeds to Step S602. The external representative value referred to herein means a value representing a received signal strength indication at a time point when the vehicular portable device 200 is present outside the compartment. The external representative value used herein as an example is a moving average value when Step S406 is performed.

A value adopted as the external representative value may be designed as needed and is not limited to the moving average value specified as above. For example, a moving average value received a certain time (for example, three seconds) before reception of the present-in-compartment notification signal may be adopted. Alternatively, the external representative value may be an average value or a median value found by using moving average values within a certain previous time after reception of the present-in-compartment notification signal as a population. Further, the external representative value may be a received signal strength indication acquired at a predetermined time point when the vehicular portable device 200 is present outside the compartment. The external representative value only needs to be determined by using data stored in the externally collected data storage M1. The external representative value is determined for each portable terminal 300.

In Step S602, an internal representative value is identified for each portable terminal 300. The flow then proceeds to Step S603. The internal representative value referred to herein means a value representing a received signal strength indication at a time point when the vehicular portable device 200 is present inside the compartment. The internal representative value adopted herein as an example is a moving average value at a time point when the report command signal is received in Step S412. As with the external representative value, it goes without saying that a value adopted as the internal representative value may be designed as needed. For example, the internal representative value may be an average value or a median value found by using moving average values acquired within a certain time as a population.

In Step S603, an internal-external variation γ is calculated for each portable terminal 300. The flow then proceeds to Step S604. The internal-external variation γ of a portable terminal 300 referred to herein means a value found by subtracting the external representative value from the internal representative value of the portable terminal 300. In a case where the internal representative value is larger than the external representative value, the internal-external value y takes a positive value. A portable terminal 300 with a positive internal-external variation γ can be said as a portable terminal 300 with which a received signal strength indication becomes higher when the vehicular portable device 200 is present inside the compartment than outside the compartment.

In Step S604, a portable terminal 300 with a positive internal-external variation γ is determined as being the holder's terminal. In a case where presence of two or more portable terminals 300 with a positive internal-external variation γ is determined, one of such portable terminals 300 with a largest internal-external variation γ is determined as being the holder's terminal.

A portable terminal 300 with a positive internal-external variation γ, in other words, a portable terminal 300 with which a received signal strength indication becomes higher when the vehicular portable device 200 is present inside the compartment than outside the compartment is adopted as the holder's terminal for a reason as follows.

First of all, the second holder's terminal identification processing is performed in a case where identification of the holder's terminal by the first holder's terminal identification processing fails. Identification of the holder's terminal by the first holder's terminal identification processing fails when a difference of variations in received signal strength indication between a portable terminal corresponding to the holder's terminal and another portable terminal 300 is below the gap threshold THb or when a variation of every portable terminal 300 is at or above the predetermined threshold THa.

A failure in identifying the holder's terminal by the first holder's terminal identification processing as above occurs in a case where a positional relationship between the portable terminal 300 and the vehicular portable device 200 by the portable device holder corresponds to the indirect propagation pattern described above. In such a case, a received signal strength indication of a signal from a portable terminal 300 as the holder's terminal detected by the vehicular portable device 200 is highly likely to be a received signal strength indication of a reflected wave arriving after being reflected on another object instead of a received signal strength indication of a direct wave.

In a case where a positional relationship between a portable terminal 300 and the vehicular portable device 200 corresponds to the indirect propagation pattern and the vehicular portable device 200 is present outside the compartment, a received signal strength indication from the holder's terminal takes relatively a low value. However, because the compartment is a narrow space surrounded by the vehicle body, a reflected wave is more readily received when the portable device holder is present inside the compartment and a received signal strength indication tends to rise in comparison with a received signal strength indication when the vehicular portable device 200 is present outside the compartment. On the contrary, a received signal strength indication of a signal from a portable terminal 300 inside the house decreases due to an effect of the vehicle body.

Hence, in a case where a signal from a portable terminal 300 owned by a user who is not a member of the present trip is trapped, a risk of erroneously determining the portable terminal 300 owned by such a user as being the holder's terminal can be reduced by identifying the holder's terminal by the method described above.

### Eleventh Modification

The tenth modification above is of the configuration in which the portable device-side controller 210 distinguishes whether the vehicular portable device 200 is present inside or outside the compartment when the onboard device 100 sends the present-in-compartment notification signal from the compartment antenna 131E and the vehicular portable device 200 receives the present-in-compartment notification signal. However, the present disclosure is not limited to the configuration as above.

For example, a signal sent from an LF antenna 131 may contain identification information identifying as being a signal sent to an exterior of the compartment or a signal sent to an interior of the compartment. That is, a signal containing identification information identifying as being a signal sent to the exterior of the compartment is sent from an antenna 131 covering a transmission area outside the compartment (for example, the DF-side antenna 131A). Also, a signal containing identification information identifying as being a signal sent to the interior of the compartment is sent from an LF antenna 131 covering a transmission area inside the compartment (for example, the compartment antenna 131E).

According to the configuration as above, the portable device-side controller 210 is capable of distinguishing whether the vehicular portable device 200 is present inside or outside the compartment of the vehicle V by referring to the identification information contained in a received signal.

### Twelfth Modification

The tenth modification above has described the configuration in which the holder's terminal is identified by comparing internal-external variations γ when identification of the holder's terminal by the first holder's terminal identification processing fails by way of example. However, the present disclosure is not limited to the configuration of the example. The portable device-side controller 210 may identify the holder's terminal by merely comparing internal-external variations γ as the holder information providing processing without performing the first holder's terminal identification processing. In such a case, the procedure of the holder information acquisition processing may be changed as need. For example, transmission of the report command signal in Step S306 may be omitted.

### Thirteenth Modification

A case where the holder's terminal is identified by comparing internal-external variations γ as in the tenth modification above is not limited to a case where identification of the holder's terminal by the first holder's terminal identification processing fails. For example, the holder's terminal may be identified by comparing internal-external variations γ in a case where every external representative value identified for each portable terminal 300 is at or below the received strength indication threshold described in the embodiment above.

In such a case, the external representative value may be calculated for each portable terminal 300 in a case where the report command signal is received while the vehicular portable device 200 is present outside the compartment. In a case where every external representative value identified for every portable terminal 300 is at or below the received strength indication threshold, the processing in and after Step S408 may be performed by determining that the holder's terminal is unknown.

### Fourteenth Modification

A content of the first holder's terminal identification processing in the tenth modification above may be changed as follows. Firstly, the holder's terminal identification section G4 calculates the external representative value for each portable terminal 300 and extracts a portable terminal 300 with which the external representative value calculated for each portable terminal 300 is found to be a predetermined direct holding threshold as a candidate for the holder's terminal. A variation is calculated for each extracted portable terminal 300 and a portable terminal 300 with the smallest variation is adopted as the holder's terminal.

In a case where a positional relationship between a portable terminal 300 and the vehicular portable device 200 established by the portable device holder does not correspond to the indirect propagation pattern, the vehicular portable device 200 is normally expected to directly receive a signal from the holder's terminal. Hence, the external representative value is also expected to be a sufficiently large value. The direct holding threshold mentioned above is an assumed value of a received signal strength indication measured when the vehicular portable device 200 directly receives a signal from the holder's terminal.

That is, the direct holding threshold functions as a threshold with which to determine whether the vehicular portable device 200 is held by the portable device holder in a style in which a signal from the holder's terminal is directly received. A risk of determining a wrong portable terminal 300 as being the holder's terminal due to a holding style of the holder's terminal can be reduced also by the configuration of the tenth modification.

### Fifteenth Modification

The method of identifying a user as the portable device holder by the vehicular portable device 200 is not limited to the methods illustrated in the embodiment and the tenth modification (hereinafter, referred to as the embodiment and the like). In the embodiment and the like above, the holder's terminal is identified on condition that a variation in received signal strength indication (hereinafter, abbreviated to RSSI) of a portable terminal 300 carried by the portable device holder is smaller than a variation in RSSI of a portable terminal 300 carried by a fellow vehicle occupant (hereinafter, referred to as a fellow vehicle occupant's terminal).

However, inventors had conducted various tests and had discovered that a variation in RSSI of the holder's terminal takes a value larger than a value of an RSSI variation of the fellow vehicle occupant's terminal in some cases depending on a combination of holding styles of the vehicular portable device 200 and a portable terminal 300 by the portable device holder (in other words, a positional relationship between the vehicular portable device 200 and a portable terminal 300).

For example, when the portable device holder holds the vehicular portable device 200 in a style in which acceleration associated with motion of an upper limb (that is, hand) of the user acts on the vehicular portable device 200 (hereinafter, referred to as upper limb associated holding style) while a portable terminal 300 is put in a garment pocket, a positional relationship between the vehicular portable device 200 and the portable terminal 300 varies with hand motion by walking, and an RSSI variation readily increases. The same can be said when the portable device holder holds a portable terminal 300 in the upper limb associated holding style while the vehicular portable device 200 is put in a garment pocket.

The vehicular portable device 200 held in the upper limb associated holding style means a case where the portable device holder directly holds the portable device 200 in hand or when the vehicular portable device 200 is put in a container (for example, a handbag) held in hand of the portable device holder. The same can be said when a portable terminal 300 is held in the upper limb associated holding style.

In a case where the portable device holder puts a portable terminal (that is, holder's terminal) 300 in a trousers pocket, a position (including a posture) of the holder's terminal in the pocket may possibly change when the portable device holder is walking and stationary. The same can be said with the vehicular portable device 200. Hence, in a case where at least one of a portable terminal 300 and the vehicular portable device 200 is put in a trousers pocket, a positional relation may possibly change when the portable device holder is walking and stationary.

As has been described above, a signal propagation path from the holder's terminal to the vehicular portable device 200 changes when a positional relation between the holder' terminal and the vehicular portable device 200 changes and an RSSI varies, too. In short, an RSSI during walking readily fluctuates at a level different from a level of an RSSI in a stationary state.

Hence, in a case where a population used for a calculation of a variation in RSSI contains RSSIs acquired both during walking and in a stationary state, an RSSI variation becomes relatively large. Consequently, an RSSI variation of the holder's terminal may become larger than an RSSI variation of the fellow vehicle occupant's terminal. An RSSI variation of the holder's terminal means a variation in RSSI of a signal sent from the holder's terminal and received by the vehicular portable device 200. An RSSI variation of the fellow vehicle occupant's terminal means a variation in RSSI of a signal sent from the fellow vehicle occupant's terminal and received at the vehicular portable device 200.

The vehicular portable device 200 disclosed below as the fifteenth modification adopts a determination algorithm addressing the case described above. The embodiment and the various modifications above are also applicable to the fifteenth modification unless a contradiction occurs.

In the fifteenth modification, as is shown in FIG. 21, the LF receiver 222 includes an LF strength indication detector section 2221 detecting a strength of a signal (that is, RSSI) received at the LF antenna 221. The LF strength indication detector section 2221 may be realized by using a known circuit configuration. Data indicating an RSSI detected by the LF strength indication detector section 2221 is provided to the portable device-side controller 210 each time an RSSI is detected. An RSSI detected by the LF strength indication detector section 2221 is an RSSI of an LF signal. Hence, an RSSI detected by the LF strength indication detector section 2221 is denoted also as an LF_RSSI for ease of description. The LF strength indication detector section corresponds to a vehicle signal strength indication detection unit.

In the fifteenth modification, the portable device-side controller 210 gives a timestamp indicating a detection time to data indicating a present LF_RSSI when the data is acquired from the LF strength indication detector section 2221 and saves the data in the RAM 212 for a certain time.

As has been described, a detection result of an RSSI obtained for each portable terminal 300 by the sampling processing is also saved in the RAM 212. RSSIs obtained for each portable terminal 300 and saved in the RAM 212 may be sorted according a time series. Hereinafter, time-series data of RSSIs of a signal from a portable terminal 300 is referred to as time-series RSSI data of the portable terminal 300. The time-series RSSI data of a portable terminal 300 functions as waveform data indicating a temporal change of an RSSI of the portable terminal 300.

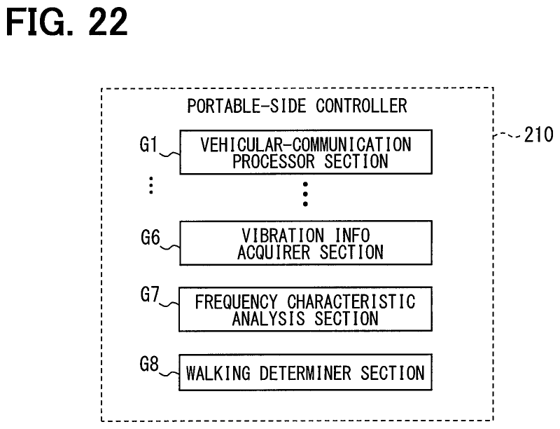

In the fifteenth modification, as is shown in FIG. 22, the portable device-side controller 210 further includes a frequency characteristic analysis section G7 and a walking determiner section G8. The frequency characteristic analysis section G7 and the walking determiner section G8 may be realized by running the portable terminal program on the CPU or by using a hardware member, such as an IC.

The frequency characteristic analysis section G7 performs processing (hereinafter, referred to as frequency characteristic analysis processing) to analyze frequency characteristics of an RSSI for each portable terminal 300 from the time-series RSSI data obtained for each portable terminal 300 and saved in the RAM 212 by applying FFT (Fast Fourier Transform). An operation to analyze frequency characteristics corresponds to an operation to identify a periodicity of a time-change pattern of an RSSI indicated by the time-series RSSI data.

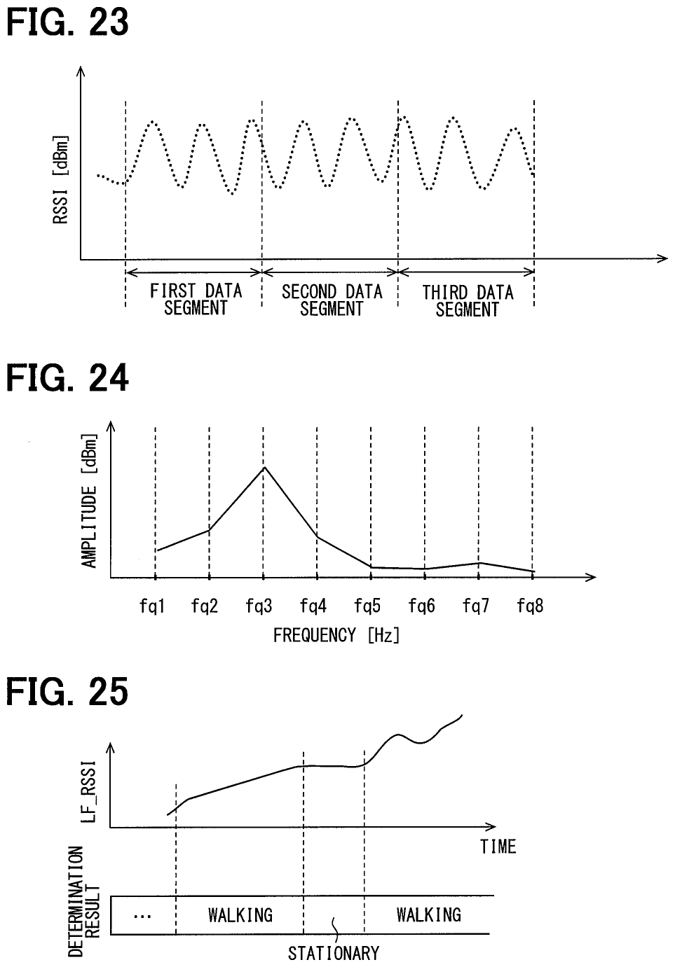

More specifically, as is shown in FIG. 23, the frequency characteristic analysis section G7 divides an RSSI within a latest certain time indicated by the time-series RSSI data of a portable terminal 300 into first through third data segments, and performs FFT processing for each data segment. The FFT processing is processing to apply known FFT on a target signal sequence. Because a specific method of the FFT processing is known, a description is omitted herein. FIG. 23 schematically shows a waveform of an RSSI when the portable device holder holds the vehicular portable device 200 in the upper limb associated holding style while a portable terminal 300 is put in a trousers pocket.

In the present modification, it is sufficient to identify a strength of a preliminarily designed frequency component (in other words, amplitude) by the FFT processing. Herein, the frequency characteristic analysis section G7 identifies strengths at eight frequencies fq1, fq2, . . . , and fq8 as an example. The frequencies fq1 through fq8 as analysis targets may be designed according to an average value or a median value of frequencies at which an individual swings a hand during walking. That is, the frequencies fq1, fq2, . . . , and fq8 may be determined to correspond to frequencies of hand swing motion (hereinafter, referred to as a swing frequency) of various individuals during walking. A range of the swing frequencies (hereinafter, referred to as a swing frequency region) may be determined by a test or the like.

Frequencies set herein as an example are: fq1=0.3 Hz, fq2=0.6 Hz, fq3=0.9 Hz, fq4=1.2 Hz, fq5=1.5 Hz, fq6=1.8 Hz, fq7=2.1 Hz, and fq8=2.4 Hz.

The inventors had conducted tests to measure swing frequencies of individuals of various physical sizes and ages, and had discovered from a result of the tests that an average value of the swing frequencies is 0.8 Hz and a swing frequency during walking ranges from 0.6 Hz to 1.3 Hz. The discovery as above is taken into consideration herein and the frequencies fq2, fq3, and fq4 are handled as frequencies belonging to the swing frequency region and the other frequencies fq1, fq5, fq6, fq7, and fq8 as frequencies representing noise components.

The configuration disclosed herein is to extract particular eight frequency components. However, the present disclosure is not limited to the disclosed configuration. Four, six, ten or more frequencies can be analysis targets on condition that a frequency belonging to the swing frequency region is included in the analysis target frequencies.

An analysis result by the frequency characteristic analysis section G7 of the first data segment in the time-series RSSI data shown in FIG. 23 is set forth in FIG. 24. In a case where the portable device holder is walking by holding the vehicular portable device 200 in the upper limb associated holding style while a portable terminal 300 is put in a trouser pocket, as is set forth in FIG. 24, a peak appears at any one of fq2, fq3, and fq4 belonging to the swing frequency region.

The frequency characteristic analysis section G7 generates data showing a frequency distribution (hereinafter, referred to as frequency characteristic data) as set forth in FIG. 24 by applying the FFT processing to the respective three data segments. One data segment may be designed as needed to have a length long enough to obtain a desirable frequency resolution. In the present modification, the three data segments are set not to overlap each other. However, the present disclosure is not limited to the data segments set as above. The respective data segments may be set for the first data segment and the second data segment to overlap and the second data segment and the third data segment to overlap. The first data segment and the third data segment may overlap as a consequence. In the present modification, three data segments are set as an example. However, one, two, four or more data segments may be set as well.

The walking determiner section G8 determines whether the portable device holder is walking according to an LF_RSSI provided from the LF strength indication detector section 2221. More specifically, as is shown in FIG. 25, the walking determiner section G8 determines that the portable device holder is walking when an LF_RSSI varies, and determines that the portable device holder is stationary when an LF_RSSI does not vary. A determination is made as above for a reason as follows. That is, generally, an attenuation curve of a received strength with respect to a distance from an antenna is unsusceptible to a disturbance in the case of a radio wave in the LF band. Hence, it is a change of the location of the portable device holder with respect to the vehicle V that appears as a variance in LF_RSSI.

Whether an LF_RSSI varies may be determined by, for example, comparing a value a certain time before (for example, 100 milliseconds before) with a present value. When a variance of the two values is at or above a predetermined threshold, a difference in LF_RSSI may be determined. The threshold used herein may be a fixed value or may be a product of the value a certain time before and a predetermined rate (for example, 0.1).

It is preferable that an LF_RSSI used to determine whether the portable device holder is walking is an LF_RSSI of a signal sent from the vehicle V. Hence, in the present modification, the transmission processor section F1 sends a signal from all the external LF antennae 131 in a predetermined period (for example, every 50 milliseconds) while the vehicle V is parked as a more preferable configuration. A signal sent regularly can be any signal containing information enabling the vehicular portable device 200 to recognize that the received signal is a signal sent from the vehicle V. The portable device-side controller 210 saves only an LF_RSSI of a signal sent from the vehicle V into the RAM 212.

Hereinafter, processing performed by the walking determiner section G8 to determine whether the portable device holder is walking is referred to as walking determination processing for ease of description. Alternatively, the portable device holder may be determined as walking when the acceleration sensor 250 outputs a value at or above a predetermined threshold. The walking determiner section G8 corresponds to a location change determination unit.

### Holder's Terminal Identification Processing

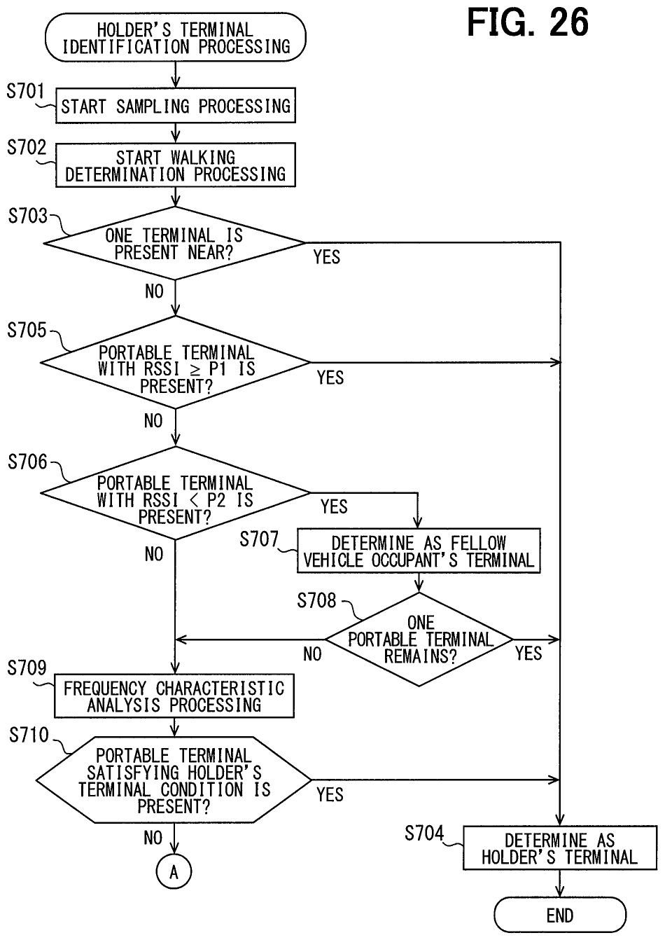

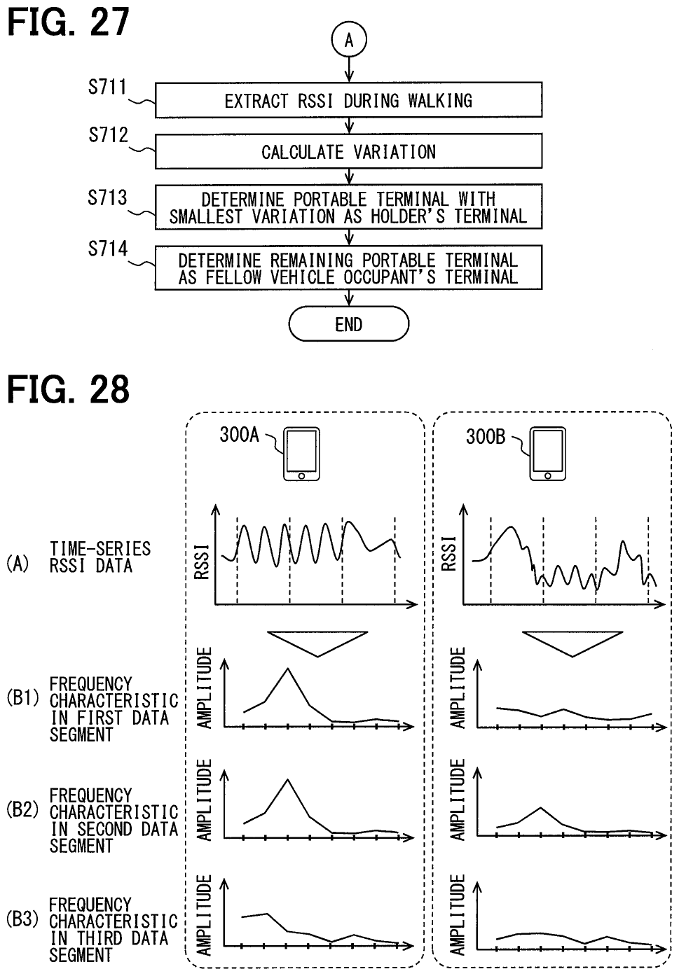

A sequence of processing steps performed by the portable device-side controller 210 of the fifteenth modification to identify the portable device holder (hereinafter, referred to as holder's terminal identification processing) will now be described by using flowcharts of FIG. 26 and FIG. 27. The holder's terminal identification processing may be started, for example, when authentication between the onboard device 100 and the vehicular portable device 200 via wireless communication succeeds. It goes without saying that a condition by which to start the processing is not limited to the condition as above and may be designed as needed.

In Step S701, the short-range communication processor section G3 starts the sampling processing. The flow then proceeds to Step S702. The scan processing is thus performed successively. In Step S702, the walking determiner section G8 starts the walking determination processing according to LF_RSSIs successively provided from the LF strength indication detector section 2221. The walking determination processing is performed successively at predetermined intervals (for example, every 100 milliseconds) after Step S702. The walking determination processing that is performed regularly may be stopped when the flow ends.

In Step S703, the holder's terminal identification section G4 identifies the number of portable terminals 300 present near the self-device according to a result of the scan processing (in other words, a communication state of the short-range communicator 230). In a case where only one portable terminal 300 is present near the self-device, a positive determination is made in Step S703 and the flow proceeds to Step S704. In Step S704, the holder's terminal identification section G4 determines the only one detected portable terminal 300 as being the holder's terminal. The flow is then ended.

Meanwhile, in a case where two or more portable terminals 300 are present near the self-device, a negative determination is made in Step S703 and the flow proceeds to Step S705. In a case where no portable terminal 300 is detected, the flow may be ended. In such a case, exceptional processing, such as to perform Step S701 again after a certain time, may be designed as needed and performed.

In Step S705, the holder's terminal identification section G4 determines whether a portable terminal 300 with an RSSI at or above a predetermined finalization threshold P1 is present. In a case where a portable terminal 300 with an RSSI at or above the predetermined finalization threshold P1 is present, a positive determination is made in Step S705 and the flow proceeds to Step S704, in which the detected portable terminal 300 is determined as being the holder's terminal.

The finalization threshold P1 introduced herein is a threshold used to determine the holder's terminal according to RSSIs and set to a sufficiently large value. For example, the finalization threshold may be a smallest value or an average value of RSSIs observable when the vehicular portable device 200 and a portable terminal 300 are present within a sight of 0.5 m.

Meanwhile, in a case where no portable terminal 300 with an RSSI at or above the finalization threshold P1 is present, a negative determination is made in Step S705 and the flow proceeds to Step S706. In Step S706, the holder's terminal identification section G4 determines whether a portable terminal 300 with an RSSI below a predetermined exclusion threshold P2 is present.

The exclusion threshold P2 introduced herein is a threshold set for an RSSI to identify a portable terminal 300 held by an individual other than the portable device holder (that is, a fellow vehicle occupant). In other words, the exclusion threshold P2 is a threshold to exclude a portable terminal 300 that is least likely to be the holder's terminal from portable terminals 300 present near the vehicular portable device 200.

When an RSSI is sufficiently high, a portable terminal 300 is highly likely to be the holder's terminal whereas when the RSSI becomes lower, a portable terminal 300 is less likely to be the holder's terminal. Hence, a portable terminal 300 with an RSSI below the predetermined value can be deemed as being a portable terminal held by a fellow vehicle occupant (hereinafter, referred to as a fellow vehicle occupant's terminal). A specific value of the exclusion threshold P2 may be designed as needed. It is preferable that the exclusion threshold P2 is set to a value less than an RSSI observed when a positional relationship between a portable terminal 300 and the vehicular portable device 200 corresponds to the indirect propagation pattern.

In a case where a portable terminal 300 with an RSSI below the predetermined exclusion threshold P2 is present, a positive determination is made in Step S706 and the flow proceeds to Step S707. Meanwhile, in a case where no portable terminal 300 with an RSSI below the exclusion threshold P2 is present, a negative determination is made in Step S706 and the flow proceeds to Step S709.

In Step S708, the detected portable terminal 300 is determined as being the fellow vehicle occupant's terminal. The flow then proceeds to Step S708. In Step S708, whether only one portable terminal 300 remains after the fellow vehicle occupant's terminal is determined. When only one portable terminal 300 remains, a positive determination is made in Step S708 and the flow proceeds to Step S704, in which the remaining portable terminal 300 is determined as being the holder's terminal. The flow is then ended. Meanwhile, when two or more portable terminals 300 remain, a negative determination is made in Step S708 and the flow proceeds to Step S709.

In Step S709, the frequency characteristic analysis section G7 generates the frequency characteristic data for each portable terminal 300 according to the time-series RSSI data obtained for each portable terminal 300 and saved in the RAM 212. The flow then proceeds to Step S710. The frequency characteristic data of each data segment is generated for one portable terminal 300. That is, the FFT processing is applied three times to one portable terminal 300 and three items of frequency characteristic data are generated as a consequence.

FIG. 28 conceptually shows an example of a result when Step S709 is performed in a case where two portable terminals 300, namely the portable terminals 300A and 300B, are present near the vehicular portable device 200. The portable terminal 300A is a portable terminal 300 carried by the user A and the portable terminal 300B is a portable terminal 300 carried by the user B.

As is shown in FIG. 28, the frequency characteristic analysis section G7 sets the first, second, and third data segments in the time-series RSSI data of each of the two portable terminals 300, and analyzes a frequency characteristic of each data segment. In FIG. 28, a row A shows the time-series RSSI data and rows B1 through B3 show frequency characteristics of the respective data segments.

In Step S710, the holder's terminal identification section G4 determines whether a portable terminal 300 satisfying a predetermined holder's terminal condition is present among portable terminals 300 present near the self-device. The holder's terminal condition referred to herein means a condition by which to determine the holder's terminal according to a periodicity of a temporal change pattern of an RSSI. The holder's terminal condition adopted in the present modification as an example is acquisition of frequency characteristic data in which a peak is present at any one of the frequencies fq2, fq3, and fq4 corresponding to the holder swing frequency and a peak height is at or above a predetermined peak detection threshold in any one of the first, second, and third data segments.

That is, in a case where a portable terminal 300 with an analysis result that a peak is present at any one of the frequencies fq2, fq3, and fq4 corresponding to the holder swing frequency and a peak height is at or above the peak detection threshold in any one of the first, second, and third data segments is present, the flow proceeds to Step S704, in which the detected portable terminal 300 is determined as being the holder's terminal. A specific value of the peak detection threshold may be determined by a test or the like. A portable terminal satisfying the holder's terminal condition corresponds to a portable terminal 300 with an RSSI that vibrates in a period corresponding to hand swinging motion during walking.

In a case where a result of periodicity evaluation processing indicates presence of multiple portable terminals 300 satisfying the holder's terminal condition, a portable terminal 300 which satisfies the holder's terminal condition a largest number of times as a result of the analysis processing applied three times in total to the respective first, second, and third data segments is determined as being the holder's terminal. For example, as is shown in FIG. 28, in a case where the portable terminal 300A satisfies the holder's terminal condition in two data segments, namely the first and second data segments, whereas the portable terminal 300B satisfies the holder's terminal condition in the second data segment alone, the portable terminal 300A is determined as being the holder's terminal.

In a case where identification of the holder's terminal fails as a result of Step S710, the flow proceeds to Step S711. In Step S711, the holder's terminal identification section G4 extracts RSSIs acquired in a period during which the portable device holder is determined as walking by the walking determiner section G8 from the time-series RSSI data of respective portable terminals 300 saved in the RAM 212. The flow then proceeds to Step S712.

In Step S712, the holder's terminal identification section G4 calculates RSSI variations of the respective portable terminals 300 by using the RSSIs extracted for each portable terminal 300 in Step S712. The flow then proceeds to Step S713. That is, the holder's terminal identification section G4 calculates RSSI variations of the respective portable terminals 300 by using only RSSIs acquired while the portable device holder is determined as walking by the walking determiner section G8 among RSSIs acquired successively by the sampling processing for each portable terminal 300.

In Step S713, the holder's terminal identification section G4 determines a portable terminal 300 with the smallest RSSI variation as being the holder's terminal. The flow then proceeds to Step S714. In Step S714, a remaining portable terminal 300 is determined as being the fellow vehicle occupant's terminal. The flow is then ended. Information on a vehicle occupant (for example, holder's terminal information) identified by the processing as above may be sent to the vehicle V at predetermined timing.

The present modification has described the configuration in which RSSI variations of portable terminals 300 are calculated by using RSSIs acquired while the portable device holder is walking without using RSSIs acquired while the portable device holder is stationary by way of example. However, the present disclosure is not limited to the configuration as above. It may be configured conversely that RSSI variations are calculated by using RSSIs acquired while the portable device holder is stationary without using RSSIs acquired while the portable device holder is walking.

However, positional relationships with other portable terminals 300 readily change when the portable device holder is walking. Hence, the holder's terminal can be identified at a higher degree of accuracy when RSSI variations are calculated by using RSSIs acquired while the portable device holder is walking as described above than by using RSSIs acquired while the portable device holder is stationary.

The LF antennae 131 from which to send a signal to the exterior of the compartment are often installed inside the door handles. In a case where the LF antenna 131 is installed inside the door handle, a line connecting points at which a signal sent from the LF antenna 131 is received by the vehicular portable device 200 at a same strength indication forms substantially a circular shape about a location where the LF antenna 131 is set.

In such a configuration, when the portable device holder walks around the vehicle V along points at which an LF_RSSI remains constant (that is, in an arc about the door handle), a variance at or above a predetermined threshold does not occur in an LF_RSSI. Hence, the walking determiner section G8 may possibly determine that the portable device holder is stationary even when the portable device holder is walking actually. Accordingly, RSSIs acquired while such a determination is maintained may be removed from a population used to calculate RSSI variations in Step S712.

Meanwhile, when a user gets into the vehicle, the user has to make a sequence of operations by gripping the door handle, opening the door, and getting into the vehicle. Hence, the portable device holder comes close to the door handle without exception. Consequently, a variance at or above the predetermined threshold occurs in an LF_RSSI. The walking determiner section G8 thus changes a determination result to walking and RSSIs used to calculate RSSI variations are collected. That is, even when the portable device holder moves in an arc about the door handle, the vehicular portable device 200 operates without any problem as described above. Effects as described above can be thus obtained.

### Summary of Fifteenth Modification

According to the configuration as above, a periodicity of variance in RSSI is identified for each portable terminal 300 by using FFT and a portable terminal 300 with a periodicity corresponding to the swing frequency is determined as being the holder's terminal. Owing to the configuration as above, the holder's terminal can be identified at a higher degree of accuracy when the portable device holder holds either one of the vehicular portable device 200 and a portable terminal 300 in the upper limb associated holding style while the other is put in a garment pocket.

Also, by calculating an RSSI variation by using only RSSIs during walking, a variance between an RSSI during walking and an RSSI in a stationary state can be reduced. Consequently, the holder's terminal can be identified at a higher degree of accuracy.

### Sixteenth Modification

The above has disclosed the method of identifying the holder's terminal by using RSSIs of signals sent from portable terminals 300 and received by the vehicular portable device 200. However, the method of identifying the holder's terminal is not limited to the disclosed method as above. For example, the holder's terminal may be identified by using information on acceleration acting on each of the vehicular portable device 200 and portable terminals 300. The following will describe an embodiment in light with such an idea as a sixteenth modification.

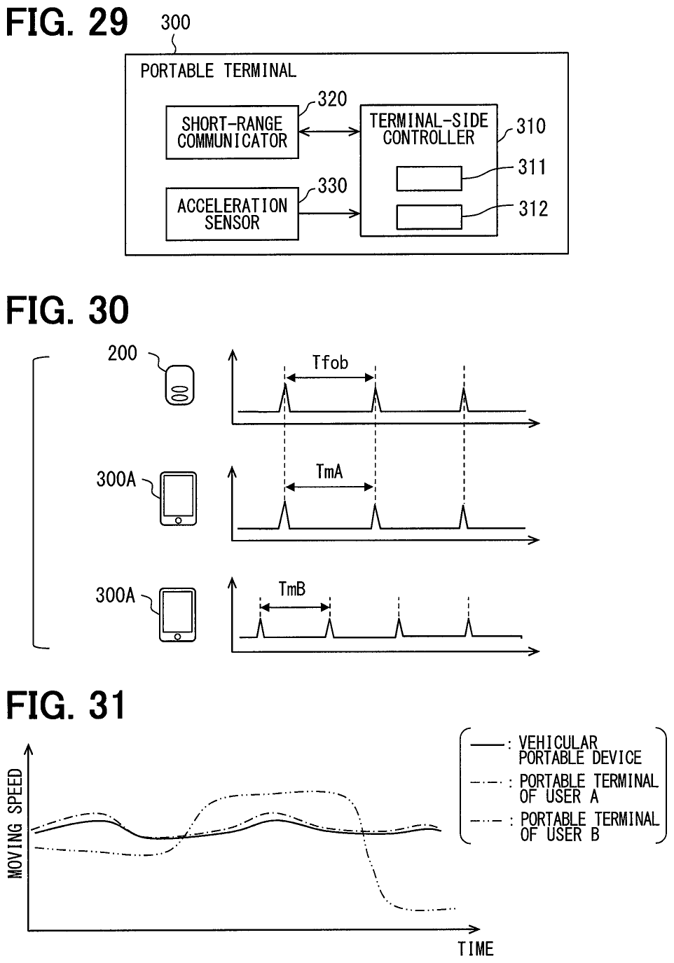

In the sixteenth modification, as is shown in FIG. 29, each portable terminal 300 includes an acceleration sensor 330. The acceleration sensor 330 is a sensor successively detecting acceleration acting on the self. The acceleration sensor 330 used herein as an example is a sensor including three detection axes orthogonal to one another and measuring acceleration acting in the respective axial directions (that is, a triaxial acceleration sensor). It goes without saying that the acceleration sensor 330 may be a biaxial acceleration senor or a monoaxial acceleration senor instead.

Detection results of the acceleration sensor 330 are successively provided to the terminal-side controller 310. An interval at which the acceleration sensor 330 outputs detection results (hereinafter, referred to as a sampling interval) is, for example, 100 milliseconds. It goes without saying that the sampling interval may be another time duration, such as 50 milliseconds and 200 milliseconds. The acceleration sensor 330 outputs data indicating acceleration in the respective three axes (Ax, Ay, and Az) as a result of one detection.

Upon acquisition of data indicating the detection result of the acceleration sensor 330 (hereinafter, referred to as acceleration data), the terminal-side controller 310 gives a timestamp indicating a detection time to the acceleration data and saves the acceleration data in a RAM 312 for a certain time. The acceleration data acquired successively and saved in the RAM 312 may be sorted according to a time series. The acceleration data may be deleted sequentially after being saved in the RAM 312 for the certain time.

Hereinafter, a block of time-series data of acceleration acting on a portable terminal 300 over a latest certain time is referred to as acceleration history data for ease of description. The acceleration history data functions as data indicating a temporal change of acceleration acting on the portable terminal 300. A length of the certain time may be designed as needed and set to, for example, several seconds. The number of items of data forming the acceleration history data corresponds to a value found by dividing the certain time by the sampling interval. The acceleration history data functions as data indicating a history of a behavior of a user carrying a portable terminal 300 within a certain time from a present time.

Each portable terminal 300 sends a communication packet containing the acceleration history data saved in the RAM 312 (hereinafter, referred to as a behavior notification packet) to the vehicular portable device 200 via short-range communication. It goes without saying that the behavior notification packet contains sender identification information (for example, the terminal ID). The terminal-side controller 310 may be configured to send the behavior notification packet regularly or in response to a request from the vehicular portable device 200. The acceleration history data contained in the behavior notification packet corresponds to behavior notification data, in particular, to state quantity history data.

In the sixteenth modification, when the vibration information acquirer section G6 of the vehicular portable device 200 acquires data on acceleration acting on the vehicular portable device 200 from the acceleration sensor 250, the vibration information acquirer section G6 gives a timestamp indicating a detection time to the acquired data and saves the acquired data in the RAM 212 for a certain time. The acceleration data in the RAM 212 may be handled in a same manner as in the terminal-side controller 310. That is, acceleration history data made up of acceleration acting on the self-device is saved in the RAM 212. The vibration information acquirer section G6 corresponds to a state quantity acquisition unit, in particular, to an acceleration information acquisition unit.

The short-range communication processor section G3 cooperates with the short-range communicator 230 and receives the behavior notification packet sent from a portable terminal 300 present near the self-device. The terminal ID indicated by the received behavior notification packet is associated with the acceleration history data and saved in the RAM 212.

In the present modification, the holder's terminal identification section G4 identifies the holder's terminal by using the acceleration history data of the self-device (hereinafter, referred to as self-device acceleration data) and the acceleration history data of a portable terminal 300 present near the self-device, both of which are saved in the RAM 212. The following will describe operations of the holder's terminal identification section G4 in the sixteenth modification in a case where the user A is the portable device holder and only the user B is present near the user A as an example. As has been described above, the users A and B hold the own portable terminals 300A and 300B, respectively. Portable terminals 300 and the vehicular portable device 200 are simply referred to as communication terminals when not distinguished from each other.

In the present modification, the holder's terminal identification section G4 identifies a walking rhythm of the portable device holder according to the self-device acceleration data and identifies a walking rhythm of an individual holding a portable terminal 300 according to the acceleration history data of the portable terminal 300 as one operation. A portable terminal 300 with a walking rhythm that matches best a walking rhythm of the portable device holder is determined as being the holder's terminal. A walking rhythm corresponds to an index state quantity.

For example, data indicating a temporal change of triaxial synthetic acceleration is generated according to the self-device acceleration data, and an average value of peak appearance intervals of triaxial synthetic acceleration may be adopted as a walking rhythm of the portable device holder. The triaxial synthetic acceleration referred to herein means a value found by multiplying a square sum of a detection value in each axial direction by 0.5 (that is, by taking the square root). Alternatively, a gravity acting direction (in other words, a perpendicular direction) is identified from a detection value in each axial direction and peak appearance intervals of acceleration acting in the perpendicular direction may be adopted as a walking rhythm.

The perpendicular direction may be a direction of a synthetic vector of acceleration in each axial direction (hereinafter, referred to as a synthetic acceleration vector) at a time point when the vehicular portable device 200 is stationary. A stationary time point may be, for example, a time point when the triaxial synthetic acceleration coincides with gravitational acceleration (which is 9.8 [nn/seĉ2]). In short, a time point when gravitational acceleration alone is acting on the vehicular portable device 200 is deemed as being the stationary time point. Alternatively, the perpendicular direction may be identified by using a detection result of a gyro sensor or a geomagnetic sensor.

The above has described the method of identifying a walking rhythm of the portable device holder according to the self-device acceleration data. A walking rhythm of a user holding a portable terminal 300 may be identified in the same manner as above.

FIG. 30 conceptually shows an identification result of walking rhythms corresponding to the acceleration history data of the respective communication terminals. In each graph of FIG. 30, an ordinate is used for the triaxial synthetic acceleration and an abscissa is used for a time. Herein, Tfob, TmA, and TmB denote average values of peak intervals (hereinafter, referred to as average peak intervals) in the respective graphs. That is, the average peak interval Tfob represents a walking rhythm of the portable device holder and the average peak interval TmA represents a walking rhythm of an individual holding the portable terminal 300A (that is, the user A). Also, the average peak interval TmB represents a walking rhythm of an individual holding the portable terminal 300B (that is, the user B).

In a case where a result as set forth in FIG. 30 is obtained, the holder's terminal identification section G4 determines the portable terminal 300A as being the holder's terminal, because the average peak interval TmA of the portable terminal 300A takes a value closer to a value of the average peak interval Tfob of the vehicular portable device 200 than the average peak interval TmB of the portable terminal 300B.

As another operation, the holder's terminal identification section G4 identifies a moving speed of the vehicular portable device 200 according to the self-device acceleration data and also identifies moving speeds of portable terminals 300 according to the acceleration history data of the respective portable terminals 300. A portable terminal 300 with a moving speed closest to a moving speed of the portable device holder is determined as being the holder's terminal. A moving speed of the vehicular portable device 200 corresponds to a walking speed of the portable device holder and a moving speed of a portable terminal 300 corresponds to a walking speed of an individual carrying the portable terminal 300. A moving speed also corresponds to an example of the index state quantity.

A moving speed of the vehicular portable device 200 at a time point (hereinafter, a target time point) can be calculated by using acceleration data at multiple time points detected within one second from the target time point. For example, magnitudes of horizontally-acting acceleration (that is, a horizontal component) at the respective detection time points are identified according to the acceleration data detected within one second from the target time point. The horizontal components at the respective detection time points are multiplied by the sampling interval and a sum of the products is adopted as a moving speed at the target time point. In short, a moving speed may be found by applying time integration to horizontally-acting acceleration. The horizontal component corresponds to a component which is the triaxial synthetic acceleration vector projected onto a plane (that is, a horizontal surface) orthogonal to the perpendicular direction.

In the present modification, time points (in other words, detection time points) when multiple items of acceleration data forming the acceleration history data are acquired are deemed as being the target time points, and same computation processing is performed for each time point as a more preferable operation. Accordingly, the holder's terminal identification section G4 generates data indicating moving speeds at the respective detection time points (speed history data).

The above has described the method of calculating a moving speed of the vehicular portable device 200, and moving speeds of a portable terminal 300 at the respective detection time points may be calculated by a method same as the method of finding a moving speed of the vehicular portable device 200. Also, speed history data of a portable terminal 300 is generated by the same method from the acceleration history data.

As is shown in FIG. 31, the speed history data of the respective communication terminals functions as data indicating a temporal change pattern of a moving speed (hereinafter, referred to as a speed change pattern). In FIG. 31, a solid line represents a moving speed of the vehicular portable device 200 and an alternate long and short dash line represents a moving speed of the portable terminal 300A. Also, an alternate long and two short dashes line represents a moving speed of the portable terminal 300B.

In the present modification, the holder's terminal identification section G4 compares a speed change pattern of each portable terminal 300 present near the self-device with a speed change pattern of the vehicular portable device 200 to identify the holder's terminal. A portable terminal 300 with a speed change pattern that matches best the speed change pattern of the vehicular portable device 200 among multiple portable terminals 300 is determined as being the holder's terminal. A matching degree of the speed change patterns may be calculated by using a known pattern matching technique.

It goes without saying that the holder's terminal identification section G4 may calculate a moving speed found by setting a latest detection time point as a calculation start point for each communication terminal and determine a portable terminal 300 with a moving speed closest to a moving speed of the vehicular portable device 200 among portable terminals 300 as being the holder's terminal.

As still another operation, the holder's terminal identification section G4 identifies a stride length of the portable device holder according to the self-device acceleration data, and also identifies stride lengths of individuals carrying portable terminals 300 according to the acceleration history data of the respective portable terminals 300. A portable terminal 300 carried by an individual with a stride length closest to a stride length of the portable device holder is determined as being the holder's terminal. A stride length also corresponds to an example of the index state quantity.

A stride length of the portable device holder may be identified by, for example, a method as follows. Firstly, data indicating a fluctuation of the moving speed (that is, speed history data) of the portable device holder is generated by the method described above. Subsequently, a time when one step changes to another step forward is identified by a method same as the method of identifying a walking rhythm. That is, a time interval for one step is identified. A moving distance by one step (that is, a stride length) is calculated by multiplying moving speeds at respective time points included in a time interval of one step by the sampling interval and adding up the products. The above has described a procedure to identify a stride length of the portable device holder by way of example, and a stride length of an individual carrying a portable terminal 300 may be identified in accordance with the same procedure.

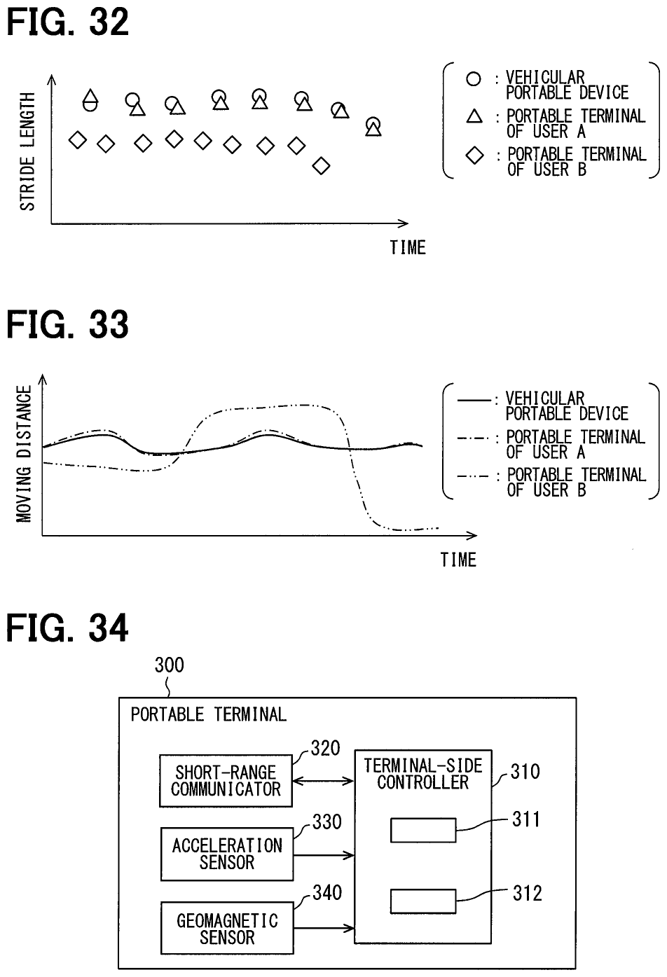

FIG. 32 conceptually shows temporal changes of stride lengths of the portable device holder, an individual holding the portable terminal 300A (that is, the user A), and an individual holding the portable terminal 300B (that is, the user B). In FIG. 32, circular marks represent a stride length of the portable device holder and triangular marks represent a stride length of the user A. Also, diamond marks represent a stride length of the user B. Stride lengths at respective time points may be identified by the method described above. Intervals of the same marks in the time axis represents a walking rhythm.

In a case where a result as set forth in FIG. 32 is obtained, the holder's terminal identification section G4 determines the portable terminal 300A as being the holder's terminal, because a stride length of the user A is closer to a stride length of the portable device holder than a stride length of the user B. Herein, a stride length of an individual carrying a communication terminal is calculated multiple times and an average value or a median value is adopted as a stride length of the individual as an example. Alternatively, the holder's terminal identification section G4 may calculate, for example, only latest stride lengths of respective individuals carrying the communication terminals and identify the holder's terminal by comparing the latest stride lengths.

As yet another operation, the holder's terminal identification section G4 identifies a temporal change pattern of a moving distance (hereinafter, referred to as a distance change pattern) per a certain time (for example, one second) of the vehicular portable device 200 according to the self-device acceleration data. The holder's terminal identification section G4 also identifies distance change patterns of portable terminals 300 from the acceleration history data of the respective portable terminals 300. A portable terminal 300 with a moving speed closest to the distance change pattern of the portable device holder is determined as being the holder's terminal.

A moving distance per a certain time (for example, one second) of the vehicular portable device 200 can be identified by applying time integration to a moving speed of the vehicular portable device 200 in a present time zone. Moving speeds at the respective detection time points are calculated by the method described above. The holder's terminal identification section G4 generates data indicating a temporal change of moving distance per a certain time (hereinafter, referred to as distance change pattern data) by performing same computation processing by setting the respective detection time points as the target time point. The above has described the method of identifying the distance change pattern of the vehicular portable device 200 and distance change pattern data of portable terminals 300 can be generated by the same method.

In order to identify the holder's terminal, the holder's terminal identification section G4 compares the distance change pattern data of respective portable terminals 300 present near the self-device with the distance change pattern data of the vehicular portable device 200. A portable terminal 300 providing distance change pattern data that matches best the distance change pattern data of the vehicular portable device 200 among portable terminals 300 is determined as being the holder's terminal. For example, in a case where the distance change pattern data of the respective communication terminals as conceptually shown in FIG. 33 is obtained as a result of the processing above, the portable terminal 300A is determined as being the holder's terminal.

It goes without saying that the holder's terminal identification section G4 may calculate a moving distance over a certain previous time from a latest detection time point set as a calculation start time point for each communication terminal and may determine a portable terminal 300 with a moving distance closest to a moving distance of the vehicular portable device 200 among portable terminals 300 as being the holder's terminal. A moving distance per a certain time also corresponds to an example of the index state quantity.

Information on a vehicle occupant (for example, holder's terminal information) identified by the processing above may be sent to the vehicle V at predetermined timing. It goes without saying that when the holder's terminal is identified successfully, a portable terminal 300 other than the holder's terminal is the fellow vehicle occupant's terminal. Hence, as has been described in the seventh modification above, information (for example, the terminal ID) on the fellow vehicle occupant's terminal can be sent as the information on the vehicle occupant. The vehicle occupant information acquirer section F6 provided to the vehicle-side controller identifies a user as the portable device holder according to the vehicle occupant information sent from the vehicular portable device 200. In short, effects same as the effects of the embodiment and the like above can be also obtained by the present modification.

The above has disclosed the configuration in which portable terminals 300 send the acceleration history data to the vehicular portable device 200 while the vehicular portable device 200 identifies stride lengths or the like of users of respective portable terminals 300 according to the sent data. However, the present disclosure is not limited to the configuration as above. A portable terminal 300 may identify a stride length or the like of the own user and notify the vehicular portable device 200 of an identification result. Each portable terminal 300 is capable of identifying a stride length or the like of the own user by performing the computation processing described above on an output history (that is, acceleration history data) of the acceleration sensor 330.

Owing to the configuration as above, a computation load in the portable device-side controller 210 can be reduced. In addition, a volume of data sent and received between the vehicular portable device 200 and a portable terminal 300 can be reduced. Data sent from a portable terminal 300 and indicating a stride length or the like of the own user corresponds to the behavior notification data, in particular, to processed state quantity data.

### Seventeenth Modification

The holder's terminal identification section G4 may identify the holder's terminal by using a temporal change pattern of a direction in which each communication terminal is oriented. The following will describe an embodiment in light with such an idea as a seventeenth modification.

In the seventeenth modification, as is shown in FIG. 34, each portable terminal 300 includes a geomagnetic sensor 340. The geomagnetic sensor 340 is a sensor detecting an azimuth of the portable terminal 300 by measuring an orientation of a magnetic field. The geomagnetic sensor 340 used herein as an example is a triaxial geomagnetic sensor detecting an azimuth by dividing geomagnetic into three axial components orthogonal to one another. Detection results of the geomagnetic sensor 340 are successively provided to the terminal-side controller 310.

The geomagnetic sensor 340 may be a biaxial geomagnetic sensor instead. An azimuth may be expressed in degrees from 0° to 359° in reference to a predetermined direction. Herein, an azimuth is expressed in angles in reference to 0° N, 90° E, 18° S, and 270° W as an example. A reference direction (in other words, a direction at an angle of 0°) is not necessarily true north, and may be a direction of magnetic north pole (so-called magnetic north). Further, true east or true south may be adopted as the reference direction.

Upon acquisition of data indicating a detection result of the geomagnetic sensor 340 (hereinafter, referred to as azimuth data), the terminal-side controller 310 gives a timestamp indicating a detection time to the azimuth data and saves the azimuth data in the RAM 312 for a certain time. The azimuth data in the RAM 312 may be handled in a same manner as with the acceleration data. Hereinafter, a block of time-series azimuth data over a latest certain time is referred to as azimuth history data. As with the acceleration history data, the azimuth history data functions as data indicating a history of a behavior of a user carrying a portable terminal 300 within a certain time from a present time point. The azimuth history data also corresponds to the state quantity history data.

In the seventeenth modification, each portable terminal 300 sends a communication packet containing the azimuth history data in addition to the acceleration history data both saved in the RAM 312 (that is, behavior notification packet) to the vehicular portable device 200 via short-range communication. As has been described in the sixteenth modification above, it goes without saying that the behavior notification packet contains sender identification information (for example, the terminal ID).

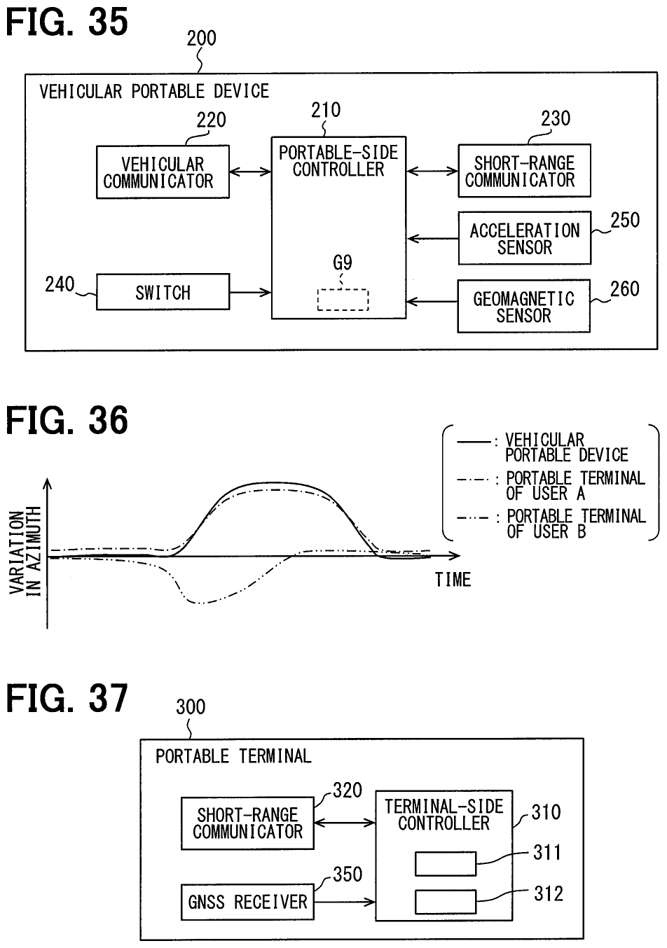

In the seventeenth modification, as is shown in FIG. 35, the vehicular portable device 200 includes a geomagnetic sensor 260 and the portable device-side controller 210 includes an azimuth information acquirer section G9. The geomagnetic sensor 260 is furnished with a function same as the function of the geomagnetic sensor 340 provided to each portable terminal 300.

The azimuth information acquirer section G9 acquires data indicating a detection result of the geomagnetic sensor 260 (that is, azimuth data). The azimuth information acquirer section G9 may be realized by running the portable terminal program on the CPU or by using a hardware member, such as an IC. Upon acquisition of the azimuth data, the azimuth information acquirer section G9 gives a timestamp indicating a detection time to the azimuth data and saves the azimuth data in the RAM 212 for a certain time. The azimuth information acquirer section G9 also corresponds to the state quantity acquisition unit.

The azimuth data in the RAM 212 may be handled in a same manner as with the acceleration data. That is, azimuth history data of the vehicular portable device 200 (hereinafter, referred to as self device azimuth data) is saved in the RAM 212. As with the self-device acceleration data, the self-device azimuth data functions as data indicating a history of a behavior of the portable device holder within a certain time from a present time point.

Upon receipt of the behavior notification packet sent from a portable terminal 300 present near the self-device, the short-range communication processor section G3 associates each of the acceleration history data and the azimuth history data indicated by the received behavior notification packet with the terminal ID and saves the both data into the RAM 212.

The holder's terminal identification section G4 identifies the holder's terminal by using the self-device azimuth data and the azimuth history data of portable terminals 300 present near the self-device, both of which are saved in the RAM 212. The following will describe an operation of the holder's terminal identification section G4 in the seventeenth modification in a case where the user A is the portable device holder and the user B alone is present near the user A as in the sixteenth modification above as an example.

Firstly, the holder's terminal identification section G4 generates the distance change pattern data of the respective communication terminals in accordance with the procedure described in the sixteenth modification above. To be more specific, the distance change pattern data of the vehicular portable device 200, the distance change pattern data of the portable terminal 300A, and the distance change pattern data of the portable terminal 300B are generated.

Subsequently, the holder's terminal identification section G4 identifies a variation per unit time in an orientation of the vehicular portable device 200 (hereinafter, referred to as an azimuth variation) according to the self-device acceleration data and also identifies azimuth variations of portable terminals 300 according to the acceleration history data of the respective portable terminals 300.

An azimuth variation of the vehicular portable device 200 at a time point may be a value found from degrees expressing an azimuth at a time point and degrees expressing an azimuth one second early by subtracting the latter from the former. That is, an azimuth variation may be a difference between a latest detection value and a detection value one second early. The holder's terminal identification section G4 generates data indicating a trajectory of a temporal change of the azimuth variation (hereinafter, referred to as azimuth change pattern data) by performing same computation processing for the respective detection time points. The holder's terminal identification section G4 generates azimuth change pattern data of respective portable terminals 300 by a method same as the method of generating the distance change pattern data of the vehicular portable device 200.

The holder's terminal identification section G4 identifies the holder's terminal by using both of a change pattern of the moving distance and a change pattern of the azimuth. For example, the distance change patterns of respective portable terminals 300 present near the self-device and the distance change pattern of the vehicular portable device 200 are compared. A portable terminal 300 presenting the distance change pattern data that matches best and another portable terminal 300 presenting distance change pattern data that matches second best the distance change pattern of the vehicular portable device 200 are identified.

The azimuth change pattern data of each of the two portable terminals 300 is compared with the azimuth change pattern data of the vehicular portable device 200. One of the two portable terminals 300 whichever provides the azimuth change pattern data that matches better the azimuth change pattern data of the vehicular portable device 200 is determined as being the holder's terminal. For example, in a case where a result as set forth in FIG. 36 is obtained, the holder's terminal identification section G4 determines the portable terminal 300A as being the holder's terminal, because the azimuth change pattern data of the portable terminal 300A matches better the azimuth change pattern data of the vehicular portable device 200 than the azimuth change pattern data of the portable terminal 300B.

The above has described the configuration in which the holder's terminal is identified by using both of a change pattern of the moving distance and a change pattern of the azimuth. However, the present disclosure is not limited to the configuration as above. The holder's terminal may be identified by using the azimuth change pattern data alone. In such a case, a portable terminal 300 presenting the azimuth change pattern data that matches best the azimuth change pattern of the vehicular portable device 200 is determined as being the holder's terminal. An operation to identify the holder's terminal by using both of a change pattern of the moving distance and a change pattern of the azimuth corresponds to an operation to identify the holder's terminal by using a temporal change of a movement vector.

Alternatively, the holder's terminal identification section G4 may calculate a variation in azimuth found by setting a latest detection time point as a calculation start point for each communication terminal and determine a portable terminal 300 with an azimuth variation closest to an azimuth variation of the vehicular portable device 200 among portable terminals 300 as being the holder's terminal. A variation in azimuth may be calculated also by using a gyro sensor. Hence, a detection value of a gyro sensor can be also adopted as a state quantity.

Information on a vehicle occupant (for example, the holder's terminal information) identified by the processing as above may be sent to the vehicle V at predetermined timing as in the sixteenth modification above. Owing to the configuration as above, effects same as the effects of the embodiment and the like above can be also obtained by the present modification.

### Eighteenth Modification

The holder's terminal identification section G4 may identify the holder's terminal by using location information of the respective communication terminals. The following will describe an embodiment in light with such an idea as an eighteenth modification.

In the eighteenth modification, as is shown in FIG. 37, each portable terminal 300 includes a GNSS receiver 350. The GNSS receiver 350 is a device which successively (for example, every 100 milliseconds) detects a present location of the GNSS receiver 350 by receiving a positioning signal sent from a positioning satellite forming a GNSS (Global Navigation Satellite System). Detection results of the GNSS receiver 350 are successively provided to the terminal-side controller 310. A present location detected by the GNSS receiver 350 may be expressed in latitude and longitude.

Upon acquisition of data indicating a present location identified by the GNSS receiver 350 (hereinafter, referred to as location data), the terminal-side controller 310 gives a timestamp indicating a detection time to the location data and saves the location data in the RAM 312 for a certain time. The location data in the RAM 312 may be handled in a same manner as with the acceleration data or the like described above. Hereinafter, a block of time-series location data over a latest certain time is referred to as location history data. The location history data functions as data indicating a movement trajectory of a portable terminal 300 within a certain time from a present time point. A timestamp indicating a detection time is given to location information at each time point.

In the eighteenth modification, each portable terminal 300 sends a communication packet including the location history data saved in the RAM 312 (hereinafter, referred to as a location information packet) to the vehicular portable device 200 via short-range communication. It goes without saying that the location information packet includes sender identification information (for example, the terminal ID). The location history data contained in the location information packet also corresponds to the behavior notification data, in particular, to an example of the state quantity history data.

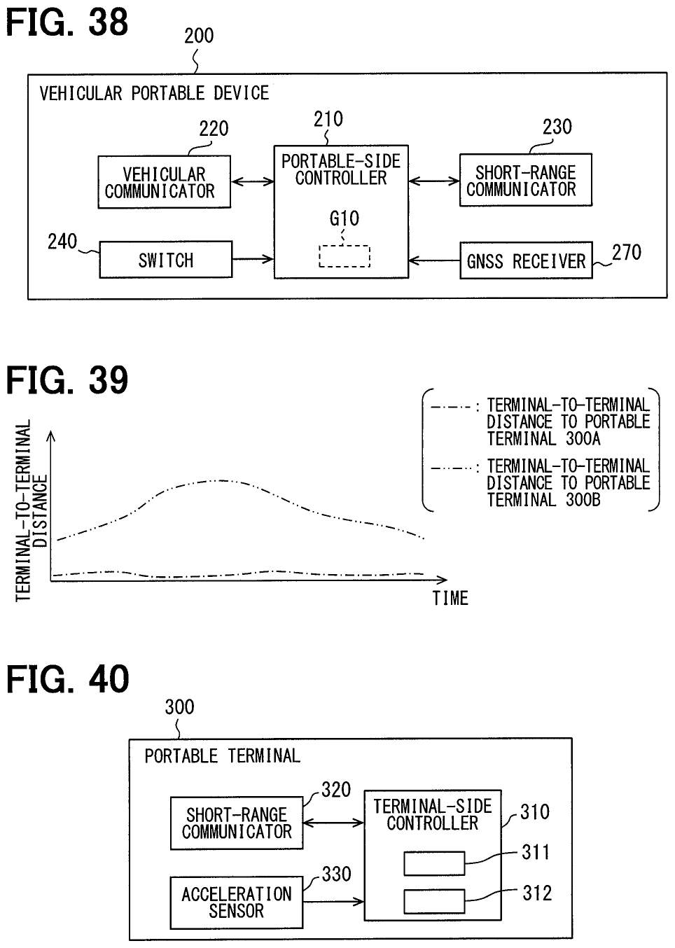

In the eighteenth modification, as is shown in FIG. 38, the vehicular portable device 200 includes a GNSS receiver 270 and the portable device-side controller 210 includes a location information acquirer section G10. The GNSS receiver 270 is furnished with a function same as the function furnished to the GNSS receiver 350 provided to each portable terminal 300.

The location information acquirer section G10 acquires data indicating a detection result of the GNSS receiver 270 (that is, location data). The location information acquirer section G10 may be realized by running the portable terminal program on the CPU or by using a hardware member, such as an IC. Upon acquisition of the location data from the GNSS receiver 270, the location information acquirer section G10 gives a timestamp to the location data and saves the location data in the RAM 212 for a certain time.

The location data in the RAM 212 may be handled in a same manner as with the acceleration data or the like described above. In short, location history data of the vehicular portable device 200 is saved in the RAM 212. The location history data of the vehicular portable device 200 functions as data indicating a movement trajectory of the vehicular portable device (in other words, the portable device holder) within a certain time from a present time point.

The short-range communication processor section G3 cooperates with the short-range communicator 230 and receives the location information packets sent from portable terminals 300 present near the self-device. The terminal ID indicated by the received location information packet is associated with the location history data and saved in the RAM 212.

In the eighteenth modification, the holder's terminal identification section G4 identifies the holder's terminal by using the location history data of the self-device and the location history data of respective portable terminals 300 present near the self-device, both of which are saved in the RAM 212. The following will describe an operation of the holder's terminal identification section G4 in the eighteenth modification in a case where the user A is the portable device holder and the user B alone is present near the user A as in the sixteenth and seventeenth modifications above as an example.

As an operation, the holder's terminal identification section G4 generates terminal-to-terminal distance fluctuation data indicating a fluctuation of a distance between a portable terminal 300 and the self-device (hereinafter, referred to as a terminal-to-terminal distance) for each portable terminal 300. A terminal-to-terminal distance between the portable terminal 300A and the vehicular portable device 200 at a time point is a difference of locations between the portable terminal 300A and the vehicular portable device 200 at the time point. The holder's terminal identification section G4 calculates the terminal-to-terminal distance at a time point by referring to location data at the time point in the location history data of the self-device and location data at the same time point in the location history data of the portable terminal 300A. Terminal-to-terminal distance fluctuation data of the portable terminal 300A is generated by performing the processing as above on location data at multiple time points. Terminal-to-terminal distance fluctuation data of the portable terminal 300B is generated in accordance with a same procedure.

The holder's terminal identification section G4 compares the terminal-to-terminal distance fluctuation data of the portable terminal 300A with the terminal-to-terminal distance fluctuation data of the portable terminal 300B, and determines one of the portable terminals 300 with the terminal-to-terminal distance relatively fluctuating in a vicinity of 0 as being the holder's terminal, because the holder's terminal is carried by the portable device holder and hence a fluctuation of the terminal-to-terminal distance is expected to be 0 to less than 1 meter. For example, in a case where a result as set forth in FIG. 39 is obtained, the holder's terminal identification section G4 determines the portable terminal 300A as being the holder's terminal. A fluctuation level used for a determination may be an average value or a median value of terminal-to-terminal distances at multiple time points.

The above has described the configuration in which the terminal-to-terminal distance is calculated at multiple time points and the holder's terminal is identified according to a fluctuation level of the terminal-to-terminal distance by way of example. However, the identification method using the location data is not limited to the method of the example. For example, a portable terminal 300 present at a nearest location to the vehicular portable device 200 at an arbitrary time point may be determined as being the holder's terminal. Further, a variance value of the terminal-to-terminal distance may be calculated for each portable terminal 300 and a portable terminal 300 with the smallest variance value may be determined as being the holder's terminal.

The above has disclosed the configuration in which a terminal-to-terminal distance in reference to a location of the vehicular portable device 200 is calculated for each portable terminal 300 and the holder's terminal is identified by using the terminal-to-terminal distance. However, the method of identifying the holder's terminal is not limited to the method disclosed above.

For example, the location history data of each portable terminal 300 present near the self-device may be compared with the location history data of the vehicular portable device 200, and a portable terminal 300 providing a movement trajectory closest to a movement trajectory of the vehicular portable device 200 may be determined as being the holder's terminal. The movement trajectory of each communication terminal is indicated by the location history data.

The holder's terminal can be identified also by the configuration as above. It goes without saying that when the holder's terminal is identified, a remaining portable terminal 300 can be deemed as being the fellow vehicle occupant's terminal. Vehicle occupant information identified by the processing above may be sent to the onboard device 100 at predetermined timing. Effects same as the embodiment and the like above can be achieved also by the configuration as above.

### Nineteenth Modification

The above has disclosed the configuration in which the holder's terminal is identified via short-range communication made by the vehicular portable device 200 with portable terminals 300 present near the self-device. However, the present disclosure is not limited to the configuration as above. In a case where the vehicular portable device 200 and respective portable terminals 300 include a communication module for near field communication (NFC for short), a portable terminal 300 which establishes near field communication with the vehicular portable device 200 may be determined as being the holder's terminal.

Near field communication referred to herein means a communication made by a communication method for a sufficiently short communicable distance in comparison with short-range communication. For example, near field communication means communication for a communicable distance as short as several to several tens of centimeters. In short, near field communication is communication based on ISO or IEC 14443 standards or ISO or IEC 18092 standards.

In a case where the vehicular portable device 200 and respective portable terminals 300 include a connector module for wired communication based on predetermined communication standards, a portable terminal 300 wire-connected to the vehicular portable device 200 may be determined as being the holder's terminal.

### Twentieth Modification

The method of identifying a user who is going to use the vehicle V as the portable device holder by the vehicular portable device 200 while the vehicle V is parked is not limited to the methods described in the embodiment and the tenth modification (hereinafter, referred to as the embodiment and the like) above by way of example.

In the embodiment and the like above, the holder's terminal is identified on condition that a variation in received signal strength indication (hereinafter, abbreviated to RSSI) of a portable terminal 300 carried by the portable device holder becomes smaller than a variation in RSSI of the fellow vehicle occupant's terminal. However, the inventors had conducted various tests and had discovered that a variation in RSSI of the holder's terminal takes a value larger than a value of RSSI variation of the fellow vehicle occupant's terminal in some cases depending on a combination of holding styles of the vehicular portable device 200 and a portable terminal 300 by the portable device holder (in other words, a locational relationship between the vehicular portable device 200 and a portable terminal 300).

A configuration and a method disclosed below as the twentieth modification are devised to identify the holder's terminal (in other words, the portable device holder) at a higher degree of accuracy by taking an exceptional event as above into consideration. The various modifications of the embodiment described above are also applicable to the twentieth modification unless a contradiction occurs. Hereinafter, a variation in RSSI is referred to as an RSSI variation of a portable terminal.

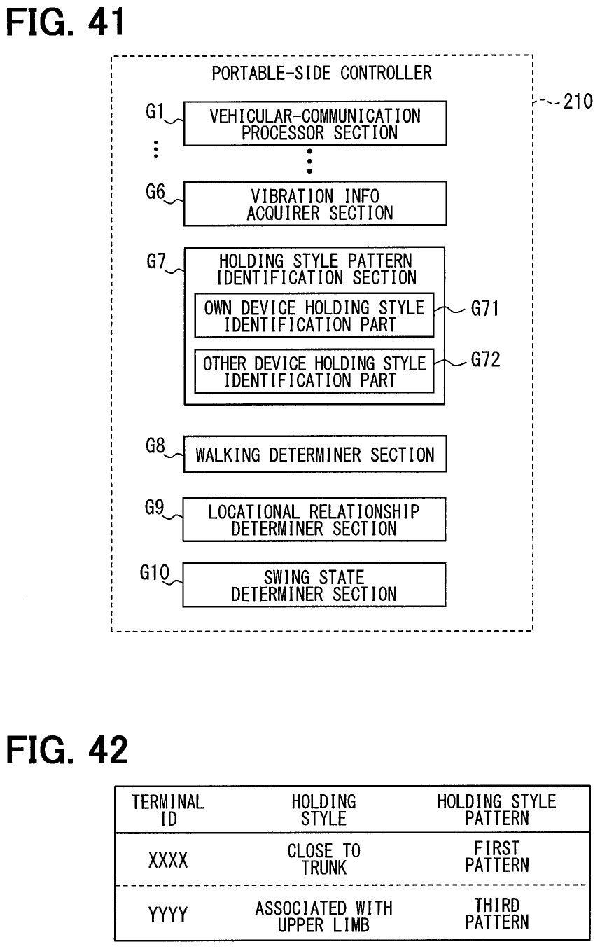

In the twentieth modification, as is shown in FIG. 40, each portable terminal 300 includes an acceleration sensor 330 detecting acceleration acting on the self. The acceleration sensor 330 used herein as an example is a sensor measuring acceleration along three axial directions orthogonal to one another (that is, a triaxial acceleration sensor). It goes without saying that the acceleration sensor 330 may be a biaxial acceleration senor or a monoaxial acceleration sensor instead. Detection results of the acceleration sensor 330 are successively provided to the terminal-side controller 310. The acceleration sensor 330 corresponds to a terminal-side acceleration sensor.

The terminal-side controller 310 includes a holding style identification section 312 identifying a holding style of the own portable terminal 300 by a user holding the own portable terminal 300 (hereinafter, referred to as a terminal holder) according to an output of the acceleration sensor 330. Herein, as an example, the holding style of the portable terminal 300 by the terminal holder is classified into two holding styles: a close-to-trunk holding style and an upper limb associated holding style. That is, the holding style identification section 312 identifies whether the holding style of the own portable terminal 300 by the terminal holder is the close-to-trunk holding style or the upper limb associated holding style according to an output of the acceleration sensor 330.

The close-to-trunk holding style referred to herein means a holding style in which acceleration associated with motion of a trunk of the terminal holder acts on a portable terminal 300. The trunk referred to herein means a human body except for hands and legs, to be more specific, a head, a neck, a chest, a belly, a pelvis, and so on. A back indicating a dorsal including a region from the neck to the belly and a hip indicating a region between the chest and the pelvis also correspond to the trunk.

A portable terminal 300 held in the close-to-trunk holding style means a case where a portable terminal 300 is put in a pocket of a garment (trousers or a jacket) the terminal holder is wearing or a case where a portable terminal 300 is put in a container, such as a backpack and a belt bag, in contact with the trunk.

The upper limb associated holding style referred to herein means a holding style in which acceleration associated with motion of an upper limb (that is, a hand) of the user acts on a portable terminal 300. A portable terminal 300 held in the upper limb associated holding style means a case where the terminal holder holds a portable terminal 300 directly in hand or a portable terminal 300 is put in a container (for example, a handbag) held in hand of the terminal holder.

Various methods are applicable as a method of identifying whether the holding style of a portable terminal 300 by the terminal holder is the close-to-trunk holding style or the upper limb associated holding style by the holding style identification section 312 according to an output of the acceleration sensor 330.

As an example, the holding style identification section 312 determines that the holding style is the close-to-trunk holding style in a case where a periodic fluctuation corresponding to a walking rhythm of the terminal holder is observed in acceleration in a vertical direction (in other words, a gravity acting direction), because a vibration in the vertical direction due to walking of the terminal holder acts relatively hard on a portable terminal 300 when the holding style is the close-to-trunk holding style.

Meanwhile, in a case where no periodic fluctuation corresponding to a walking rhythm of the terminal holder is observed in acceleration in the vertical direction or amplitude of the detected periodic fluctuation is at or below a predetermined threshold while a fluctuation range of horizontally-acting acceleration is at or above a predetermined threshold, the holding style is determined as being the upper limb associated holding style.

The determination as above is made because horizontal acceleration corresponding to swinging motion of a hand (hereinafter, referred to as swinging motion) of the terminal holder acts relatively hard on a portable terminal 300 when the holding style is the upper limb associated holding style. More specifically, while the terminal holder is walking, a vertical vibration due to walking of the terminal holder is mitigated by the upper limb and hardly acts on a portable terminal 300. On the contrary, horizontal acceleration readily fluctuates while the terminal holder is walking, because the terminal holder swings hands. Hence, the holding style by the terminal holder can be determined as being the upper limb associated holding style according to determination criteria as above.

Specific values of the various thresholds used for determinations may be determined by tests or the like. It goes without saying that the method of identifying the holding style of a portable terminal 300 is not limited to the method described above and various known methods are also applicable. For example, a determination may be made by using a method disclosed in Japanese Patent No. 5232211. The holding style identification section 312 may be realized by running the portable terminal program on the CPU or by using a hardware member, such as an IC.

Each portable terminal 300 sends a communication packet indicating the holding style identified by the holding style identification section 312 (hereinafter, referred to as a holding style notification packet) to the vehicular portable device 200 via short-range communication. It goes without saying that the holding style notification packet contains sender identification information (for example, the terminal ID).

In the twentieth modification, the holding style identification section 312 identifies a swing period Tswg from a temporal change of horizontally-acting acceleration when it is determined that the holding style is the upper limb associated holding style as a more preferable configuration. The swing period Tswg corresponds to a period in which the terminal holder swings the hands. When the swing period Tswg is already identified, the holding style identification section 312 successively identifies a present phase in the swing period Tswg as one period. The phase may be expressed by a value in a range of 0° inclusive to 360° exclusive. It goes without saying that the phase may be expressed by a circular method (so-called radian).

In a case where the holding style identification section 312 has determined that the holding style is the upper limb associated holding style, the holding style notification packet sent to the vehicular portable device 200 contains the swing period Tswg identified by the holding style identification section 312 and phase timing information indicating timing when the phase is at 0° or 180°. In a case where identification of the swing period Tswg fails, the holding style notification packet may contain data indicating absence of periodicity in motion of the hands.

Each portable terminal 300 sends data made up of latest time-series detection results of the acceleration sensor 330 within a certain time (hereinafter, referred to as acceleration data) to the vehicular portable device 200 via short-range communication in response to a request from the vehicular portable device 200. The acceleration data contains time information indicating times when respective detection results are acquired.

In the twentieth modification, as is shown in FIG. 41, the portable device-side controller 210 includes a holding style pattern identification section G7, the walking determiner section G8, a positional relationship determiner section G9, and a swing state determiner section G10 in addition to the various functional blocks specified above. Each of the holding style pattern identification section G7, the walking determiner section G8, the location relationship determiner section G9, and the swing state determiner section G10 may be realized by running the portable device control program on the CPU 211 or by using a hardware member, such as an IC.

The holding style pattern identification section G7 determines whether a combination of the holding style of the self-device by the portable device holder and the holding style of a portable terminal 300 as a target by the terminal holder is a first, second, or third pattern. A portable terminal 300 as a target referred to herein means a portable terminal 300 present near the self-device. The holding style pattern identification potion G7 identifies the holding style pattern specified above for each portable terminal 300 present near the self-device.

The first pattern is a pattern in which both of a portable terminal 300 as a target (hereinafter, referred to as a target terminal) and the self-device are held in the close-to-trunk holding style. The second pattern is a pattern in which both of the target terminal and the self-device are held in the upper limb associated holding style. The third pattern means a pattern in which one of the target terminal and the self-device is held in the close-to-trunk holding style and the other is held in the upper limb associated holding style. Definitions of the upper limb associated holding style and the close-to-trunk holding style of the vehicular portable device 200 are same as the definitions of the upper limb associated holding style and the close-to-trunk holding style of a portable terminal 300.

p [0397]

To describe the configuration more in detail, the holding style pattern identification section G7 includes an self device holding style identification part G71 and an other device holding style identification part G72. The self-device holding style identification part G71 is a functional block identifying the holding style of the self-device by the portable device holder according to a detection result of the acceleration sensor 250. A method of identifying the holding style of the self-device by the self-device holding style identification part G71 may be same as the method of the holding style identification section 312 provided to the portable terminal 300.

The other device holding style identification part G72 is a functional block identifying the holding style of a portable terminal 300 present near the self-device. The other device holding style identification part G72 cooperates with the short-range communicator 230 and receives the holding style notification packets sent from respective portable terminals 300 present near the self-device. The terminal IDs indicated by the received holding style notification packets are associated with the holding styles and saved in the RAM 212. That is, in the present embodiment, the other device holding style identification part G72 identifies the holding style of each portable terminal 300 present near the self-device by receiving the holding style notification packets sent from respective portable terminals 300.

The present embodiment adopts the configuration in which each portable terminal 300 identifies the own holding style and notifies the vehicular portable device 200 of an identification result. However, the present disclosure is not limited to the configuration above. Alternatively, each portable terminal 300 may send data indicating detection results of the acceleration sensor 330 at multiple time points (that is, acceleration data) to the vehicular portable device 200 and the vehicular portable device 200 may identify the holding style of each portable terminal 300 according to the sent data. Even when configured as above, the vehicular portable device 200 is capable of knowing the holding style of each portable terminal 300 present near the self-device.

The holding style pattern identification section G7 identifies the holding style pattern for each portable terminal 300 according to the identification result of the self-device holding style identification part G71 and the identification result of the other device holding style identification part G72. For example, in a case where the holding style of the self-device is the close-to-trunk holding style, the holding style pattern is determined as being the first pattern with a portable terminal 300 held in the close-to-trunk holding style, and the holding style pattern is determined as being the third patter with a portable terminal 300 held in the upper limb associated holding style. FIG. 42 shows an example of holding style patterns in a case where two portable terminals 300 are present near the self-device.

The walking determiner section G8, the locational relationship determiner section G9, and the swing state determiner section G10 will be described below.

### Holder's Terminal Identification Processing

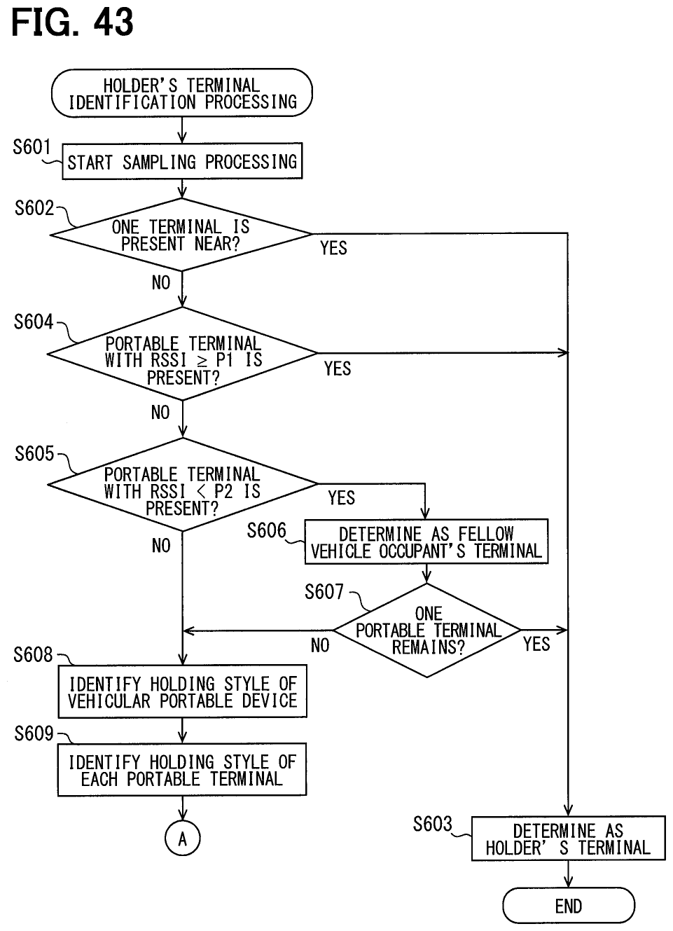

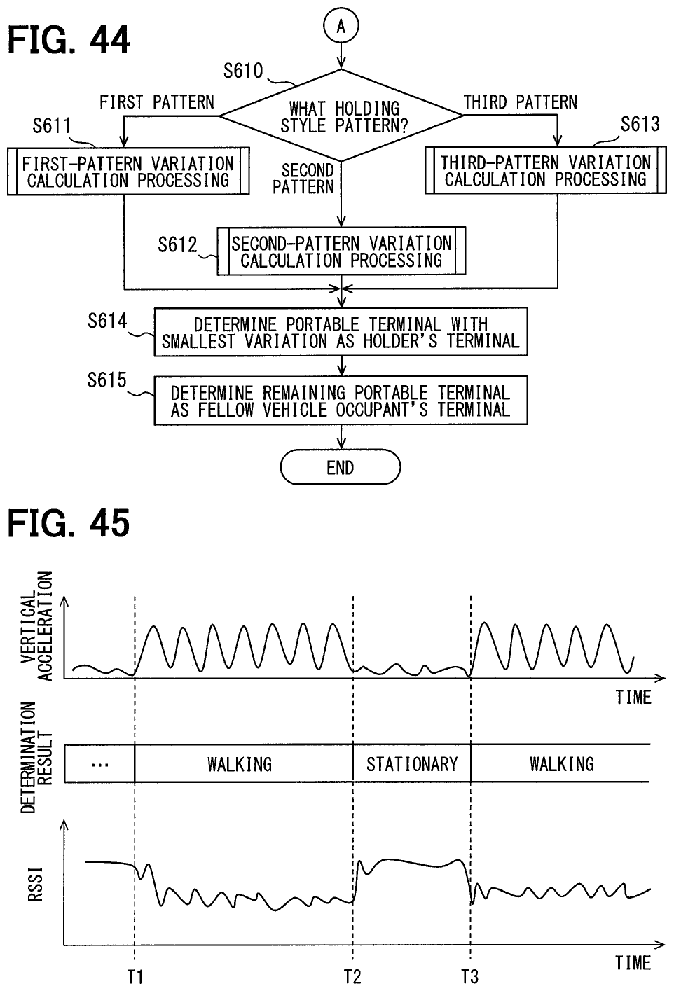

A sequence of processing steps performed by the portable device-side controller 210 to identify the portable device holder (hereinafter, referred to as holder's terminal identification processing) in the twentieth modification will now be described by using flowcharts of FIG. 43 and FIG. 44. The holder's terminal identification processing may be stared, for example, when authentication between the onboard device 100 and the vehicular portable device 200 via wireless communication succeeds. It goes without saying that a condition by which to start the holder's terminal identification processing is not limited to the condition specified above and may be designed as needed.

In Step S601, the short-range communication processor section G3 starts the sampling processing. The flow then proceeds to Step S602. The scan processing is thus performed successively. In Step S602, the holder's terminal identification section G4 identifies the number of portable terminals 300 present near the self-device according to a result of the scan processing.

In a case where only one portable terminal 300 is present near the self-device, a positive determination is made in Step S602 and the flow proceeds to Step S603. In Step S603, the holder's terminal identification section G4 determines the one detected portable terminal 300 as being the holder's terminal. The flow is then ended.

Meanwhile, in a case where two or more portable terminals 300 are present near the self-device, a negative determination is made in Step S602 and the flow proceeds to Step S604. In a case where no portable terminal 300 is detected, the flow may be ended. In such a case, exceptional processing, such as to perform Step S601 again a certain time later, may be designed as needed and performed.

In Step S604, the holder's terminal identification section G4 determines whether a portable terminal 300 with an RSSI at or above a predetermined finalization threshold P1 is present. In a case where a portable terminal 300 with an RSSI at or above the predetermined finalization threshold P1 is present, a positive determination is made in Step S604 and the flow proceeds to Step S603, in which the detected portable terminal 300 is determined as being the holder's terminal.

The finalization threshold P1 introduced herein is a threshold used to determine the holder's terminal according to an RSSI and set to a sufficiently large value. For example, the finalization threshold may be a smallest value or an average value of RSSIs observable when the vehicular portable device 200 and a portable terminal 300 are present within a sight of 0.5 m.

Meanwhile, in a case where no portable terminal 300 with an RSSI at or above the finalization threshold P1 is present, a negative determination is made in Step S604 and the flow proceeds to Step S605. In Step S605, the holder's terminal identification section G4 determines whether a portable terminal 300 with an RSSI below a predetermined exclusion threshold P2 is present.

The exclusion threshold P2 introduced herein is a threshold set for an RSSI to identify a portable terminal 300 held by an individual other than the portable device holder (that is, a fellow vehicle occupant). In other words, the exclusion threshold P2 is a threshold to exclude a portable terminal 300 that is least likely to be the holder's terminal from portable terminals 300 present near the vehicular portable device 200.

When an RSSI is sufficiently high, a portable terminal 300 is highly likely to be the holder's terminal whereas when the RSSI becomes lower, a portable terminal 300 is less likely to be the holder's terminal. Hence, a portable terminal 300 with an RSSI below a predetermined value can be deemed as being a portable terminal held by the fellow vehicle occupant (hereinafter, referred to as a fellow vehicle occupant's terminal). A specific value of the exclusion threshold P2 may be designed as needed. It is preferable that the exclusion threshold P2 is set to a value below an RSSI observed when a positional relationship between a portable terminal 300 and the vehicular portable device 200 corresponds to the indirect propagation pattern.

In a case where a portable terminal 300 with an RSSI below the predetermined exclusion threshold P2 is present, a positive determination is made in Step S605 and the flow proceeds to Step S606. Meanwhile, in a case where a portable terminal 300 with an RSSI below the exclusion threshold P2 is absent, a negative determination is made in Step S605 and the flow proceeds to Step S608.

In Step S606, the detected portable terminal 300 is determined as being the fellow vehicle occupant's terminal. The flow then proceeds to Step S607. In Step S607, whether only one portable terminal 300 remains after the fellow vehicle occupant's terminal is determined. When only one portable terminal 300 remains, a positive determination is made in Step S607 and the flow proceeds to Step S603, in which the remaining portable terminal 300 is determined as being the holder's terminal. The flow is then ended. Meanwhile, when two or more portable terminals 300 remain, a negative determination is made in Step S607 and the flow proceeds to Step S608.

In Step S608, the self-device holding style identification part G71 identifies whether the self-device is held in the close-to-trunk holding style or the upper limb associated holding style according to a detection result of the acceleration sensor 250. The flow then proceeds to Step S609.

In the present embodiment, Step S608 and subsequent steps are performed after the determination processing in respective Steps S604 through S607 ends. Hence, a portable terminal 300 as a target of the processing in Step S608 and the subsequent steps is a portable terminal 300 present near the self-device and with an RSSI below the finalization threshold P1 and at or above the exclusion threshold P2. Hereinafter, a portable terminal 300 as a target of the subsequent processing is referred to as a candidate terminal, because such a portable terminal 300 remains as a candidate for the holder's terminal.

In Step S609, the other device holding style identification part G72 identifies the holding style for each candidate terminal according to the holding style notification packets sent from respective candidate terminals. The flow then proceeds to Step S610. The candidate terminal may send the holding style notification packet in response to a request from the vehicular portable device 200 or spontaneously in a predetermined period.

In Step S610, the holding style pattern identification section G7 identifies the holding style pattern for each candidate terminal and further determines whether the identified holding style pattern is the first, second, or third pattern.

When the first pattern is determined for the candidate terminal in Step S610, first-pattern variation calculation processing is performed in Step S611 and the flow proceeds to Step S614. When the second pattern is determined for the candidate terminal in Step S610, second-pattern variation calculation processing is performed in Step S612 and the flow proceeds to Step S614. When the third pattern is determined for the candidate terminal in Step S610, third-pattern variation calculation processing is performed in Step S613 and the flow proceeds to Step S614.

The first through third variation calculation processing will be described separately in detail below. In Step S614, a candidate terminal with the smallest RSSI variation is determined as being the holder's terminal. The flow then proceeds to Step S615. In Step S615, a remaining candidate terminal is determined as being the fellow vehicle occupant's terminal. The flow is then ended.

### First-Pattern Variation Calculation Processing

The first-pattern variation calculation processing will now be described. The first-pattern variation calculation processing is processing to calculate a variation of a portable terminal 300 held in the first pattern of the holding style pattern.

The first-pattern variation calculation processing is performed for a reason as follows. In the embodiment and the like above, the holder's terminal is identified on condition that an RSSI variation of a portable terminal 300 carried by the portable device holder is smaller than an RSSI variation of the fellow vehicle occupant's terminal. However, the inventors had conducted various tests and had discovered that an RSSI variation of the portable terminal 300 carried by the portable device holder is larger than an RSSI variation of the fellow vehicle occupant's terminal in some cases when the portable device holder holds both of the vehicular portable device 200 and a portable terminal 300 in the close-to-trunk holding style.

Such a case occurs because a posture of a portable terminal 300 with respect to the vehicular portable device 200 dynamically changes in association with motion of the trunk during walking when the portable device holder holds both of the vehicular portable device 200 and a portable terminal 300 in the close-to-trunk holding style. More specifically, a signal propagation path from the holder's terminal to the vehicular portable device 200 dynamically changes in association with motion of the trunk during walking and an RSSI readily fluctuates while the portable device holder is walking at a level different from a level of an RSSI while the portable device holder is stationary.

In a case where a population used to calculate a variance amount of RSSIs includes both of RSSIs acquired during walking and RSSIs acquired in a stationary state, an RSSI variation becomes relatively large, in which case an RSSI variation of the holder's terminal becomes larger than an RSSI variation of the fellow vehicle occupant's terminal.

The holder's terminal identification section G4 adopts a portable terminal 300 with the smallest RSSI variation as the holder's terminal. Hence, in a case where the portable device holder holds the vehicular portable device 200 and a portable terminal 300 in the first pattern, the holder's terminal may possibly be determined erroneously because of a behavior as above.

The first-pattern variation calculation processing is processing to restrict an erroneous determination caused by the behavior as above. To be more exact, the processing as follows will be performed. A portable terminal 300 as a target of the first-pattern variation calculation processing is referred to as a target terminal for ease of description.

Firstly, the walking determiner section G8 determines whether the portable device holder is walking according to a detection result of the acceleration sensor 250. A known determination algorithm is applicable as a method of determining whether the portable device holder is walking according to a detection result of the acceleration sensor 250.

For example, as is disclosed in Japanese Patent No. 5459179, the walking determiner section G8 determines whether the portable device holder is walking depending on presence or absence of periodicity in vertically-acting acceleration. A posture of the vehicular portable device 200 with respect to space can be identified according to an output of the acceleration sensor 250 by a known method. Vertically-acting acceleration may be found by, for example, projecting output values in the respective axial directions of the acceleration sensor 250 in the vertical direction by using a rotation matrix corresponding to the posture of the vehicular portable device 200.

The holder's terminal identification section G4 calculates an RSSI variation of the target terminal by using only RSSIs acquired while the portable device holder is determined as walking by the walking determiner section G8 among all RSSIs of the target terminal acquired successively by the sampling processing.

FIG. 45 conceptually shows an operation of the walking determiner section G8. In FIG. 45, a graph in a top row shows a fluctuation of vertically-acting acceleration on the vehicular portable device 200 and a graph in a middle row shows a result of a determination as to whether the portable device holder is walking made by the walking determiner section G8 according to a fluctuation of acceleration. To be more specific, it is determined that the portable device holder is walking in a time zone from a time T1 to a time T2 and a time zone after a time T3.

Hence, in a circumstance as is shown in FIG. 45, the holder's terminal identification section G4 calculates an RSSI variation of the target terminal by using RSSIs of the target terminal acquired from the time T1 to the time T2 and after the time T3.

The present embodiment has described the configuration in which an RSSI variation of the target terminal is calculated by using RSSIs acquired while the portable device holder is walking without using RSSIs acquired while the portable device holder is stationary. However, the present disclosure is not limited to the configuration as above. Conversely, an RSSI variation may be calculated by using RSSIs acquired while the portable device holder is stationary without using RSSIs acquired while the portable device holder is walking.

However, positional relationships with other portable terminals 300 readily change while the portable device holder is walking. Hence, the holder's terminal can be identified at a higher degree of accuracy by adopting an RSSI variation calculated by using RSSIs acquired while the portable device holder is walking as described above than by adopting an RSSI variation calculated by using RSSIs acquired when the portable device holder is stationary.

### Second-Pattern Variation Calculation Processing

The second-pattern variation calculation processing will now be described. The second-pattern variation calculation processing is processing to calculate a variation of a portable terminal 300 held in the second pattern of the holding style pattern. The second-pattern variation calculation processing is performed when at least the vehicular portable device 200 is held in the upper limb associated holding style and a portable terminal 300 held in the upper limb associated holding style is present near the vehicular portable device 200.

A portable terminal 300 set as a target of the second-pattern variation calculation processing is referred to also as a target terminal for ease of description. In a case where the portable device holder holds a portable terminal 300 in the upper limb associated holding style while the vehicular portable device 200 is held in the upper limb associated holding style, the portable terminal 300 (that is, the holder's terminal) corresponds to the target terminal. In a case where a fellow vehicle occupant holds a portable terminal 300 in the upper limb associated holding style while the vehicular portable device 200 is held in the upper limb associated holding style, the portable terminal 300 of the fellow vehicle occupant also corresponds to the target terminal.

The second-pattern variation calculation processing is performed for a reason to restrict an erroneous determination that may possibly be made when both of the vehicular portable device 200 and the holder' terminal are carried in a single container (for example, a handbag), which will be described more specifically in the following.

In a case where the holder's terminal corresponds to the target terminal of the second-pattern variation calculation processing, it is highly likely that the portable device holder puts both of the vehicular portable device 200 and the holder's terminal in one bag held in hand. In a case where both of the vehicular portable device 200 and the holder's terminal are put in one bag, a positional relationship between the vehicular portable device 200 and the holder's terminal hardly changes. Hence, an RSSI variation of the holder's terminal is highly likely to take a relatively small value.

However, in a case where both of the vehicular portable device 200 and the holder's terminal are put in one bag, the vehicular portable device 200 and the holder's terminal are located so close to each other (for example, within 0.3 m) that an RSSI variation increases markedly when the positional relationship between the vehicular portable device 200 and the holder's terminal changes for some reason. An RSSI increases more and attenuates more abruptly when a distance between devices becomes shorter. Consequently, an RSSI variation of the holder's terminal may possibly become larger than an RSSI variation of the fellow vehicle occupant's terminal.

In a case where the portable device holder holds the vehicular portable device 200 and a portable terminal 300 in the second pattern, the portable device holder may hold one in a right hand and the other in a left hand. However, in a case where the portable device holder who is going get into the vehicle holds the vehicular portable device 200 and the holder's terminal in the second pattern, it is more likely that the vehicular portable device 200 and the holder's terminal are put in one bag held in either the right or left hand. Hence, in a case where the holder's terminal corresponds to the target terminal of the second-pattern variation calculation processing, it can be deemed that the vehicular portable device 200 and the holder's terminal are carried in one bag.

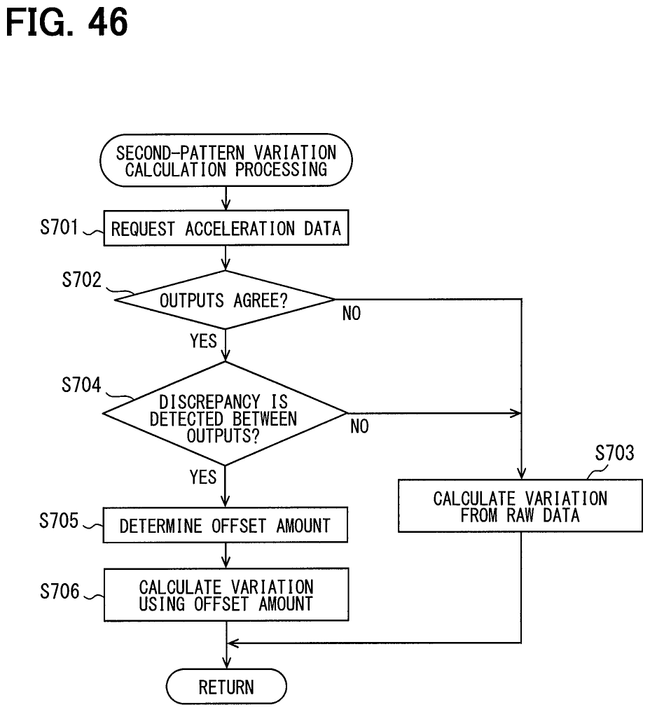

More specifically, the second-pattern variation calculation processing is performed in accordance with a procedure shown in a flowchart of FIG. 46. The sampling processing started in Step S602 of FIG. 43 is performed in parallel with (in other words, independently of) the second-pattern variation calculation processing.

In Step S701, the locational relationship determiner section G9 cooperates with the short-range communicator 230 and requests the target terminal to send the acceleration data. The acceleration data sent from the target terminal is compared with a detection result of the acceleration sensor 250 provided to the self-device to determine whether output values at multiple time points (in other words, fluctuation patterns of output values) of the respective acceleration sensors agree with each other.

In a case where fluctuation patterns of the output values of the respective acceleration sensors agree with each other, a positive determination is made in Step S702 and the flow proceeds to Step S704. Meanwhile, in a case where fluctuation patterns of the output values of the respective acceleration sensors have a discrepancy, a negative determination is made in Step S702 and the flow proceeds to Step S703. It should be noted that the fluctuation patterns do not necessarily agree with each other perfectly. Agreement of the fluctuation patterns may be determined when an agreement rate is at or above a predetermined threshold (for example, 80%). Alternatively, even in a case where specific values have a discrepancy, agreement of the fluctuation patterns of output values of the respective sensors may be determined when temporal change patterns, such as an increase and a decrease, agree with each other. The locational relationship determiner section G9 performing Step S702 corresponds to an acceleration tendency determination unit.

In a case where the target terminal is the holder's terminal, because the vehicular portable device 200 and the target terminal are put in one bag, substantially same acceleration acts on both of the vehicular portable device 200 and the target terminal unless an impact large enough to change the positional relationship is applied. Hence, a positive determination made in Step S702 means that the target terminal is highly likely to be the holder's terminal. Conversely, a negative determination made in Step S702 means that the target terminal is highly likely to be the fellow vehicle occupant's terminal.

In Step S703, an RSSI variation is calculated by directly using RSSIs of the target terminal obtained by the sampling processing. In short, a variation is calculated from raw data of RSSIs. A variation may be calculated in Step S703 at timing when sufficient data to calculate a variation is collected by the sampling processing.

In Step S704, the acceleration data of the target terminal is compared with a detection result of the acceleration sensor 250 provided to the self-device to determine whether a gap at or above a predetermined threshold is produced between the output values. In a case where a gap at or above the predetermined threshold is produced between the output values, the flow proceeds to Step S705. Meanwhile, in a case where a gap at or above the predetermined threshold is not produced between the output values, the flow proceeds to Step S703, in which a variation is calculated by using the raw data. Hereinafter, a period during which a gap at or above the predetermined threshold is produced is referred to as an output discrepancy period for ease of description.

In Step S705, the holder's terminal identification section G4 calculates respective representative values of RSSIs before and after the output discrepancy period and calculates an offset amount. The representative values may be an average value or a median value. A representative value of RSSIs before the output discrepancy period may be determined by using RSSIs collected within a certain previous time before the output discrepancy period starts as a population. A representative value of RSSIs after the output discrepancy period may be determined by using RSSIs collected when a certain time has elapsed after the output discrepancy period ends as a population.

The offset amount is comparable to a variance in the fluctuation level of an RSSI caused by a change of the positional relationship between the vehicular portable device 200 and a portable terminal 300 in the bag. When calculation of the offset amount is completed, the flow proceeds to Step S706. In Step S706, the holder's terminal identification section G4 calculates an RSSI variation by using the offset amount calculated in Step S705. The flow is then ended.

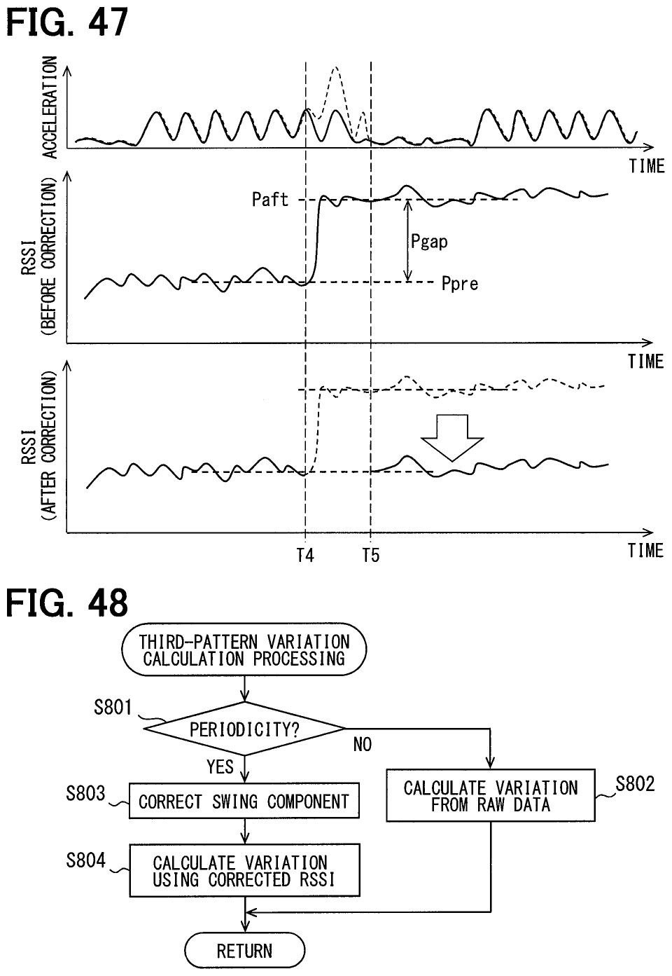

FIG. 47 conceptually shows temporal changes of output values of the acceleration sensors and RSSIs when a positional relationship between the vehicular portable device 200 and the holder's terminal put in one bag changes for some reason.

In FIG. 47, a top row shows a graph showing an output value of the acceleration sensor 250 of the vehicular portable device 200 and an output value of the acceleration sensor 330 of the target terminal (herein, the holder's terminal) which is indicated by a broken line. An ordinate is used for magnitude of acceleration and an abscissa is used for a time. In FIG. 47, a solid line represents an output value of the acceleration sensor 250 of the vehicular portable device 200 and a broken line represents an output value of the acceleration sensor 330 of the holder's terminal. A period from a time T4 to a time T5 corresponds to an output discrepancy period.

In a case where the vehicular portable device 200 and the holder's terminal are put in one bag, as is shown in a time zone before the time T4 and a time zone after the time T5, acceleration acting on the vehicular portable device 200 and acceleration acting on the holder's terminal substantially agree with each other. For example, in a case where the vehicle potable device 200 and the target terminal are put in one bag, a positive determination is made in Step S702 according to, for example, data in the time zone before the time T4.

In FIG. 47, a graph in a middle row shows a temporal change of an RSSI of the holder's terminal in the circumstance described above. As has been described, the positional relationship between the vehicular portable device 200 and the holder's terminal changes before and after the output discrepancy period, which causes an RSSI to fluctuate at a different level. FIG. 47 shows a configuration in which an RSSI rises due to a change of the positional relationship by way of example. However, it goes without saying that a fluctuation level of an RSSI may possibly fall in response to a change of the positional relationship.

In FIG. 47, Ppre indicates a representative value of an RSSI before the output discrepancy period, and Paft indicates a representative value of an RSSI after the output discrepancy period. Also, Pgap is a value as a difference when Ppre is subtracted from Paft. Herein, Pgap corresponds to an offset amount.

When a change of locations in one bag is observed, as is indicated in a bottom row of FIG. 47, the locational relationship determiner section G9 subtracts the offset amount from RSSIs acquired after the output discrepancy period and calculates a variation by using the differences (hereinafter, referred to as corrected RSSIs).

According to configuration as above, an inconvenience that the fellow vehicle occupant's terminal is erroneously determined as being the holder's terminal due to an increase in variation when a positional relationship between the vehicular portable device 200 and the holder's terminal put in one bag changes upon application of an impact can be limited.

### Third-Pattern Variation Calculation Processing

The third-pattern variation calculation processing will now be described. The third-pattern variation calculation processing is processing to calculate a variation of a portable terminal 300 held in the third pattern of the holding style pattern. A target terminal referred to in the description of the third-pattern variation calculation processing means a portable terminal 300 targeted at the third-pattern variation calculation processing.

The third-pattern variation calculation processing is performed for a reason as follows. In a case where the portable device holder holds either one of the vehicular portable device 200 and the holder's terminal in the upper limb associated holding style and the other in the close-to-trunk holding style, a positional relationship between the vehicular portable device 200 and the holder's terminal changes periodically in association with motion (that is, swinging) of an upper limb of the portable device holder and an RSSI of the holder's terminal changes periodically.

A variation in RSSI caused by a change of a positional relationship between two terminals increases as the two terminals are present closer. Consequently, in a case where the portable device holder holds the vehicular portable device and the holder's terminal in the third pattern, an RSSI variation of the holder's terminal becomes larger than an RSSI variation of the fellow vehicle occupant's terminal, in which case the vehicular portable device 200 may possibly make an erroneous determination on the holder's terminal.

The third-pattern variation calculation processing is processing to restrict such an erroneous determination caused by a behavior as described above. More specifically, the third-pattern variation calculation processing is provided with multiple steps shown in a flowchart of FIG. 48. The sampling processing is performed in parallel with (in other words, independently of) the third-pattern variation calculation processing.

In Step S801, the swing state determiner section G10 determines whether a positional relationship between the target terminal and the vehicular portable device 200 changes periodically with swinging motion of a user. To be more exact, a determination is made first as to which of the target terminal and the self-device is held in the upper limb associated holding style. In a case where the target terminal is held in the upper limb associated holding style, it is determined whether a variance in output of the acceleration sensor 330 has a periodicity, by referring to the holding style notification packet sent from the target terminal. That is, a determination is made as to whether a positional relationship between the target terminal and the vehicular portable device 200 changes periodically in association with swing motion of the user.

In a case where the vehicular portable device 200 is held in the upper limb associated holding style, presence or absence of periodicity is determined according to a temporal change of an output of the acceleration sensor 250 (to be more exact, horizontally-acting acceleration). In a case where the periodicity is present, a period (swing period Tswg) is identified and also a present phase in the swing period Tswg assumed to be one period is identified successively. One of the vehicular portable device 200 and the target terminal whichever is held in the upper limb holding style corresponds to an upper limb associated device.

In a case where the swing period Tswg is identified successfully in Step S801, the flow proceeds to Step S803. Meanwhile, when identification of the swing period Tswg fails, the flow proceeds to Step S802. In Step S802, an RSSI variation is calculated by directly using RSSIs of the target terminal acquired by the sampling processing. That is, a variation is calculated from raw data of RSSIs. A variation may be calculated when sufficient data to calculate a variation is collected.

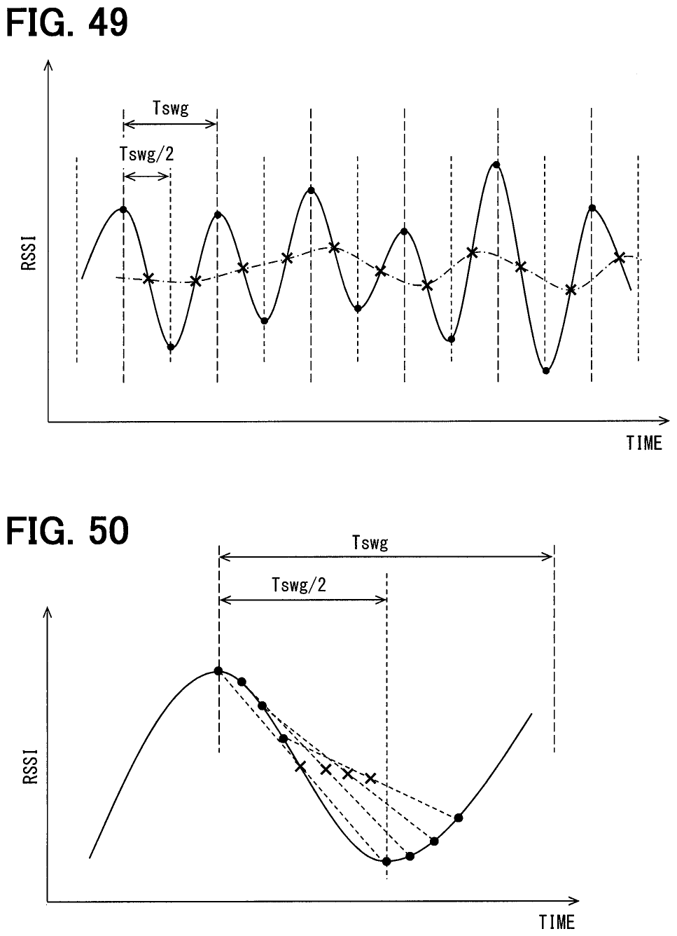

In Step S803, RSSIs successively collected are corrected to cancel a variance caused by swing motion. More specifically, as are indicated by x's in FIG. 49, a sum of an RSSI at a time point and an RSSI at a time point at a phase shifted by 180° from the firstly mentioned time point is divided by two, and a value thus found (that is, an average value) is saved in the RAM 212 as one item of data (hereinafter, referred to as sample data) used to calculate an RSSI variation. A time point at a phase shifted by 180° from another time point corresponds to a time point when half the swing period Tswg elapses.

FIG. 49 shows only sample data calculated from RSSIs at time points at phases of 0° and 180° for ease of description. In practice, however, sample data may be calculated also from RSSIs at other time points as is shown in FIG. 50.

In Step S804, an RSSI variation is calculated by using the sample data accumulated by performing Step S803 (in other words, corrected RSSIs). The flow is then ended.

### Summary of Twentieth Modification

According to the configuration as above, the holding style patterns of the vehicular portable device 200 and the portable terminal 300 are identified according to outputs of the acceleration sensors respectively provided to the vehicular portable device 200 and the portable terminal 300. The vehicular portable device 200 calculates an RSSI variation by using RSSIs corrected according to the holding style pattern or RSSIs collected in a predetermined circumstance. Hence, even when an RSSI variation calculated for the holder's terminal increases due to the holding style pattern, such an increase can be restricted. In short, the holder's terminal can be identified at a higher degree of accuracy.

What is claimed is:

1.-40. (canceled)

41. A vehicle occupant information acquisition system, comprising:
an onboard device mounted to a vehicle used by a plurality of users; and
at least one vehicular portable device associated with the onboard device,
wherein:
the onboard device includes:
a vehicle-side transmission unit that sends a predetermined signal from a plurality of transmission antenna provided to send a signal in a frequency band receivable by the vehicular portable device;
a vehicle-side reception unit that receives a signal sent from the vehicular portable device via a reception antenna; and
a portable device location identification unit that identifies a portable device location which is a location where the vehicular portable device is present, by receiving a response signal sent from the vehicular portable device in response to the signal sent from the plurality of transmission antennae;
the vehicle-side transmission unit sends from the transmission antennae a command signal requesting to identify a holder's terminal which is the portable terminal that is carried by the user carrying the vehicular portable device;
the vehicular portable device includes:
a first communication unit that sends a signal to and receives a signal from the onboard device and sends the response signal in response to a signal sent from the onboard device when the signal is received;
a second communication unit that is provided to perform short-range wireless communication with each of a plurality of portable terminals carried by the plurality of users;
a received signal strength indication detection unit that detects a received signal strength indication of the signal that the second communication unit receives from the portable terminal;
a holder's terminal identification unit that identifies the holder's terminal based on the received signal strength indications detected by the received signal strength indication detection unit in a time zone defined in reference to a time point when the first communication unit receives the command signal; and
a frequency characteristic analysis unit that, for each of the plurality of portable terminals, performs frequency characteristic analysis processing to analyze a frequency characteristic of waveform data indicating a temporal change in the received signal strength indication of the signal received from the portable terminal;
when a portable terminal with the received signal strength indication at or above a predetermined finalization threshold is present, the portable terminal is identified as the holder's terminal by the holder's terminal identification unit;
when the portable terminal with the received signal strength indication at or above the finalization threshold is absent, a portable terminal with which a frequency component corresponding to hand swing motion associated with walking is detected by the frequency characteristic analysis unit among the plurality of portable terminals is identified as the holder's terminal by the holder's terminal identification unit;
the first communication unit sends to the onboard device holder information identifying the user of the holder's terminal identified by the holder's terminal identification unit; and
the onboard device further includes a vehicle occupant information acquisition unit that identifies a portable device holder who is the user holding the vehicular portable device based on the holder information sent from the vehicular portable device, and identifies a seated location of the portable device holder based on the portable device location identified by the portable device location identification unit.

42. The vehicle occupant information acquisition system according to claim 41, wherein:
the frequency characteristic analysis unit performs the frequency characteristic analysis processing a plurality of times for each portable terminal; and
the vehicle occupant information acquisition unit determines that the holder's terminal is a portable terminal with which the frequency component corresponding to the hand swing motion is detected a largest number of times among the plurality of portable terminals.

43. A vehicle occupant information acquisition system, comprising:
an onboard device mounted to a vehicle used by a plurality of users; and
at least one vehicular portable device associated with the onboard device,
wherein:
the onboard device includes:
a vehicle-side transmission unit that sends a predetermined signal from a plurality of transmission antenna provided to send a signal in a frequency band receivable by the vehicular portable device;
a transmission processing unit that regularly sends a signal from the vehicle-side transmission unit in a predetermined period;
a vehicle-side reception unit that receives a signal sent from the vehicular portable device via a reception antenna; and
a portable device location identification unit that identifies a portable device location which is a location where the vehicular portable device is present, by receiving a response signal sent from the vehicular portable device in response to the signal sent from the plurality of transmission antennae;
the vehicle-side transmission unit sends from the transmission antennae a command signal requesting to identify a holder's terminal which is the portable terminal that is carried by the user carrying the vehicular portable device;
the vehicular portable device includes:
a first communication unit that sends a signal to and receives a signal from the onboard device and sends the response signal in response to a signal sent from the onboard device when the signal is received;
a second communication unit that is provided to perform short-range wireless communication with each of a plurality of portable terminals carried by the plurality of users;
a received signal strength indication detection unit that detects a received signal strength indication of the signal that the second communication unit receives from the portable terminal;
a holder's terminal identification unit that identifies the holder's terminal based on the received signal strength indications detected by the received signal strength indication detection unit;
a vehicle signal strength indication detection unit that detects a received strength indication of the signal sent from the onboard device; and
a location change determination unit that determines whether a location of the vehicular portable device with respect to the vehicle is changing, based on presence or absence of a temporal change in the received strength indication detected by the vehicle signal strength indication detection unit;
the holder's terminal identification unit determines the holder's terminal by using, among the received signal strength indications detected by the received signal strength indication detection unit in a time zone defined in reference to a time point when the first communication unit receives the signal, the received signal strength indications acquired during the location change determination unit determining that the location of the vehicular portable device with respect to the vehicle is changing;
the first communication unit sends to the onboard device holder information identifying the user of the holder's terminal identified by the holder's terminal identification unit; and
the onboard device further includes a vehicle occupant information acquisition unit that identifies a portable device holder who is the user holding the vehicular portable device based on the holder information sent from the vehicular portable device, and identifies a seated location of the portable device holder based on the portable device location identified by the portable device location identification unit.

44. The vehicle occupant information acquisition system according to claim 43, wherein:
the received signal strength indication detection unit is configured to successively detect the received signal strength indications of the signals received from the portable terminals in the time zone defined by the time point of receipt of the command signal; and
the holder's terminal identification unit calculates a degree of variance in the received signal strength indication in the time zone for each portable terminal based on the reception signal strength indications detected a plurality of times in the time zone, and determines the portable terminal with a minimum degree of variance as being the holder's terminal.

45. The vehicle occupant information acquisition system according to claim 41, wherein:
the plurality of transmission antennae are provided at locations to cover regions respectively corresponding to a plurality of seats of the vehicle as transmission areas;
the vehicle-side transmission unit sends a response requesting signal to the vehicular portable device from the plurality of transmission antennae in turn by shifting timing;
based on timing when the response signal is received, the portable device location identification unit identifies a sender antenna which is the transmission antenna from which the signal responded to by the vehicular portable device has been sent; and
the vehicle occupant information acquisition unit adopts a seat corresponding to the transmission area covered by the sender antenna as the seated location of the portable device holder.

46. The vehicle occupant information acquisition system according to claim 41, wherein:
the transmission antennae are provided to all doors respectively corresponding to a plurality of seats of the vehicle;
when the vehicle-side reception unit receives the response signal as a response to a signal sent from a driver's seat antenna which is the transmission antenna covering a transmission area within a certain range from a door at a driver's seat, the portable device location identification unit determines that the portable device location is near the door at the driver's seat;
when the vehicle-side reception unit receives the response signal as a response to the signal sent from a front occupant's seat antenna which is the transmission antenna covering a transmission area within a certain range from a door at a front occupant's seat, the portable device location identification unit determines that the portable device location is near the door at the front occupant's seat;
when the portable device location is determined as being near the door at the driver's seat by the portable device location identification unit, the vehicle occupant information acquisition unit determines that the seated location is the driver's seat; and
when the portable device location is determined as being near the door at the front occupant's seat by the portable device location identification unit, the vehicle occupant information acquisition unit determines that the seated location is the front occupant's seat.

47. A vehicle occupant information acquisition system, comprising:
an onboard device mounted to a vehicle used by a plurality of users; and
at least one vehicular portable device associated with the onboard device,
wherein:
the onboard device includes:
a vehicle-side transmission unit that sends a predetermined signal from a plurality of transmission antennae provided to send a signal in a frequency band receivable by the vehicular portable device; and
a vehicle-side reception unit that receives a signal sent from the vehicular portable device via a reception antenna;
the vehicular portable device includes:
a first communication unit that sends a signal to and receives a signal from the onboard device and sends a response signal in response to a signal sent from the onboard device when the signal is received;
a second communication unit that is provided to perform short-range wireless communication with each of a plurality of portable terminals carried by the plurality of users; and
a state quantity acquisition unit that, from a device for detecting a predetermined state quantity which changes due to a behavior of a portable device holder who is one of the users carrying the vehicular portable device, acquires a detection result of the state quantity and saves the detection result into a predetermined storage medium;
each portable terminal is configured to send location history data indicating a history of location of the portable terminal, which is determined by receipt of positioning signals sent from positioning satellites, to the vehicular portable device as behavior notification data,
the vehicular portable device further includes a holder's terminal identification unit that identifies a holder's terminal which is the portable terminal carried by the portable device holder, based on the behavior notification data sent from each of the plurality of portable terminals and a history of the state quantity of the vehicular portable device acquired by the state quantity acquisition unit;
the first communication unit sends holder information identifying a user of the holder's terminal identified by the holder's terminal identification unit to the onboard device;
the onboard device further includes a vehicle occupant information acquisition unit that identifies the portable device holder based on the holder information sent from the vehicular portable device;
the vehicular portable device further includes, as the state quantity acquisition unit, a location information acquisition unit that acquires location information indicating a present location of the vehicular portable device determined by receipt of positioning signals sent from positioning satellites and that saves the acquired location information into the storage medium; and
the holder's terminal identification unit identifies the holder's terminal, based on the location history data provided from the portable terminals as the behavior notification data and a history of the location of the vehicular portable device acquired by the state quantity acquisition unit.

48. The vehicle occupant information acquisition system according to claim 47, wherein:
the holder's terminal identification unit compares the location history data of each portable terminal with the history of the location of the vehicular portable device and determines that the holder's terminal is the portable terminal that is located closest to the vehicular portable device at a predetermined time point.

49. The vehicle occupant information acquisition system according to claim 47, wherein:
the holder's terminal identification unit
for each portable terminal, identifies a fluctuation level of a terminal-to-terminal distance which is a distance between the portable terminal and the vehicular portable device, based on the location history data of each portable terminal and the history of the location of the vehicular portable device, and
determines that the holder's terminal is the portable terminal with the terminal-to-terminal distance at a lowest fluctuation level.

50. The vehicle occupant information acquisition system according to a claim 47, wherein:
the onboard device further includes a portable device location identification unit that identifies a portable device location which is a location where the vehicular portable device is present by receiving a response signal sent from the vehicular portable device in response to a signal sent by the vehicle-side transmission unit from the plurality of transmission antennae; and
the vehicle occupant information acquisition unit identifies a seated location of the portable device holder based on the portable device location identified by the portable device location identification unit.

51. The vehicle occupant information acquisition system according to a claim 41, wherein:
the holder's terminal identification unit identifies the number of portable terminals present near the vehicular portable device based on a communication state of the second communication unit, and
in a case where only one portable terminal is present near the vehicular portable device, the holder's terminal identification unit determines the one portable terminal as being the holder's terminal.

52. A vehicle occupant information acquisition system, comprising:
an onboard device mounted to a vehicle used by a plurality of users; and
at least one vehicular portable device associated with the onboard device,
wherein:
the onboard device includes:
a vehicle-side transmission unit that sends a predetermined signal from a plurality of transmission antenna provided to send a signal in a frequency band receivable by the vehicular portable device;
a vehicle-side reception unit that receives a signal sent from the vehicular portable device via a reception antenna; and
a portable device location identification unit that identifies a portable device location which is a location where the vehicular portable device is present, by receiving a response signal sent from the vehicular portable device in response to the signal sent from the plurality of transmission antennae;
the vehicular portable device includes:
a first communication unit that sends a signal to and receives a signal from the onboard device and sends the response signal in response to a signal sent from the onboard device when the signal is received;
a second communication unit that is provided to perform short-range wireless communication with each of a plurality of portable terminals carried by the plurality of users;
a received signal strength indication detection unit that detects a received signal strength indication of the signal that the second communication unit receives from the portable terminal; and
a holder's terminal identification unit that identifies a holder's terminal which is the portable terminal that is carried by the user carrying the vehicular portable device, based on the received signal strength indications detected by the received signal strength indication detection unit;
the first communication unit sends to the onboard device holder information identifying the user of the holder's terminal identified by the holder's terminal identification unit; and
the onboard device further includes a vehicle occupant information acquisition unit that identifies a portable device holder who is the user holding the vehicular portable device based on the holder information sent from the vehicular portable device, and identifies a seated location of the portable device holder based on the portable device location identified by the portable device location identification unit.

53. The vehicle occupant information acquisition system according to claim 52, wherein:
the plurality of transmission antennae are provided to cover regions respectively corresponding to a plurality of seats of the vehicle as transmission areas;
the vehicle-side transmission unit sends a response requesting signal to the vehicular portable device from the plurality of transmission antennae in turn by shifting timing;
the portable device location identification unit identifies a sender antenna which is a transmission antenna from which the signal responded to by the vehicular portable device has been sent, based on timing when the response signal is received; and
the vehicle occupant information acquisition unit adopts a seat corresponding to a transmission area covered by the sender antenna as the seated location of the portable device holder.

54. The vehicle occupant information acquisition system according to claim 52, wherein:
the transmission antennae are provided to all doors respectively corresponding to a plurality of seats of the vehicle;
the portable device location identification unit determines,
that the portable device location is near a door at a driver's seat when the vehicle-side reception unit receives the response signal as a response to a signal sent from a driver's seat antenna which is a transmission antenna covering a transmission area within a certain range from the door at the driver's seat, and
that the portable device location is near a door at a front occupant's seat when the vehicle-side reception unit receives the response signal as a response to a signal sent from a front occupant's seat antenna which is a transmission antenna covering a transmission area within a certain range from the door at the front occupant's seat; and
the vehicle occupant information acquisition unit determines,
that the seated location is the driver's seat when the portable device location is determined as being near the door at the driver's seat by the portable device location identification unit, and
that the seated location is the front occupant's seat when the portable device location is determined as being near the door at the front occupant's seat by the portable device location identification unit.

55. The vehicle occupant information acquisition system according to claim 52, wherein:
the vehicle-side transmission unit sends a command signal requesting to identify the holder's terminal from the transmission antennae; and
the holder's terminal identification unit determines the holder's terminal based on the received signal strength indications detected by the received signal strength indication detection unit in a time zone defined in reference to a time point when the first communication unit receives the command signal.

56. The vehicle occupant information acquisition system according to claim 55, wherein:
the received signal strength indication detection unit is configured to successively detect the received signal strength indications of the signals received from the portable terminals in the time zone defined by the time point of receipt of the command signal; and
the holder's terminal identification unit
calculates a degree of variance in received signal strength indication in the time zone for each portable terminal, based on the reception signal strength indications detected a plurality of times in the time zone, and
determines a portable terminal with a minimum degree of variance as being the holder's terminal.

57. The vehicle occupant information acquisition system according to claim 55, wherein:
the vehicular portable device is furnished with a function of determining, based on a signal sent from the onboard device, whether an self device which is the vehicular portable device is present inside or outside a compartment of the vehicle;
the vehicular portable device further includes,
an external received strength indication storage unit that, separately for each portable terminal, stores as external received strength indication information the received signal strength indications detected by the received signal strength indication detection unit when the self device is present outside the compartment, and
an internal received strength indication storage unit that, separately for each portable terminal, stores as internal received strength indication information the received signal strength indications detected by the received signal strength indication detection unit when the self device is present inside the compartment; and
the holder's terminal identification unit calculates, for each portable terminal, an external representative value determined by the external received strength indication information stored in the external received strength indication storage unit and an internal representative value determined by the internal received strength indication information stored in the internal received strength indication storage unit, and adopts a portable terminal with the internal representative value larger than the exterior representative value as a candidate for the holder's terminal among the plurality of portable terminals.

58. The vehicle occupant information acquisition system according to claim 57, wherein:
the vehicle is provided with the transmission antennae including an external antenna covering an exterior of the compartment as a transmission area and an internal antenna covering an interior of the compartment as a transmission area;
the vehicle-side transmission unit, when sending a signal from the external antenna, sends the signal containing identification information identifying that the signal is sent to the exterior of the compartment, and when sending a signal from the internal antenna, sends the signal containing identification information identifying that signal is sent to the interior of the compartment; and
the vehicular portable device determines whether the vehicular portable device is present inside the compartment, based on the identification information contained in the received signal.

59. The vehicle occupant information acquisition system according to claim 57, wherein:
the received signal strength indication detection unit is configured to successively detect the received signal strength indications of the signals received from the portable terminals in the time zone defined by the time point of the receipt of the command signal;
in a case where the command signal is received while the self device is present outside the compartment, the external received strength indication storage unit stores, as the external received strength indication information for each portable device, the received signal strength indications detected a plurality of times by the received signal strength indication detection unit in the time zone defined in reference to the time point of the receipt of the command signal; and
the holder's terminal identification unit calculates, for each portable terminal, a degree of variance in received signal strength indication stored in the external received strength indication storage unit, calculates, for each portable terminal, an internal-external variation by subtracting the external representative value from the internal representative value when a difference between a smallest value and a second smallest value of the degree of variance calculated for each portable terminal is below a predetermined gap threshold, and determines a portable terminal with a largest internal-external variation as being the holder's terminal.

60. The vehicle occupant information acquisition system according to claim 59, wherein:
the holder's terminal identification unit determines a portable terminal with a minimum degree of variance as being the holder's terminal when a difference between the smallest value and the second smallest value of the degree of variance calculated for each portable terminal and determined by the received signal strength indications stored in the external received strength indication storage unit is at or above the gap threshold.

61. The vehicle occupant information acquisition system according to claim 57, wherein:
when every external representative value calculated for each portable terminal is below a predetermined received strength indication threshold, the holder's terminal identification unit calculates, for each portable terminal, an internal-external variation by subtracting the external representative value from the internal representative value, and determines a portable terminal with a largest internal-external variation as being the holder's terminal.

62. The vehicle occupant information acquisition system according to claim 57, wherein:
the received signal strength indication detection unit is configured to successively detect the received signal strength indications of the signals received from the portable terminals in the time zone defined by the time point of the receipt of the command signal;
when the command signal is received while the self device is present outside the compartment, the external received strength indication storage unit stores as the external received strength indication information for each portable terminal the received signal strength indications detected a plurality of times by the received signal strength indication detection unit in the time zone defined in reference to the time point of the receipt of the command signal; and
when there are the portable terminals with the external representative value at or above a predetermined direct holding threshold, the holder's terminal identification unit calculates a degree of variance in received signal strength indication stored in the external received strength indication storage unit for each of the portable terminals, and determines that the holder's terminal is a portable terminal with a minimum degree of variance among portable terminals with the external representative value at or above the direct holding threshold.

63. The vehicle occupant information acquisition system according to claim 55, wherein:
the first communication unit sends vehicle occupant information identifying users corresponding to portable terminals present near the vehicular portable device to the onboard device in response to a request from the onboard device; and
the vehicle occupant information acquisition unit
identifies the users as members of a present trip based on the vehicle occupant information and
determines that a seated location of the user whose seated location is not identified is any of the seats for which a seated vehicle occupant is not yet identified.

64. The vehicle occupant information acquisition system according to claim 52, wherein:
the onboard device further includes a driver candidate presentation processing unit that displays the user whose seated location is not identified yet on a display as a candidate for a driver in a case where a seat other than a driver's seat is identified as being the seated location of the portable device holder.

65. The vehicle occupant information acquisition system according to claim 55, wherein:
the vehicular portable device further includes a portable device-side acceleration sensor functioning as an acceleration sensor which detects acceleration acting on the vehicular portable device;
each of the plurality of portable terminals includes a terminal-side acceleration sensor functioning as an acceleration sensor which detects acceleration acting thereon;
the vehicular portable device further includes,
an self device holding style identification unit that identifies a holding style of the vehicular portable device by the portable device holder, based on an output value of the portable device-side acceleration sensor, and
an other device holding style identification uni that identifies a holding style of a target terminal by a user which is a portable terminal as a target of processing, based on an output value of the terminal-side acceleration sensor provided to the target terminal
the holder's terminal identification unit calculates a degree of variance in received signal strength indication of the target terminal by using
a received signal strength indication of a signal from the target terminal corrected according to a combination of holding styles of the vehicular portable device and the target terminal or
a received signal strength indication acquired in a circumstance determined by the combination of the holding styles of the vehicular portable device and the target terminal; and
the holder's terminal identification unit determines a portable terminal with a minimum degree of variance among the plurality of portable terminals as being the holder's terminal.

66. The vehicle occupant information acquisition system according to claim 65, wherein:
the vehicular portable device further includes a walking determination unit that determines whether the portable device holder is walking based on an output value of the portable device-side acceleration sensor;
the self device holding style identification unit determines, based on an output value of the portable device-side acceleration sensor, whether the vehicular portable device is held in a style in which acceleration associated with motion of a trunk of the portable device holder acts on the vehicular portable device;
the other device holding style identification unit determines, based on an output value of the terminal-side acceleration sensor, whether the target terminal is held by a terminal holder who is one of the plurality of users holding the target terminal in a style in which acceleration associated with motion of a trunk of the terminal holder acts on the target terminal; and
the holder's terminal identification unit calculates the degree of variance of the target terminal by using received signal strength indications of signals from the target terminal acquired by the received signal strength indication detection unit while the walking determination unit determines that the portable device holder is walking as a population in a case where it is determined by the self device holding style identification unit and the other device holding style identification unit that both of the vehicular portable device and the target terminal are held in the style in which acceleration associated with motion of the trunk of the respective holders acts on the vehicular portable device and the target terminal.

67. The vehicle occupant information acquisition system according to claim 65, further comprising:
an acceleration tendency determination unit that determines whether temporal changes of an output value of the portable device-side acceleration sensor and an output value of the terminal-side acceleration sensor agree with each other by comparing the respective output values,
wherein:
in a case where a gap at or above a predetermined threshold is produced between the output values of the portable device-side acceleration sensor and the terminal-side acceleration sensor when the acceleration tendency determination unit determines that the temporal changes of the output values of the acceleration sensors respectively provided to the vehicular portable device and the target terminal agree with each other, the holder's terminal identification unit calculates,
a representative value of received signal strength indications in respective time zones before and after an output discrepancy period during which the gap is produced,
an offset amount which is a value obtained by subtracting a representative value before the output discrepancy period from a representative value after the output discrepancy period, and
the degree of variance of the target terminal by using a value obtained by subtracting the offset amount from a received signal strength indication of a signal from the target terminal acquired after the output discrepancy period.

68. The vehicle occupant information acquisition system according to claim 65, wherein:
the self device holding style identification unit identifies, based on a temporal change of an output value of the portable device-side acceleration sensor, whether the vehicular portable device is held by the portable device holder as a holder of the vehicular portable device in a style in which acceleration associated with motion of an upper limb of the portable device holder acts on the vehicular portable device or in a style in which acceleration associated with motion of a trunk of the portable device holder acts on the vehicular portable device;
the other device holding style identification unit identifies, based on a temporal change of an output value of the terminal-side acceleration sensor, whether the target terminal is held by a terminal holder who is a user holding the target terminal in a style in which acceleration associated with motion of an upper limb of the terminal holder acts on the target terminal or in a style in which acceleration associated with motion of a trunk of the target holder acts on the target terminal;
the vehicle occupant information acquisition system further comprises a swing state determination unit;
in a case where it is determined by the self device holding style identification unit and the other device holding style identification unit that one of the vehicular portable device and the target terminal is held in the style under action of acceleration associated with motion of the upper limb of the holder and that the other one of the vehicular portable device and the target terminal is held in the style under action of acceleration associated with motion of the trunk of the holder, the swing state determination unit makes a determination as to whether an upper limb associated device which is one of the vehicular portable device and the target terminal held in the style under action of acceleration associated with motion of the upper limb of the holder is swung in a predetermined period, based on a temporal change of an output value of the acceleration sensor provided to the upper limb associated device; and
the holder's terminal identification unit calculates the degree of variance by using a value found by dividing a sum of a receive signal strength indication acquired by the received signal strength indication detection unit at a time point and a received signal strength indication acquired at timing half the predetermined period later from the time point by two in a case where the swing state determination unit determines that the upper limb associated device is swung in the predetermined period.
